(19) United States
(12) Patent Application Publication
(10) Pub. No.: US 2025/0364653 A1
(43) Pub. Date: Nov. 27, 2025

(54) BATTERY CELLS HAVING ELECTRODE ASSEMBLIES AND METHODS OF THEIR FABRICATION

(71) Applicant: Enovix Corporation, Fremont, CA (US)

(72) Inventors: Robert S. Busacca, Oakland, CA (US); Brett Kiger, Flowery Branch, GA (US); Ashok Lahiri, Danville, CA (US); Robert M. Spotnitz, Pleasanton, CA (US); Murali Ramasubramanian, Fremont, CA (US); John S. Thorne, Mountain View, CA (US); Kang Yao, Fremont, CA (US); Robert Keith Rosen, Lincoln, CA (US)

(21) Appl. No.: 19/287,389

(22) Filed: Jul. 31, 2025

Related U.S. Application Data
(63) Continuation of application No. 17/864,641, filed on Jul. 14, 2022.
(60) Provisional application No. 63/222,010, filed on Jul. 15, 2021.
(60) Provisional application No. 63/222,299, filed on Jul. 15, 2021.
(60) Provisional application No. 63/222,015, filed on Jul. 15, 2021.
(60) Provisional application No. 63/222,295, filed on Jul. 15, 2021.
(60) Provisional application No. 63/221,998, filed on Jul. 15, 2021.
(60) Provisional application No. 63/222,296, filed on Jul. 15, 2021.
(60) Provisional application No. 63/350,687, filed on Jun. 9, 2022.
(60) Provisional application No. 63/350,641, filed on Jun. 9, 2022.
(60) Provisional application No. 63/350,679, filed on Jun. 9, 2022.

(51) Int. Cl. H01M 50/191; H01M 4/66; H01M 4/70; H01M 10/0525; H01M 10/0585; H01M 10/613; H01M 10/653; H01M 10/6552; H01M 10/6561; H01M 10/6567; H01M 50/186; H01M 50/193; H01M 50/198; H01M 50/531

(52) U.S. Cl. CPC H01M 50/191; H01M 4/661; H01M 4/663; H01M 4/70; H01M 10/0525; H01M 10/0585; H01M 10/613; H01M 10/653; H01M 10/6552; H01M 10/6561; H01M 10/6567; H01M 50/186; H01M 50/193; H01M 50/198; H01M 50/531

(57) ABSTRACT

A secondary battery cell chargeable between a charged state and a discharged state is provided. The secondary battery cell comprises an electrode current collector having (a) an electrode current collector body region and (b) an electrode current collector end region having a smaller height than the electrode current collector body.

### CROSS REFERENCE TO RELATED APPLICATIONS

This application is a continuation of U.S. patent application Ser. No. 17/864,641, filed on Jul. 14, 2022, which claims priority of U.S. Provisional Patent Application Ser. Nos. 63/222,010, 63/222,299, 63/222,015, 63/222,295, 63/221,998, and 63/222,296 filed on Jul. 15, 2021, and U.S. Provisional Patent Application Ser. Nos. 63/350,687, 63/350,641, and 63/350,679, filed on Jun. 9, 2022, which are hereby incorporated by reference in their entireties.

### FIELD OF THE INVENTION

This disclosure generally relates to structures for use in sealed secondary battery cells and other energy storage devices, and to sealed secondary battery cells and energy storage devices employing such structures.

### BACKGROUND

Rocking chair or insertion secondary batteries are a type of energy storage device in which carrier ions, such as lithium, sodium, potassium, calcium or magnesium ions, move between a positive electrode and a negative electrode through an electrolyte. The secondary battery may comprise a single battery cell, or two or more battery cells that have been electrically coupled to form the battery, with each battery cell comprising a positive electrode, a negative electrode, a microporous separator, and an electrolyte.

In rocking chair battery cells, both the positive and negative electrodes comprise materials into which a carrier ion inserts and extracts. As a cell is discharged, carrier ions are extracted from the negative electrode and inserted into the positive electrode. As a cell is charged, the reverse process occurs: the carrier ion is extracted from the positive and inserted into the negative electrode.

When the carrier ions move between electrodes, one of the persistent challenges resides in the fact that a considerable amount of heat is generated as the battery is repeatedly charged and discharged. The heat generated during cycling, if not properly and promptly dissipated, will accumulate and become problematic for safety, reliability and cycle life of the battery because when the temperature rises, electrical shorts and battery failures occur.

Therefore, there remains a need for temperature control during battery cycling to improve safety, reliability and cycle life of the battery.

### SUMMARY

Briefly, therefore, aspects of the present disclosure provides a sealed secondary battery cell chargeable between a charged state and a discharged state. The sealed secondary battery cell comprises a hermetically sealed case, an electrode assembly enclosed by the hermetically sealed case, and a rated capacity of at least 100 mAmp·hr. The electrode assembly has a substantially polyhedral shape with mutually perpendicular transverse, longitudinal and vertical axes corresponding to the x, y and z axes, respectively, of an imaginary three-dimensional Cartesian coordinate system, opposing longitudinal end surfaces that are substantially flat and separated from each other in the longitudinal direction, and a lateral surface surrounding an electrode assembly longitudinal axis A_{EA} and connecting the first and second longitudinal end surfaces, the lateral surface having opposing vertical surfaces that are substantially flat and separated from each other in the vertical direction on opposing vertical sides of the longitudinal axis, and opposing transverse surfaces that are substantially flat and separated from each other in the transverse direction on opposing transverse sides of the longitudinal axis, wherein the opposing longitudinal surfaces have a combined surface area, L_{SA}, the opposing transverse surfaces have a combined surface area, T_{SA}, the opposing vertical surfaces have a combined surface area, V_{SA}, and the ratio of V_{SA} to each of L_{SA} and T_{SA} is at least 5:1. The electrode assembly further comprises an electrode structure population, an electrically insulating separator population, and a counter-electrode structure population, wherein members of the electrode structure, electrically insulating separator and counter-electrode structure populations are arranged in an alternating sequence, the hermetically sealed case has opposing first and second case ends separated in the longitudinal direction, and a case sidewall that connects the first and second case ends, the opposing first and second case ends and case sidewall forming a hermetic seal about the electrode assembly, wherein the case sidewall comprises upper and lower sidewalls separated from each other in the vertical direction, and first and second transverse sidewalls that are separated from each other in the transverse direction, wherein members of the electrode structure population and/or counter-electrode structure population comprise upper and lower end surfaces in the vertical direction, that are connected to the upper and lower sidewalls of the hermetically sealed case to restrain growth of the electrode assembly in the vertical direction during cycling of the secondary battery cell between the charged and discharged states, wherein members of the population of electrode structures and/or members of the population of counter-electrode structures that are connected to the upper and lower sidewalls have (i) a thickness as measured in the longitudinal direction that is in a range of between 5 and 50 μm, and (ii) a yield strength of greater than 100 MPa, the charged state is at least 75% of a rated capacity of the secondary battery cell, and the discharged state is less than 25% of a rated capacity of the secondary battery cell. A thickness of the secondary battery as measured in the vertical direction between vertically opposing regions of external vertical surfaces of the upper and lower sidewalls of the hermetically sealed case, is at least 1 mm, and a thermal conductivity of the secondary battery cell along a thermally conductive path between the vertically opposing regions of the external vertical surfaces of the upper and lower sidewalls of the hermetically sealed case in the vertical direction is at least 7.5 W/m·K.

Other aspects, features and embodiments of the present disclosure will be, in part, discussed and, in part, apparent in the following description and drawings.

### BRIEF DESCRIPTION OF THE DRAWINGS

FIG. 1A is a perspective view of one embodiment of an electrode assembly with a set of electrode constraints.

FIG. 1B is a schematic of one embodiment of a three-dimensional electrode assembly for a secondary battery.

FIG. 1C is an inset cross-sectional view of the electrode assembly of FIG. 1B.

FIG. 1D is a cross-sectional view of the electrode assembly of FIG. 1B, taken along line D in FIG. 1B.

FIG. 2 illustrates an exploded view of an embodiment of an energy storage device or a secondary battery comprising an electrode assembly and set of electrode constraints.

FIG. 3A illustrates a cross-section in a Z-Y plane, of embodiments of an electrode assembly, with an auxiliary electrodes.

FIG. 3B illustrates a top view in the X-Y plane, of embodiments of an electrode assembly, with a constraint system having apertures therein.

FIG. 4 is a cross-sectional view of an embodiment of an electrode assembly bonded to a constraint system.

FIG. 5 is a top view of an embodiment of an electrode assembly, showing a constraint system adhered to electrode current collectors.

FIG. 6A illustrates a cross-section of an embodiment of the electrode assembly taken along the line A-A′ as shown in FIG. 1A, and illustrates elements of embodiments of primary and secondary growth constraint systems.

FIG. 6B illustrates a cross-section of an embodiment of the electrode assembly taken along the line B-B′ as shown in FIG. 1A, and illustrates elements of embodiments of primary and secondary growth constraint systems.

FIG. 6C illustrates a cross section of an embodiment of the electrode assembly taken along the line A-A′ as shown in FIG. 1A, and illustrates further elements of embodiments of primary and secondary growth constraint systems.

FIG. 7 is a top view of one embodiment of a secondary battery cell in a bottom portion of a hermetically sealed case.

FIG. 8 is a perspective view of an embodiment of a hermetically sealed case.

FIG. 9 is a perspective view of an embodiment of the hermetically sealed case of FIG. 8 from the opposite side.

FIG. 10 illustrates an exploded view of an embodiment of a secondary battery cell in the hermetically sealed case of FIGS. 8-9.

FIG. 11 illustrates a cross-section in a Z-Y plane, of embodiments of a secondary battery cell in a hermetically sealed case.

FIG. 12 is the enlarged view of one end of the cross-section of FIG. 12.

FIG. 13 illustrates a schematic of an exemplary thermally conductive path in a jelly roll secondary battery cell.

FIG. 14 illustrates a schematic of an exemplary thermally conductive path in a cylindrical secondary battery cell.

FIG. 15 illustrates a schematic of an exemplary thermally conductive path in an embodiment of a secondary battery cell having a substantially polyhedral shape according to aspects of the disclosure.

FIGS. 16A-16D show the current (A) and voltage (V) versus time (in minutes) for two different cells (TM39713 and TM40142) for indicated cycles using rates tested from 1 C up to 1° C. charge rate with C/25 CV cutoff as described in Tables 1 and 2.

FIGS. 17A-17D show current (A) and cell voltage (V) vs. time (minutes) for two different cells (TM39713 and TM40142) for indicated cycles using rates tested from C/10 to 4 C discharge rates with standard C/3 charge rate on all cycles with C/25 CV step, as described in Tables 3 and 4. The C/10 reference cycle 52 has 1 C discharge pulses and 0.75 C charge pulses every 10% SOC according to standard test protocols defined by the US Department of Energy.

FIG. 18 shows cell voltage (V) and cell temperature (° C.) vs. capacity (Ah) for cells TM39713 (left) and TM40142 (right) for indicated cycles using rates tested from C/5 to 4 C discharge rates with standard C/3 charge rate on all cycles with C/25 CV step, as described in Tables 3 and 4.

FIG. 19 shows cell discharge capacity (Ah), average discharge voltage (V), and DeltaAveCell_V (V) vs. cycle number for TM39059 and TM40136 using 6 C charge and 1 C discharge for cycles 32 and above, with multi-rate US Department of Energy defined diagnostic cycles every 50^{th} cycle.

FIGS. 20A-20B show Cell voltage (V), current (amps), and temperature (° C.) vs. capacity (Ah) for charge (20A) and discharge (20B) for indicated cycles 40-180 for EXP4049-type cell TM39059.

FIG. 21 shows state of charge versus cycle time and charge times at various C-rates.

FIG. 22 is a chart showing charge rate and minutes to state of charge.

FIG. 23 shows cells cycled using 0.33 C/0.33 C charge/discharge rate with C/25 CV step (CellInt=32266) compared to cells cycled with 6 C/1 C charge/discharge rate with C/25 CV step (CellInt=39059 and CellInt=40136) including discharge capacity, average discharge voltage, the difference between average charge and discharge voltage DeltaAveCell_V, and normalized capacity retention (using cycle 32 as reference) plotted vs. cycle number. Every 50^{th} cycle has a DOE defined diagnostic cycle using C/10 discharge with 1 C discharge pulses and 0.75 C charge pulses, and a standard 0.33 C/0.33 C diagnostic cycle (not shown).

FIGS. 24-25 show state of charge versus time for various charging rates.

FIG. 26 is a chart showing charge rate and minutes to state of charge.

FIG. 27 shows state of charge versus time for various charging rates, with an industry target rate.

FIG. 28 shows the % capacity retention versus cycle number for 6 C CCCV-1 C and C/3 CCCV-C/3.

FIG. 29 shows an embodiment of an electrode structure comprising an electrode current collector having an electrode current collector body region and an electrode current collector end region, and an embodiment of a counter-electrode structure comprising a counter-electrode current collector having a counter-electrode current collector body region and a counter-electrode current collector end region, as shown along a cross-section in the X-Z plane.

FIG. 30 shows the embodiment of the electrode structure and the embodiment of the counter-electrode structure of FIG. 29, as shown along a cross-section in the Y-X plane.

FIG. 31 shows an embodiment of an electrode and/or counter-electrode structure with electrode current collector and/or counter-electrode current collector connected to busbar and/or counter-electrode busbar.

Other aspects, embodiments and features of the inventive subject matter will become apparent from the following detailed description when considered in conjunction with the accompanying drawing. The accompanying figures are schematic and are not intended to be drawn to scale. For purposes of clarity, not every element or component is labeled in every figure, nor is every element or component of each embodiment of the inventive subject matter shown where illustration is not necessary to allow those of ordinary skill in the art to understand the inventive subject matter.

### Definitions

“A,” “an,” and “the” (i.e., singular forms) as used herein refer to plural referents unless the context clearly dictates otherwise. For example, in one instance, reference to “an electrode” includes both a single electrode and a plurality of similar electrodes.

“About” and “approximately” as used herein refers to plus or minus 10%, 5%, or 1% of the value stated. For example, in one instance, about 250 μm would include 225 μm to 275 μm. By way of further example, in one instance, about 1,000 μm would include 900 μm to 1,100 μm. Unless otherwise indicated, all numbers expressing quantities (e.g., measurements, and the like) and so forth used in the specification and claims are to be understood as being modified in all instances by the term “about.” Accordingly, unless indicated to the contrary, the numerical parameters set forth in the following specification and attached claims are approximations. Each numerical parameter should at least be construed in light of the number of reported significant digits and by applying ordinary rounding techniques.

“Charged state” as used herein in the context of the state of a secondary battery refers to a state where the secondary battery is charged to at least 75% of its rated capacity. For example, the battery may be charged to at least 80% of its rated capacity, at least 90% of its rated capacity, and even at least 95% of its rated capacity, such as 100% of its rated capacity.

“C-rate” as used herein refers to a measure of the rate at which a secondary battery is discharged, and is defined as the discharge current divided by the theoretical current draw under which the battery would deliver its nominal rated capacity in one hour. For example, a C-rate of 1 C indicates the discharge current that discharges the battery in one hour, a rate of 2 C indicates the discharge current that discharges the battery in ½ hours, a rate of C/2 indicates the discharge current that discharges the battery in 2 hours, etc.

“Discharged state” as used herein in the context of the state of a secondary battery refers to a state where the secondary battery is discharged to less than 25% of its rated capacity. For example, the battery may be discharged to less than 20% of its rated capacity, such as less than 10% of its rated capacity, and even less than 5% of its rated capacity, such as 0% of its rated capacity.

A “cycle” as used herein in the context of cycling of a secondary battery between charged and discharged states refers to charging and/or discharging a battery to move the battery in a cycle from a first state that is either a charged or discharged state, to a second state that is the opposite of the first state (i.e., a charged state if the first state was discharged, or a discharged state if the first state was charged), and then moving the battery back to the first state to complete the cycle. For example, a single cycle of the secondary battery between charged and discharged states can include, as in a charge cycle, charging the battery from a discharged state to a charged state, and then discharging back to the discharged state, to complete the cycle. The single cycle can also include, as in a discharge cycle, discharging the battery from the charged state to the discharged state, and then charging back to a charged state, to complete the cycle.

“Feret diameter” as referred to herein with respect to the electrode assembly is defined as the distance between two parallel planes restricting the electrode assembly measured in a direction perpendicular to the two planes. For example, a Feret diameter of the electrode assembly in the longitudinal direction is the distance as measured in the longitudinal direction between two parallel planes restricting the electrode assembly that are perpendicular to the longitudinal direction. As another example, a Feret diameter of the electrode assembly in the transverse direction is the distance as measured in the transverse direction between two parallel planes restricting the electrode assembly that are perpendicular to the transverse direction. As yet another example, a Feret diameter of the electrode assembly in the vertical direction is the distance as measured in the vertical direction between two parallel planes restricting the electrode assembly that are perpendicular to the vertical direction.

“Longitudinal axis,” “transverse axis,” and “vertical axis,” as used herein refer to mutually perpendicular axes (i.e., each are orthogonal to one another). For example, the “longitudinal axis,” “transverse axis,” and the “vertical axis” as used herein are akin to a Cartesian coordinate system used to define three-dimensional aspects or orientations. As such, the descriptions of elements of the inventive subject matter herein are not limited to the particular axis or axes used to describe three-dimensional orientations of the elements. Alternatively stated, the axes may be interchangeable when referring to three-dimensional aspects of the inventive subject matter.

“Longitudinal direction,” “transverse direction,” and “vertical direction,” as used herein, refer to mutually perpendicular directions (i.e., each are orthogonal to one another). For example, the “longitudinal direction,” “transverse direction,” and the “vertical direction” as used herein may be generally parallel to the longitudinal axis, transverse axis and vertical axis, respectively, of a Cartesian coordinate system used to define three-dimensional aspects or orientations.

“Repeated cycling” as used herein in the context of cycling between charged and discharged states of the secondary battery refers to cycling more than once from a discharged state to a charged state, or from a charged state to a discharged state. For example, repeated cycling between charged and discharged states can including cycling at least 2 times from a discharged to a charged state, such as in charging from a discharged state to a charged state, discharging back to a discharged state, charging again to a charged state and finally discharging back to the discharged state. As yet another example, repeated cycling between charged and discharged states at least 2 times can include discharging from a charged state to a discharged state, charging back up to a charged state, discharging again to a discharged state and finally charging back up to the charged state By way of further example, repeated cycling between charged and discharged states can include cycling at least 5 times, and even cycling at least 10 times from a discharged to a charged state. By way of further example, the repeated cycling between charged and discharged states can include cycling at least 25, 50, 100, 300, 500 and even 1000 times from a discharged to a charged state.

“Rated capacity” as used herein in the context of a secondary battery refers to the capacity of the secondary battery to deliver a specified current over a period of time, as measured under standard temperature conditions (25° C.). For example, the rated capacity may be measured in units of Amp-hour, either by determining a current output for a specified time, or by determining for a specified current, the time the current can be output, and taking the product of the current and time. For example, for a battery rated 20 Amp-hr, if the current is specified at 2 amperes for the rating, then the battery can be understood to be one that will provide that current output for 10 hours, and conversely if the time is specified at 10 hours for the rating, then the battery can be understood to be one that will output 2 amperes during the 10 hours. In particular, the rated capacity for a secondary battery may be given as the rated capacity at a specified discharge current, such as the C-rate, where the C-rate is a measure of the rate at which the battery is discharged relative to its capacity. For example, a C-rate of 1 C indicates the discharge current that discharges the battery in one hour, 2 C indicates the discharge current that discharges the battery in ½ hours, C/2 indicates the discharge current that discharges the battery in 2 hours, etc. Thus, for example, a battery rated at 20 Amp-hr at a C-rate of 1 C would give a discharge current of 20 Amp for 1 hour, whereas a battery rated at 20 Amp-hr at a C-rate of 2 C would give a discharge current of 40 Amps for ½ hour, and a battery rated at 20 Amp-hr at a C-rate of C/2 would give a discharge current of 10 Amps over 2 hours.

“Maximum width” (W_{EA}) as used herein in the context of a dimension of an electrode assembly corresponds to the greatest width of the electrode assembly as measured from opposing points of longitudinal end surfaces of the electrode assembly in the longitudinal direction.

“Maximum length” (L_{EA}) as used herein in the context of a dimension of an electrode assembly corresponds to the greatest length of the electrode assembly as measured from opposing points of a lateral surface of the electrode assembly in the transverse direction.

“Maximum height” (H_{EA}) as used herein in the context of a dimension of an electrode assembly corresponds to the greatest height of the electrode assembly as measured from opposing points of the lateral surface of the electrode assembly in the transverse direction.

“Substantially polyhedral shape” as used herein in the context of an electrode assembly is a shape that has 6 or more flat surfaces, and in certain embodiments may contain curved surface area regions, such as at the corners or vertices of the shape.

Furthermore, as used herein, for each embodiment that describes a material or structure using the term “electrode” such as an “electrode structure” or “electrode active material,” it is to be understood that such structure and/or material may in certain embodiments correspond that of a “negative electrode”, such as a “negative electrode structure” or “negative electrode active material.” Similarly, as used herein, for each embodiment that describes a material or structure using the term “counter-electrode” such as a “counter-electrode structure” or “counter-electrode active material,” it is to be understood that such structure and/or material may in certain embodiments correspond to that of a “positive electrode,” such as a “positive electrode structure” or “positive electrode active material.” That is, where suitable, any embodiments described for an electrode and/or counter-electrode may correspond to the same embodiments where the electrode and/or counter-electrode are specifically a negative electrode and/or positive electrode, including their corresponding structures and materials, respectively.

### DETAILED DESCRIPTION

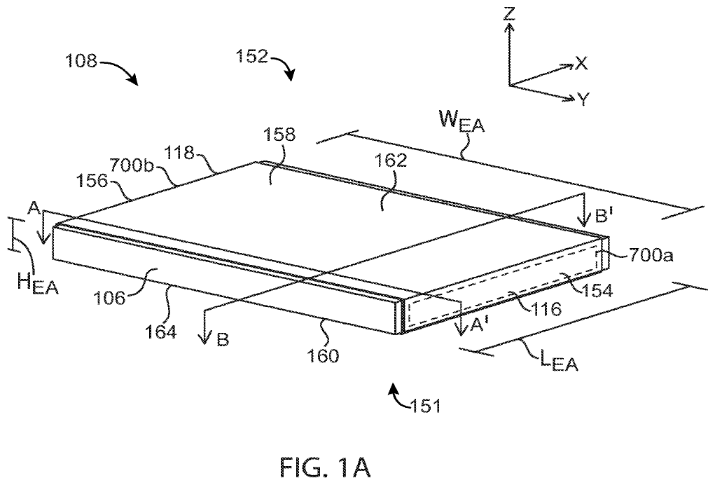

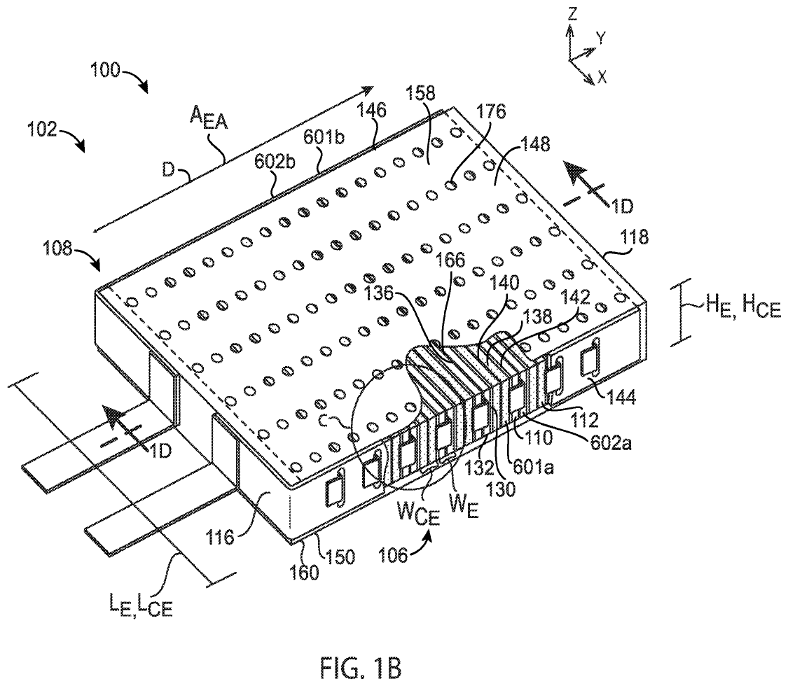

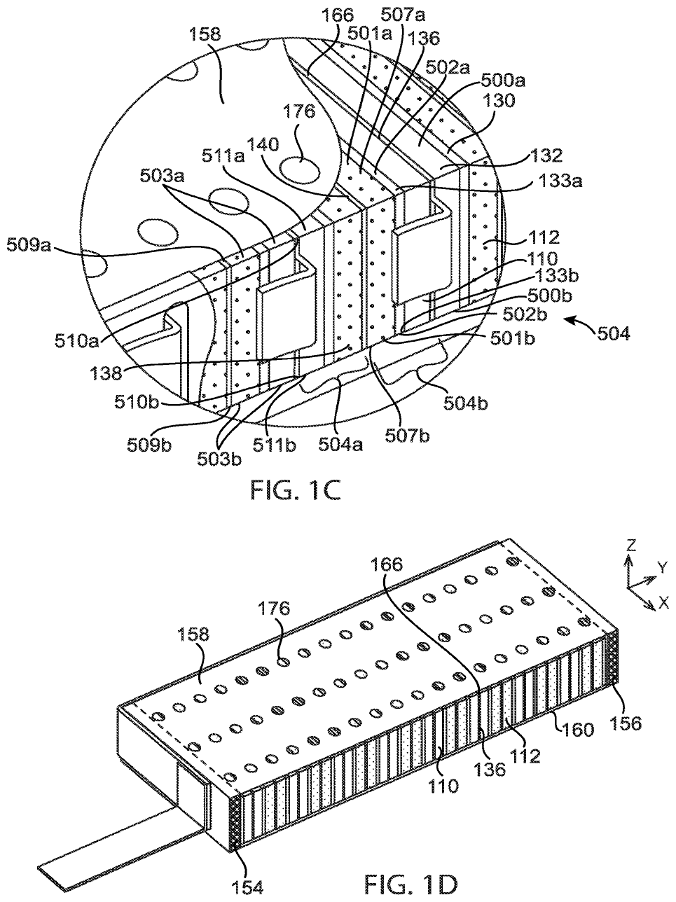

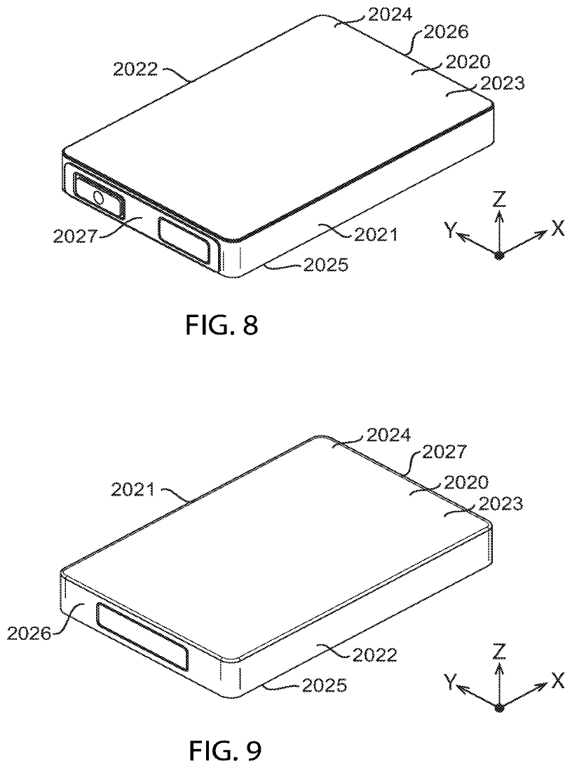

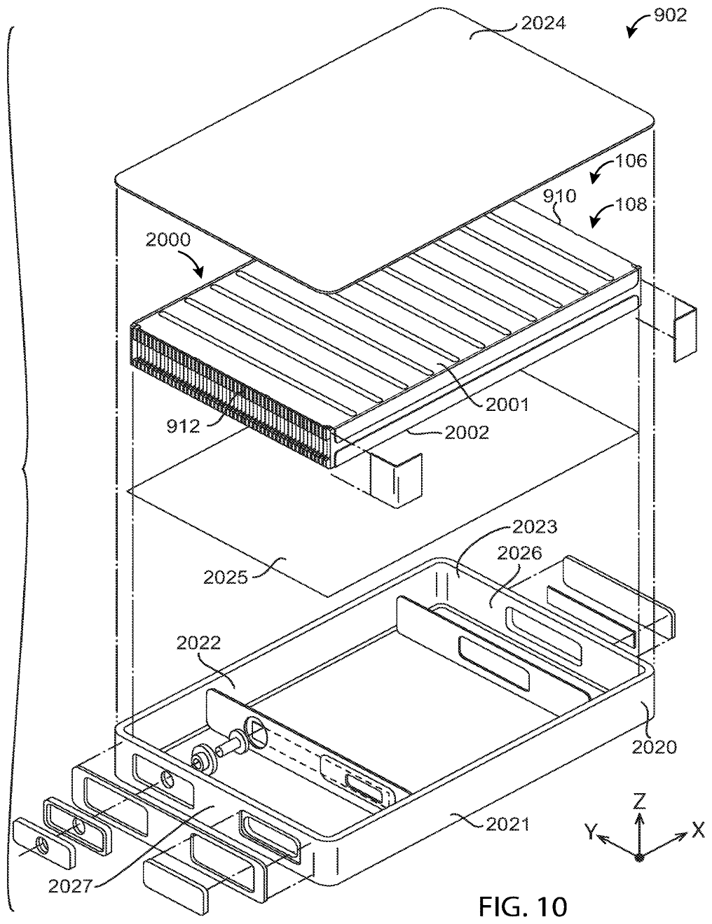

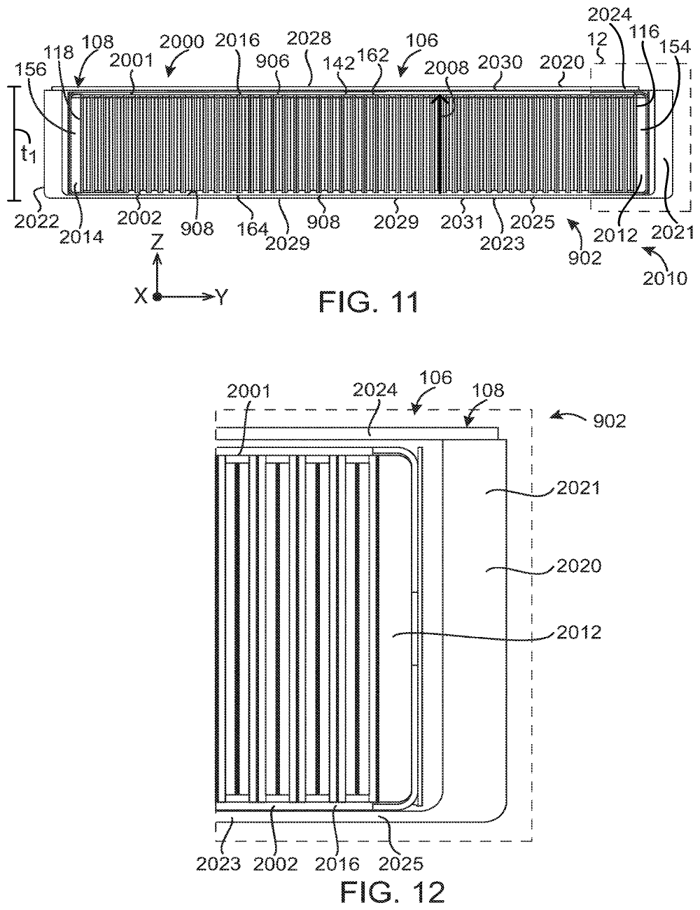

In general, the present disclosure is directed to an energy storage device 100, such as a secondary battery 102 and/or secondary battery cell 902, as shown for example in FIGS. 1A-1D, 2 and 7-12, that cycles between a charged and a discharged state. A secondary battery cell 902 may be a part of a secondary battery 102, and includes a battery enclosure 104, an electrode assembly 106, and carrier ions. In certain embodiments, a non-aqueous liquid electrolyte may be within the battery enclosure 104. In certain embodiments, the secondary battery 102 also includes a constraint system 108 that restrains growth of the electrode assembly 106. The growth of the electrode assembly 106 that is being constrained may be a macroscopic increase in one or more dimensions of the electrode assembly 106.

Referring to FIGS. 1A-1D, in one embodiment, the electrode assembly 106 includes a population of unit cells 504 stacked in series in a stacking direction (i.e. stacking direction D in FIG. 1B). Each member of the unit cell population comprises an electrode structure 110, a counter-electrode structures 112, and an electrically insulating separator 130 between the electrode and counter-electrode structures, to electrically insulate the electrode and counter-electrode structures 110, 112 from one another. In one example, as shown in FIG. 1B, the electrode assembly comprises a series of stacked unit cells 504 comprising the electrode structures 110 and counter-electrode structures in an alternating arrangement. FIG. 1C is an inset showing the secondary battery with electrode assembly 106 of FIG. 1B, and FIG. 1D is a cross-section of the secondary battery with electrode assembly 106 of FIG. 1B. Other arrangements of the stacked series of unit cells 504a, 504b, can also be provided. Accordingly, the electrode assembly can comprise a population of electrode structures, a population of counter-electrode structures, and a population of electrically insulating separator materials electrically separating members of the electrode and counter-electrode populations, where each member of the unit cell population comprises an electrode structure, a counter-electrode structure, and an electrically insulating separator between the electrode and counter-electrode structures.

In one embodiment, the electrode structures 110 comprise an electrode active material layer 132, and an electrode current collector 136, as shown for example in FIGS. 1A-1D. For example, the electrode structure can comprise an electrode current collector 136 disposed between one or more electrode active material layer 132s. According to one embodiment, the electrode active material layer 132 comprises anode active material, and the electrode current collector 136 comprises an anode current collector. Similarly, in one embodiment, counter-electrode structures 112 comprise a counter-electrode active material layer 138, and a counter-electrode current collector 140. For example, the counter-electrode structure 112 can comprise a counter-electrode current collector 140 disposed between one or more counter-electrode active material layers 138. According to one embodiment, the counter-electrode active material layer 138 comprises cathode active material, and the counter-electrode current collector 140 comprises a cathode current collector. Furthermore, it should be understood that the electrode and counter-electrode structures 110 and 112, respectively, are not limited to the specific embodiments and structures described herein, and other configurations, structures, and/or materials other than those specifically described herein can also be provided to form the electrode structures 110 and counter-electrode structures 112. According to certain embodiments, each unit cell 504a, 504b in the unit cell population comprises, in the stacked series, a unit cell portion of the electrode current collector 136, an electrode structure 110 comprising an electrode active material layer 132, an electrically insulating separator 130 between the electrode and counter-electrode active material layers, a counter-electrode structure 113 comprising a counter-electrode active material layer 138, and a unit cell portion of a counter-electrode current collector 140. In certain embodiments, the order of the unit cell portion of the electrode current collector, electrode active material layer, separator, counter-electrode active material layer, and the unit cell portion of the counter-electrode current collector will be reversed for unit cells that are adjacent to one another in the stacked series, with portions of the electrode current collector and/or counter-electrode current collector being shared between adjacent unit cells, as shown for example in FIG. 1C.

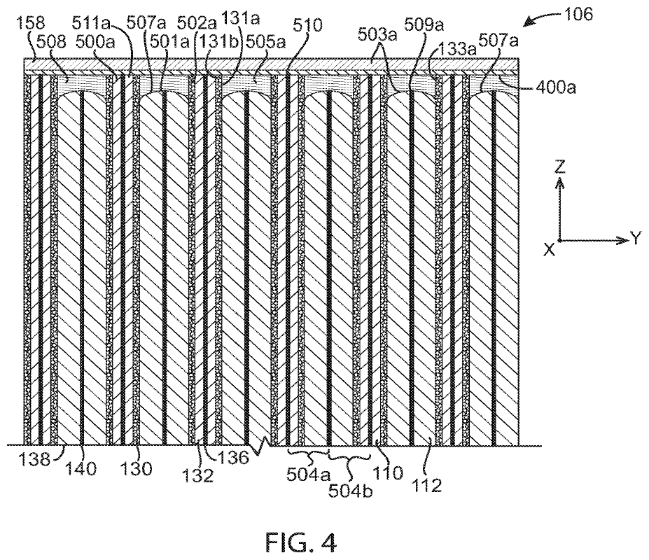

According to the embodiment as shown in FIGS. 1A-1D, the members of the electrode and counter-electrode structure populations 110 and 112, respectively, are arranged in alternating sequence, with a direction of the alternating sequence corresponding to the stacking direction D. The electrode assembly 106 according to this embodiment further comprises mutually perpendicular longitudinal, transverse, and vertical axes, with the longitudinal axis A_{EA} generally corresponding or parallel to the stacking direction D of the members of the electrode and counter-electrode structure populations. As shown in the embodiment in FIG. 1B, the longitudinal axis A_{EA} is depicted as corresponding to the Y axis, the transverse axis is depicted as corresponding to the X axis, and the vertical axis is depicted as corresponding to the Z axis. According to embodiments of the disclosure herein, the electrode structures 110, counter-electrode structures 112 and electrically insulating separators 130 within each unit cell 504 of the unit cell population have opposing upper and lower end surfaces separated in a vertical direction that is orthogonal to the stacking direction of the unit cell population. For example, referring to FIGS. 1C and 4, the electrode structures 110 in each member of the unit cell population can comprise opposing upper and lower end surfaces 500a, 500b separated in the vertical direction, the counter-electrode structures 110 in each member of the unit cell population can comprise opposing upper and lower end surfaces 501a, 501b separated in the vertical direction, and the electrically insulating separator 130 can comprise opposing upper and lower end surfaces 502a, 502b separated in the vertical direction.

Referring to FIGS. 1A-1D, according to one embodiment, the electrode assembly 106 has mutually perpendicular transverse, longitudinal and vertical axes corresponding to the x, y and z axes, respectively, of an imaginary three-dimensional Cartesian coordinate system, a first longitudinal end surface 116 and a second longitudinal end surface 118 separated from each other in the longitudinal direction, and a lateral surface 142 surrounding an electrode assembly longitudinal axis A_{EA} and connecting the first and second longitudinal end surfaces 116, 118. In one embodiment, the surface area of the first and second longitudinal end surfaces 116, 118 is less than 33% of the surface area of the electrode assembly 106. For example, in one such embodiment, the sum of the surface areas of the first and second longitudinal end surfaces 116, 118, respectively, is less than 25% of the surface area of the total surface of the electrode assembly 106. By way of further example, in one embodiment, the sum of the surface areas of the first and second longitudinal end surfaces 116, 118, respectively, is less than 20% of the surface area of the total surface of the electrode assembly. By way of further example, in one embodiment, the sum of the surface areas of the first and second longitudinal end surfaces 116, 118, respectively, is less than 15% of the surface area of the total surface of the electrode assembly. By way of further example, in one embodiment, the sum of the surface areas of the first and second longitudinal end surfaces 116, 118, respectively, is less than 10% of the surface area of the total surface of the electrode assembly.

In one embodiment, the lateral surface 142 comprises first and second regions on opposite sides of the longitudinal axis and separated in a first direction that is orthogonal to the longitudinal axis. For example, the lateral surface 142 can comprise opposing surface regions 144, 146 in the X direction (i.e., the side surfaces of the rectangular prism) and opposing surface regions 148, 150 in the Z direction. In yet another embodiment, the lateral surface can comprise a cylindrical shape. The electrode assembly 106 can further comprise a maximum width W_{EA} measured in the longitudinal direction, a maximum length L_{EA} bounded by the lateral surface and measured in the transverse direction, and a maximum height H_{EA} bounded by the lateral surface and measured in the vertical direction. In one embodiment, a ratio of the maximum length L_{EA} to the maximum height H_{EA} may be at least 2:1. By way of further example, in one embodiment a ratio of the maximum length L_{EA} to the maximum height H_{EA} may be at least 5:1. By way of further example, in one embodiment, the ratio of the maximum length L_{EA} to the maximum height H_{EA} may be at least 10:1. By way of further example, in one embodiment, the ratio of the maximum length L_{EA} to the maximum height H_{EA} may be at least 15:1. By way of further example, in one embodiment, the ratio of the maximum length L_{EA} to the maximum height H_{EA} may be at least 20:1. The ratios of the different dimensions may allow for optimal configurations within an energy storage device to maximize the amount of active materials, thereby increasing energy density.

In some embodiments, the maximum width W_{EA} may be selected to provide a width of the electrode assembly 106 that is greater than the maximum height H_{EA}. For example, in one embodiment, a ratio of the maximum width W_{EA} to the maximum height H_{EA} may be at least 2:1. By way of further example, in one embodiment, the ratio of the maximum width W_{EA} to the maximum height H_{EA} may be at least 5:1. By way of further example, in one embodiment, the ratio of the maximum width W_{EA} to the maximum height H_{EA} may be at least 10:1. By way of further example, in one embodiment, the ratio of the maximum width W_{EA} to the maximum height H_{EA} may be at least 15:1. By way of further example, in one embodiment, the ratio of the maximum width W_{EA} to the maximum height H_{EA} may be at least 20:1.

According to one embodiment, a ratio of the maximum width W_{EA} to the maximum length L_{EA} may be selected to be within a predetermined range that provides for an optimal configuration. For example, in one embodiment, a ratio of the maximum width W_{EA} to the maximum length L_{EA} may be in the range of from 1:5 to 5:1. By way of further example, in one embodiment a ratio of the maximum width W_{EA} to the maximum length L_{EA} may be in the range of from 1:3 to 3:1. By way of yet a further example, in one embodiment a ratio of the maximum width W_{EA} to the maximum length L_{EA} may be in the range of from 1:2 to 2:1.

According to embodiments of the present disclosure, each electrode structure 110 of members of the unit cell population comprise a length L_{E} as measured in the transverse direction between first and second opposing transverse end surfaces 601a, 601b of the electrode structure 110, and a height H_{E} as measured in the vertical direction between upper and lower opposing vertical end surfaces 500a, 500b of the electrode structure, and a width W_{E} as measured in the longitudinal direction between first and second opposing surfaces 603a, 603b of the electrode structure, and each counter-electrode structure of members of the unit cell population comprises a length L_{CE} as measured in the transverse direction between first and second opposing transverse end surfaces 602a, 602b of the counter-electrode structure, a height H_{CE} as measured in the vertical direction between upper and lower second opposing vertical end surfaces 501a, 501b of the counter-electrode structure, and a width W_{CE} as measured in the longitudinal direction between first and second opposing surfaces 604a, 604b of the counter-electrode structure.

According to one embodiment, a ratio of L_{E} to each of W_{E} and H_{E} is at least 5:1, respectively, and a ratio of H_{E} to W_{E} is in the range of about 2:1 to about 100:1, for electrode structures of members of the unit cell population, and the ratio of L_{CE} to each of W_{CE} and H_{CE} is at least 5:1, respectively, and a ratio of H_{CE} to W_{CE} is in the range of about 2:1 to about 100:1, for counter-electrode structures of members of the unit cell population. By way of further example, in one embodiment the ratio of L_{E} to each of W_{E} and H_{E} is at least 10:1, and the ratio of L_{CE} to each of W_{CE} and H_{CE} is at least 10:1. By way of further example, in one embodiment, the ratio of L_{E} to each of W_{E} and H_{E} is at least 15:1, and the ratio of L_{CE} to each of W_{CE} and H_{CE} is at least 15:1. By way of further example, in one embodiment, the ratio of L_{E} to each of W_{E} and H_{E} is at least 20:1, and the ratio of L_{CE} to each of W_{CE} and H_{CE} is at least 20:1.

In one embodiment, the ratio of the height (H_{E}) to the width (W_{E}) of the electrode structures is at least 0.4:1, respectively. For example, in one embodiment, the ratio of H_{E} to W_{E} will be at least 2:1, respectively, for each electrode structure of members of the unit cell population. By way of further example, in one embodiment the ratio of H_{E} to W_{E} will be at least 10:1, respectively. By way of further example, in one embodiment the ratio of H_{E} to W_{E} will be at least 20:1, respectively. Typically, however, the ratio of H_{E} to W_{E} will generally be less than 1,000:1, respectively. For example, in one embodiment the ratio of H_{E} to W_{E} will be less than 500:1, respectively. By way of further example, in one embodiment the ratio of H_{E} to W_{E} will be less than 100:1, respectively. By way of further example, in one embodiment the ratio of H_{E} to W_{E} will be less than 10:1, respectively. By way of further example, in one embodiment the ratio of H_{E} to W_{E} will be in the range of about 2:1 to about 100:1, respectively, for each electrode structure of members of the unit cell population.

In one embodiment, the ratio of the height (H_{CE}) to the width (W_{CE}) of the counter-electrode structures is at least 0.4:1, respectively. For example, in one embodiment, the ratio of H_{CE} to W_{CE} will be at least 2:1, respectively, for each counter-electrode structure of members of the unit cell population. By way of further example, in one embodiment the ratio of H_{CE} to W_{CE} will be at least 10:1, respectively. By way of further example, in one embodiment the ratio of H_{CE} to W_{CE} will be at least 20:1, respectively. Typically, however, the ratio of H_{CE} to W_{CE} will generally be less than 1,000:1, respectively. For example, in one embodiment the ratio of H_{CE} to W_{CE} will be less than 500:1, respectively. By way of further example, in one embodiment the ratio of H_{CE} to W_{CE} will be less than 100:1, respectively. By way of further example, in one embodiment the ratio of H_{CE} to W_{CE} will be less than 10:1, respectively. By way of further example, in one embodiment the ratio of H_{CE} to W_{CE} will be in the range of about 2:1 to about 100:1, respectively, for each counter-electrode structure of members of the unit cell population.

In one embodiment, the unit cell populations can comprise alternating sequence of electrode and counter-electrode structures 110 and 112, and, may include any number of members, depending on the energy storage device 100 and the intended use thereof. By way of further example, in one embodiment, and stated more generally, the population of electrode structures 110 and the population of counter-electrode structures 112 each have N members, each of N-1 electrode structure members 110 is between two counter-electrode structure members 112, each of N-1 counter-electrode structure members 112 is between two electrode structure members 110, and N is at least 2. By way of further example, in one embodiment, N is at least 4. By way of further example, in one embodiment, N is at least 5. By way of further example, in one embodiment, N is at least 10. By way of further example, in one embodiment, N is at least 25. By way of further example, in one embodiment, N is at least 50. By way of further example, in one embodiment, N is at least 100 or more.

In one embodiment, the electrode assembly 106 is enclosed within a volume V defined by the constraint system 108 that restrains overall macroscopic growth of the electrode assembly 106, as illustrated for example in FIGS. 1A and 1B. The constraint system 108 may be capable of restraining growth of the electrode assembly 106 along one or more dimensions, such as to reduce swelling and deformation of the electrode assembly 106, and thereby improve the reliability and cycling lifetime of an energy storage device 100 having the constraint system 108. Without being limited to any one particular theory, it is believed that carrier ions traveling between the electrode structures 110 and counter electrode structures 112 during charging and/or discharging of a secondary battery 102 and/or electrode assembly 106 can become inserted into electrode active material, causing the electrode active material and/or the electrode structure 110 to expand. This expansion of the electrode structure 110 can cause the electrodes and/or electrode assembly 106 to deform and swell, thereby compromising the structural integrity of the electrode assembly 106, and/or increasing the likelihood of electrical shorting or other failures. In one example, excessive swelling and/or expansion and contraction of the electrode active material layer 132 during cycling of an energy storage device 100 can cause fragments of electrode active material to break away and/or delaminate from the electrode active material layer 132, thereby compromising the efficiency and cycling lifetime of the energy storage device 100. In yet another example, excessive swelling and/or expansion and contraction of the electrode active material layer 132 can cause electrode active material to breach the electrically insulating microporous separator 130, thereby causing electrical shorting and other failures of the electrode assembly 106. Accordingly, the constraint system 108 inhibits this swelling or growth that can otherwise occur with cycling between charged and discharged states to improve the reliability, efficiency, and/or cycling lifetime of the energy storage device 100.

In one embodiment, a constraint system 108 comprising a primary growth constraint system 151 is provided to mitigate and/or reduce at least one of growth, expansion, and/or swelling of the electrode assembly 106 in the longitudinal direction (i.e., in a direction that parallels the Y axis), as shown for example in FIG. 1A. For example, the primary growth constraint system 151 can include structures configured to constrain growth by opposing expansion at longitudinal end surfaces 116, 118 of the electrode assembly 106. In one embodiment, the primary growth constraint system 151 comprises first and second primary growth constraints 154, 156, that are separated from each other in the longitudinal direction (stacking direction), and that can operate in conjunction with at least one primary connecting member 162 that connects the first and second primary growth constraints 154, 156 together to restrain growth in the electrode assembly 106 in the stacking direction. For example, the first and second primary growth constraints 154, 156 may at least partially cover first and second longitudinal end surfaces 116, 118 of the electrode assembly 106, and may operate in conjunction with connecting members 162, 164 connecting the primary growth constraints 154, 156 to one another to oppose and restrain any growth in the electrode assembly 106 that occurs during repeated cycles of charging and/or discharging.

According to embodiments herein, the primary constraint system 151 restrains growth of the electrode assembly 106 in the longitudinal direction such that any increase in the Feret diameter of the electrode assembly 106 in the longitudinal direction over 20 consecutive cycles (cycles between charged and discharges states) of the secondary battery 102 is less than 20%, or over 10 consecutive cycles of the secondary battery is less than 10%, or over 5 consecutive cycles is less than 10%, or is less than 1% per cycle of the battery. In one embodiment, any increase in the Feret diameter of the electrode assembly in the stacking direction over 20 consecutive cycles and/or 50 consecutive cycles of the secondary battery is less than 3% and/or less than 2%.

According to one embodiment, a projection of members of the electrode structure population 110 and the counter-electrode structure population 112 onto the first longitudinal surface circumscribes a first projected area 700a and a projection of the members of the electrode structure population 110 and the counter-electrode structure population 112 onto the second longitudinal surface circumscribes a second projected area 700b, and wherein the first and second primary growth constraints 154, 156 comprises first and second compression members that overlie the first and second projected areas 700a, 700b.

In addition, repeated cycling through charge and discharge processes in a secondary battery 102 can induce growth and strain not only in a longitudinal direction of the electrode assembly 106 (e.g., Y-axis in FIG. 1A), but can also induce growth and strain in directions orthogonal to the longitudinal direction, as discussed above, such as the transverse and vertical directions (e.g., X and Z axes, respectively, in FIG. 1A). Furthermore, in certain embodiments, the incorporation of a primary growth constraint system 151 to inhibit growth in one direction can even exacerbate growth and/or swelling in one or more other directions. For example, in a case where the primary growth constraint system 151 is provided to restrain growth of the electrode assembly 106 in the longitudinal direction, the intercalation of carrier ions during cycles of charging and discharging and the resulting swelling of electrode structures can induce strain in one or more other directions. In particular, in one embodiment, the strain generated by the combination of electrode growth/swelling and longitudinal growth constraints can result in buckling or other failure(s) of the electrode assembly 106 in the vertical direction (e.g., the Z axis as shown in FIG. 1A), or even in the transverse direction (e.g., the X axis as shown in FIG. 1A). Accordingly, in one embodiment of the present disclosure, a secondary growth constraint system 152 is provided that may operate in conjunction with the primary growth constraint system 151 to restrain growth of the electrode assembly 106 along multiple axes of the electrode assembly 106. For example, in one embodiment, the secondary growth constraint system 152 may be configured to interlock with, or otherwise synergistically operate with, the primary growth constraint system 151, such that overall growth of the electrode assembly 106 can be restrained to impart improved performance and reduced incidence of failure of the secondary battery having the electrode assembly 106 and primary and secondary growth constraint systems 151 and 152, respectively.

In one embodiment, a secondary constraint system 152 comprising the first and second connecting member 158, 160 restrains growth of the electrode assembly 106 in the vertical direction, such that any increase in the Feret diameter of the electrode assembly in the vertical direction over 20 consecutive cycles of the secondary battery is less than 20%, or over 10 consecutive cycles of the secondary battery is less than 10%, or over 5 consecutive cycles is less than 10%, or is less than 1% per cycle of the battery. In one embodiment, any increase in the Feret diameter of the electrode assembly in the vertical direction over 20 consecutive cycles and/or 50 consecutive cycles of the secondary battery is less than 3% and/or less than 2%.

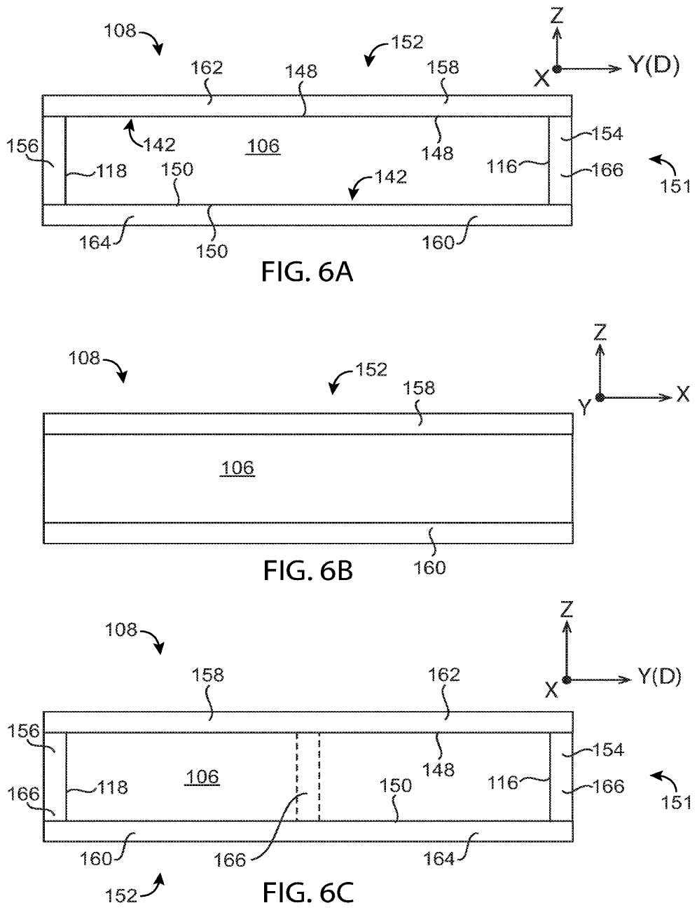

Referring to FIGS. 6A-6C, an embodiment of a constraint system 108 is shown having the primary growth constraint system 151 and the secondary growth constraint system 152 for an electrode assembly 106. FIG. 6A shows a cross-section of the electrode assembly 106 in FIG. 1A taken along the longitudinal axis (Y axis), such that the resulting 2-D cross-section is illustrated with the vertical axis (Z axis) and longitudinal axis (Y axis). FIG. 6B shows a cross-section of the electrode assembly 106 in FIG. 1A taken along the transverse axis (X axis), such that the resulting 2-D cross-section is illustrated with the vertical axis (Z axis) and transverse axis (X axis). As shown in FIG. 6A, the primary growth constraint system 151 can generally comprise first and second primary growth constraints 154, 156, respectively, that are separated from one another along the longitudinal direction (Y axis). For example, in one embodiment, the first and second primary growth constraints 154, 156, respectively, comprise a first primary growth constraint 154 that at least partially or even entirely covers a first longitudinal end surface 116 of the electrode assembly 106, and a second primary growth constraint 156 that at least partially or even entirely covers a second longitudinal end surface 118 of the electrode assembly 106. In yet another version, one or more of the first and second primary growth constraints 154, 156 may be interior to the longitudinal end surfaces 116, 118 of the electrode assembly 106, such as when one or more of the primary growth constraints comprise an internal structure of the electrode assembly 106. The primary growth constraint system 151 can further comprise at least one primary connecting member 162 that connects the first and second primary growth constraints 154, 156, and that may have a principal axis that is parallel to the longitudinal direction. For example, the primary growth constraint system 151 can comprise first and second primary connecting members 162, 164, respectively, that are separated from each other along an axis that is orthogonal to the longitudinal axis, such as along the vertical axis (Z axis) as depicted in the embodiment. The first and second primary connecting members 162, 164, respectively, can serve to connect the first and second primary growth constraints 154, 156, respectively, to one another, and to maintain the first and second primary growth constraints 154, 156, respectively, in tension with one another, so as to restrain growth along the longitudinal axis of the electrode assembly 106.

Further shown in FIGS. 6A-6C, the constraint system 108 can further comprise the secondary growth constraint system 152, that can generally comprise first and second secondary growth constraints 158, 160, respectively, that are separated from one another along a second direction orthogonal to the longitudinal direction, such as along the vertical axis (Z axis) in the embodiment as shown. For example, in one embodiment, the first secondary growth constraint 158 at least partially extends across a first region 148 of the lateral surface 142 of the electrode assembly 106, and the second secondary growth constraint 160 at least partially extends across a second region 150 of the lateral surface 142 of the electrode assembly 106 that opposes the first region 148. In yet another version, one or more of the first and second secondary growth constraints 154, 156 may be interior to the lateral surface 142 of the electrode assembly 106, such as when one or more of the secondary growth constraints comprise an internal structure of the electrode assembly 106. In one embodiment, the first and second secondary growth constraints 158, 160, respectively, are connected by at least one secondary connecting member 166, which may have a principal axis that is parallel to the second direction, such as the vertical axis. The secondary connecting member 166 may serve to connect and hold the first and second secondary growth constraints 158, 160, respectively, in tension with one another, so as to restrain growth of the electrode assembly 106 along a direction orthogonal to the longitudinal direction, such as for example to restrain growth in the vertical direction (e.g., along the Z axis). In the embodiment depicted in FIG. 6A, the at least one secondary connecting member 166 can correspond to at least one of the first and second primary growth constraints 154, 156. However, the secondary connecting member 166 is not limited thereto, and can alternatively and/or in addition comprise other structures and/or configurations.

According to one embodiment, the primary and secondary growth constraint systems 151, 152, respectively, are configured to cooperatively operate such that portions of the primary growth constraint system 151 cooperatively act as a part of the secondary growth constraint system 152, and/or portions of the secondary growth constraint system 152 cooperatively act as a part of the primary growth constraint system 151. For example, in the embodiment shown in in FIGS. 6A and 6B, the first and second primary connecting members 162, 164, respectively, of the primary growth constraint system 151 can serve as at least a portion of, or even the entire structure of, the first and second secondary growth constraints 158, 160 that constrain growth in the second direction orthogonal to the longitudinal direction. In yet another embodiment, as mentioned above, one or more of the first and second primary growth constraints 154, 156, respectively, can serve as one or more secondary connecting members 166 to connect the first and second secondary growth constrains 158, 160, respectively. Conversely, at least a portion of the first and second secondary growth constraints 158, 160, respectively, can act as first and second primary connecting members 162, 164, respectively, of the primary growth constraint system 151, and the at least one secondary connecting member 166 of the secondary growth constraint system 152 can, in one embodiment, act as one or more of the first and second primary growth constraints 154, 156, respectively. In yet another embodiment, at least a portion of the first and second primary connecting members 162, 164, respectively, of the primary growth constraint system 151, and/or the at least one secondary connecting member 166 of the secondary growth constraint system 152 can serve as at least a portion of, or even the entire structure of, the first and second tertiary growth constraints 157, 159, respectively, that constrain growth in the transverse direction orthogonal to the longitudinal direction. Accordingly, the primary and secondary growth constraint systems 151, 152, respectively, can share components and/or structures to exert restraint on the growth of the electrode assembly 106.

In one embodiment, the constraint system 108 can comprise structures such as the primary and secondary growth constraints, and primary and secondary connecting members, that are structures that are external to and/or internal to the battery enclosure 104, or may be a part of the battery enclosure 104 itself. In certain embodiments, the battery enclosure 104 may be a sealed enclosure, for example to seal liquid electrolyte therein, and/or to seal the electrode assembly 106 from the external environment. In one embodiment, the constraint system 108 can comprise a combination of structures that includes the battery enclosure 104 as well as other structural components. In one such embodiment, the battery enclosure 104 may be a component of the primary growth constraint system 151 and/or the secondary growth constraint system 152; stated differently, in one embodiment, the battery enclosure 104, alone or in combination with one or more other structures (within and/or outside the battery enclosure 104, for example, the primary growth constraint system 151 and/or a secondary growth constraint system 152) restrains growth of the electrode assembly 106 in the electrode stacking direction D and/or in the second direction orthogonal to the stacking direction, D. In one embodiment, one or more of the primary growth constraints 154, 156 and secondary growth constraints 158, 160 can comprise a structure that is internal to the electrode assembly. In another embodiment, the primary growth constraint system 151 and/or secondary growth constraint system 152 do not form any part of the battery enclosure 104, and instead one or more discrete structures (within and/or outside the battery enclosure 104) other than the battery enclosure 104 restrains growth of the electrode assembly 106 in the electrode stacking direction, D, and/or in the second direction orthogonal to the stacking direction, D. In another embodiment, the primary and secondary growth constraint systems, are within the battery enclosure, which may be a sealed battery enclosure, such as a hermetically sealed battery enclosure. The electrode assembly 106 may be restrained by the constraint system 108 at a pressure that is greater than the pressure exerted by growth and/or swelling of the electrode assembly 106 during repeated cycling of an energy storage device 100 or a secondary battery having the electrode assembly 106.

In one exemplary embodiment, the primary growth constraint system 151 includes one or more discrete structure(s) within the battery enclosure 104 that restrains growth of the electrode structure 110 in the stacking direction D by exerting a pressure that exceeds the pressure generated by the electrode structure 110 in the stacking direction D upon repeated cycling of a secondary battery 102 having the electrode structure 110 as a part of the electrode assembly 106. In another exemplary embodiment, the primary growth constraint system 151 includes one or more discrete structures within the battery enclosure 104 that restrains growth of the counter-electrode structure 112 in the stacking direction D by exerting a pressure in the stacking direction D that exceeds the pressure generated by the counter-electrode structure 112 in the stacking direction D upon repeated cycling of a secondary battery 102 having the counter-electrode structure 112 as a part of the electrode assembly 106. The secondary growth constraint system 152 can similarly include one or more discrete structures within the battery enclosure 104 that restrain growth of at least one of the electrode structures 110 and counter-electrode structures 112 in the second direction orthogonal to the stacking direction D, such as along the vertical axis (Z axis), by exerting a pressure in the second direction that exceeds the pressure generated by the electrode or counter-electrode structure 110, 112, respectively, in the second direction upon repeated cycling of a secondary battery 102 having the electrode or counter electrode structures 110, 112, respectively.

In yet another embodiment, the first and second primary growth constraints 154, 156, respectively, of the primary growth constraint system 151 restrain growth of the electrode assembly 106 by exerting a pressure on the first and second longitudinal end surfaces 116, 118 of the electrode assembly 106, meaning, in a longitudinal direction, that exceeds a pressure exerted by the first and second primary growth constraints 154, 156 on other surfaces of the electrode assembly 106 that would be in a direction orthogonal to the longitudinal direction, such as opposing first and second regions of the lateral surface 142 of the electrode assembly 106 along the transverse axis and/or vertical axis. That is, the first and second primary growth constraints 154, 156 may exert a pressure in a longitudinal direction (Y axis) that exceeds a pressure generated thereby in directions orthogonal thereto, such as the transverse (X axis) and vertical (Z axis) directions. For example, in one such embodiment, the primary growth constraint system 151 restrains growth of the electrode assembly 106 with a pressure on first and second longitudinal end surfaces 116, 118 (i.e., in the stacking direction D) that exceeds the pressure maintained on the electrode assembly 106 by the primary growth constraint system 151 in at least one, or even both, of the two directions that are perpendicular to the stacking direction D, by a factor of at least 3. By way of further example, in one such embodiment, the primary growth constraint system 151 restrains growth of the electrode assembly 106 with a pressure on first and second longitudinal end surfaces 116, 118 (i.e., in the stacking direction D) that exceeds the pressure maintained on the electrode assembly 106 by the primary growth constraint system 151 in at least one, or even both, of the two directions that are perpendicular to the stacking direction D by a factor of at least 4. By way of further example, in one such embodiment, the primary growth constraint system 151 restrains growth of the electrode assembly 106 with a pressure on first and second longitudinal end surfaces 116, 118 (i.e., in the stacking direction D) that exceeds the pressure maintained on the electrode assembly 106 in at least one, or even both, of the two directions that are perpendicular to the stacking direction D, by a factor of at least 5.

Referring now to FIG. 6C, an embodiment of an electrode assembly 106 with a constraint system 108 is shown, with a cross-section taken along the line A-A′ as shown in FIG. 1A. In the embodiment shown in FIG. 6C, the primary growth constraint system 151 can comprise first and second primary growth constraints 154, 156, respectively, at the longitudinal end surfaces 116, 118 of the electrode assembly 106, and the secondary growth constraint system 152 comprises first and second secondary growth constraints 158, 160 at the opposing first and second surface regions 148, 150 of the lateral surface 142 of the electrode assembly 106. According to this embodiment, the first and second primary growth constraints 154, 156 can serve as the at least one secondary connecting member 166 to connect the first and second secondary growth constrains 158, 160 and maintain the growth constraints in tension with one another in the second direction (e.g., vertical direction) that is orthogonal to the longitudinal direction. However, additionally and/or alternatively, the secondary growth constraint system 152 can comprise at least one secondary connecting member 166 that is located at a region other than the longitudinal end surfaces 116, 118 of the electrode assembly 106. Also, the at least one secondary connecting member 166 can be understood to act as at least one of a first and second primary growth constraint 154, 156 that is internal to the longitudinal ends 116, 118 of the electrode assembly, and that can act in conjunction with either another internal primary growth restraint and/or a primary growth restraint at a longitudinal end 116, 118 of the electrode assembly 106 to restrain growth. Referring to the embodiment shown in FIG. 6C, a secondary connecting member 166 can be provided that is spaced apart along the longitudinal axis away from the first and second longitudinal end surfaces 116, 118, respectively, of the electrode assembly 106, such as toward a central region of the electrode assembly 106. The secondary connecting member 166 can connect the first and second secondary growth constraints 158, 160, respectively, at an interior position from the electrode assembly end surfaces 116, 118, and may be under tension between the secondary growth constraints 158, 160 at that position. In one embodiment, the secondary connecting member 166 that connects the secondary growth constraints 158, 160 at an interior position from the end surfaces 116, 118 is provided in addition to one or more secondary connecting members 166 provided at the electrode assembly end surfaces 116, 118, such as the secondary connecting members 166 that also serve as primary growth constraints 154, 156 at the longitudinal end surfaces 116, 118. In another embodiment, the secondary growth constraint system 152 comprises one or more secondary connecting members 166 that connect with first and second secondary growth constraints 158, 160, respectively, at interior positions that are spaced apart from the longitudinal end surfaces 116, 118, with or without secondary connecting members 166 at the longitudinal end surfaces 116, 118. The interior secondary connecting members 166 can also be understood to act as first and second primary growth constraints 154, 156, according to one embodiment. For example, in one embodiment, at least one of the secondary connecting members 166 located at interior position(s) can comprise at least a portion of an electrode or counter electrode structure 110, 112, as described in further detail below.

More specifically, with respect to the embodiment shown in FIG. 6C, the secondary growth constraint system 152 may include a first secondary growth constraint 158 that overlies an upper region 148 of the lateral surface 142 of electrode assembly 106, and an opposing second secondary growth constraint 160 that overlies a lower region 150 of the lateral surface 142 of electrode assembly 106, the first and second secondary growth constraints 158, 160 being separated from each other in the vertical direction (i.e., along the Z-axis). Additionally, secondary growth constraint system 152 may further include at least one interior secondary connecting member 166 that is spaced apart from the longitudinal end surfaces 116, 118 of the electrode assembly 106. The interior secondary connecting member 166 may be aligned parallel to the Z axis and connects the first and second secondary growth constraints 158, 160, respectively, to maintain the growth constraints in tension with one another, and to form at least a portion of the secondary constraint system 152. In one embodiment, the at least one interior secondary connecting member 166, either alone or with secondary connecting members 166 located at the longitudinal end surfaces 116, 118 of the electrode assembly 106, may be under tension between the first and secondary growth constraints 158, 160 in the vertical direction (i.e., along the Z axis), during repeated charge and/or discharge of an energy storage device 100 and/or a secondary battery 102 having the electrode assembly 106, to reduce growth of the electrode assembly 106 in the vertical direction. Furthermore, in the embodiment as shown in FIG. 6C, the constraint system 108 further comprises a primary growth constraint system 151 having first and second primary growth constraints 154, 156, respectively, at the longitudinal ends 117, 119 of the electrode assembly 106, that are connected by first and second primary connecting members 162, 164, respectively, at the upper and lower lateral surface regions 148, 150, respectively, of the electrode assembly 106. In one embodiment, the secondary interior connecting member 166 can itself be understood as acting in concert with one or more of the first and second primary growth constraints 154, 156, respectively, to exert a constraining pressure on each portion of the electrode assembly 106 lying in the longitudinal direction between the secondary interior connecting member 166 and the longitudinal ends 117, 119 of the electrode assembly 106 where the first and second primary growth constraints 154, 156, respectively, can be located.

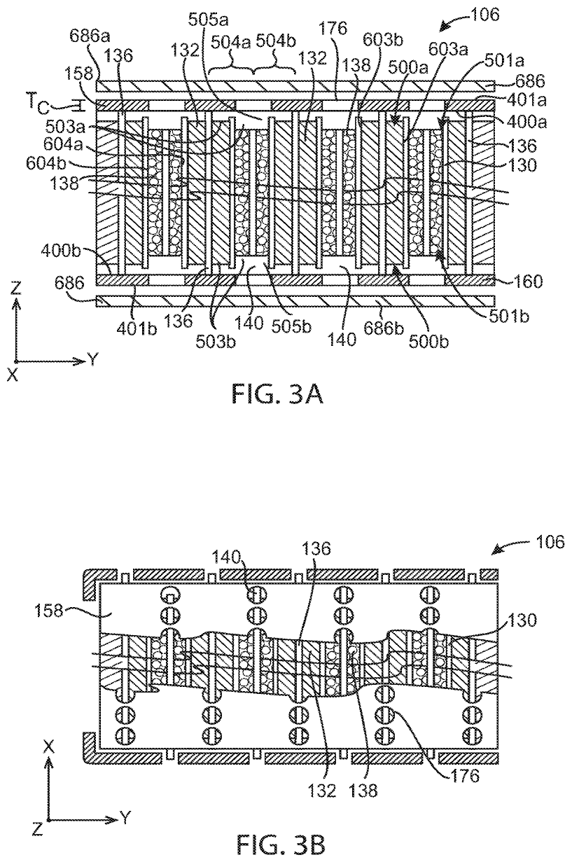

According to one embodiment, the first and second primary connecting members 162, 164 (which may be the same as the first and second secondary growth constraints 158, 160), respectively, are connected to a secondary connecting member 166 that comprises at least a portion of an electrode 110 or counter electrode 112 structure, or other interior structure of the electrode assembly 106. In one embodiment, the first primary connecting member 162 (which may be the first secondary growth constraint 158) is connected to the upper end surface(s) 500a, 501a of the electrode and/or counter-electrode structures 110, 112 of a subset 515 of members of the unit cell population 504. In another embodiment, the second primary connecting member 164 (which may be the second secondary growth constraint 160) is connected to the lower end surface(s) 500b, 501b of the electrode or counter-electrode structures 110, 112 of a subset 515 of members of the unit cell population 504. The subset 515 of the unit cell members that are connected at the upper end surface(s) may be the same as the subset of unit cell members that are connected at the lower end surface(s), or may be different subsets. In one embodiment, the first and/or second secondary growth constraints 158, 160 can be connected to other interior structures in the electrode assembly forming the secondary connecting member 166. In one embodiment, the first and/or second secondary growth constraints 158, 160 may be connected to upper and/or lower end surfaces of the electrode structures 110 and/or counter-electrode structures 112 including one or more of the electrode current collector 136, electrode active material layer 132, counter-electrode current collector 140 and counter-electrode active material layer 138, in members of the unit cell population 504. In another example, the first and second secondary growth constraints 158, 160 can be connected to upper and/or lower end surfaces of the electrically insulating separator 130. Accordingly, the secondary connecting member 166 can comprise, in certain embodiments, one or more of the electrode structures 110 and/or counter-electrodes structures 112 including one or more of the electrode current collector 136, electrode active material layer 132, counter-electrode current collector 140 and counter-electrode active material layer 138, in members of the unit cell population 504. Referring to FIGS. 3A-3B, embodiments are shown in which the first and second secondary growth constraints 158, 160 are connected to secondary connecting members 166 comprising the electrode current collectors 136 of subsets of members of the unit cell population. In FIG. 4, the first and second secondary growth constraints 158, 160 are connected to secondary connecting members 166 comprising electrode structures 110 including the electrode current collectors 136. In one embodiment, members of the population of electrode structures 110 comprise electrode current collectors 136 having opposing upper and lower end surfaces 510a, 510b in the vertical direction, and members of the population of counter-electrode structures comprise counter-electrode current collectors 140 having opposing upper and lower end surfaces 509a, 509b in the vertical direction, and wherein the first and second connecting members 162, 164 are connected to vertical end surfaces of the electrode and/or counter-electrode current collectors of the subset of members of the electrode and/or counter-electrode population.

Referring to FIG. 4, in one embodiment, the first and second primary connecting members 162, 164 separated in the vertical direction respectively connect the first and second primary growth constraints 154, 156, and further connect to a subset of the members of the electrode or counter-electrode population 110, 112. According to embodiments herein, the first and second connecting members 158, 160 have opposing upper and lower inner surfaces 400a, 400b to which the upper and lower end surfaces of the subset 500a, 501a, 500b, 501b are adhered, respectively, by an electrically-insulating, thermoplastic, hot-melt adhesive 511. In some embodiments, the hot-melt adhesive 511 comprises a material selected from but not limited to EAA (ethylene-co-acrylic acid), EMAA (ethylene-co-methacrylic acid), functionalized polyethylenes and polypropylenes, and combinations thereof. For example, in one embodiment, the hot melt adhesive comprises a mixture of EAA and EMAA copolymers. In one embodiment, the hot-melt adhesive 511 has a film shape with a thickness in the range of about 10 to about 100 micrometers and a predetermined pattern geometry.

Referring to FIGS. 3A-3B, in one embodiment, the first and/or second primary connecting members 162, 164 (which may be the same or different than the first and/or second secondary growth constraints 158, 160) comprise apertures 176 formed through respective vertical thicknesses Tc thereof. According to embodiments herein, the apertures 176 can provide passages for the flow of carrier ions from an auxiliary electrode 686 through the first and/or second primary connecting members 162, 164 and to members of the unit cell population. For example, for an auxiliary electrode 686 located outside the volume V enclosed by the constraint system 108, e.g. positioned externally to first and/or second primary connecting members 162, 164, the carrier ions provided from the auxiliary electrode 686 can access the unit cell member of the electrode assembly inside the constraints, via passage through the apertures. The auxiliary electrode 686 may be selectively electrically connected or coupled to one or more of the electrode structures 110 and/or the counter-electrode structures 112 of the unit cell members, e.g., by a switch and/or a control unit (not shown). According to certain embodiments, the auxiliary electrode is electrolytically or otherwise coupled to the counter-electrode structure and/or the electrode structure (e.g. through the separator) of members of the unit cell population, to provide a flow of carrier ions from the auxiliary electrode to the electrode and/or counter-electrode structures. By electrolytically coupled, it is meant that the carrier ions can be transferred through electrolyte, such as from the auxiliary electrode to the electrode and/or counter-electrode structures 110, 112, as well as between electrode and counter-electrode structures 110, 112. The auxiliary electrode 686 is also electrically coupled directly or indirectly to the electrode and/or counter-electrode structures, such by a series of wires or other electrical connection.

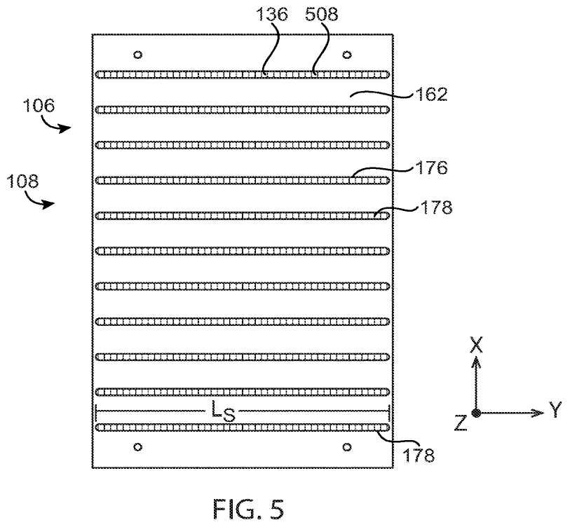

In the embodiment shown in FIG. 5, which depicts a top view of electrode assembly 106 showing the first primary connecting members 162, the apertures 176 comprise a slot-shape with the elongated dimension oriented in the longitudinal and/or stacking direction (Y-direction), and which extends across a plurality of unit cell members. Other shapes and/or configurations of the apertures 176 may also be provided. For example, in one embodiment, the plurality of apertures comprise a plurality of slots 178 spaced apart from one another in a transverse direction that is orthogonal to the stacking direction and the vertical direction, each slot 178 having a longitudinal axis L_{S} oriented in the stacking direction, and wherein each slot extends across a plurality of members of the unit cell population. In some embodiments, the first and/or second primary connecting members 162, 164 comprise bonding regions 901a, 901b of the inner surfaces 400a, 400b that are adjacent the apertures 176. The bonding regions 901a, 901b can comprise, for example, regions where adhesive such as the hot melt adhesive 511 is provided for adhering to the subset of the members of the electrode and/or counter-electrode population 110, 112. As shown in FIG. 5, in some embodiments, the apertures 176 comprise a plurality of slots extending in the longitudinal direction, and the bonding regions 901a, 901b that to adhere to the subset of the members of the electrode and/or counter-electrode population 110, 112 are located on inner surface regions 400a, 400b in between the slots of the first and/or second connecting members 158, 160.

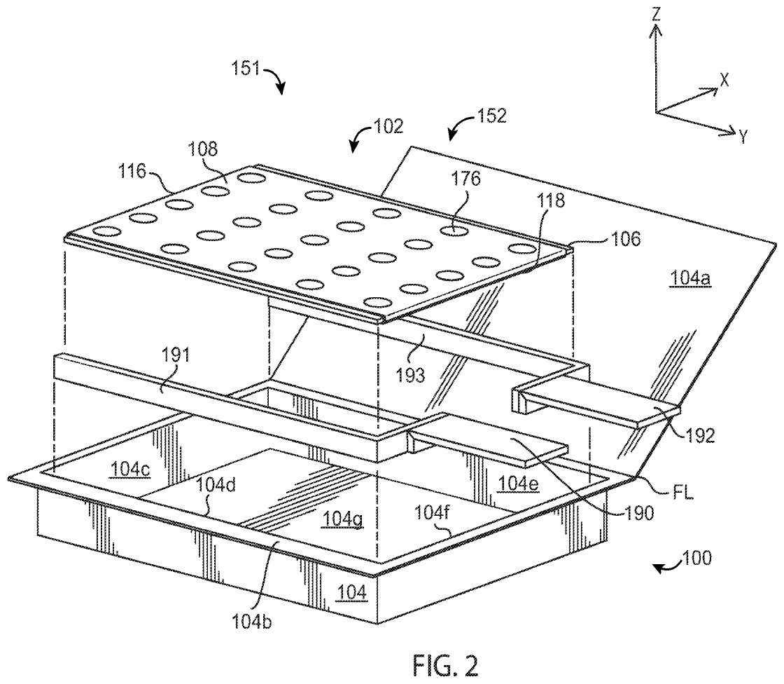

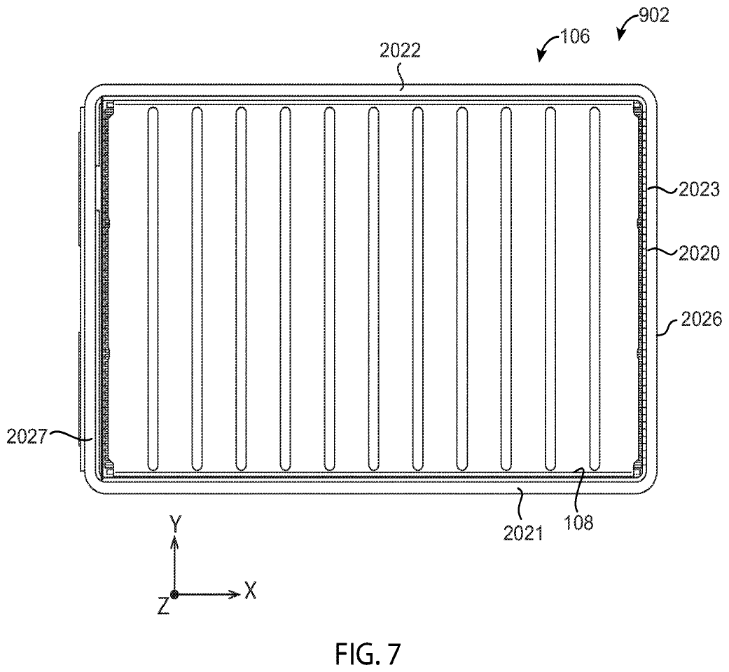

Referring now to FIG. 2, illustrated is an exploded view of one embodiment of a secondary battery 102 comprising a secondary battery cell 902 (see FIGS. 7-12), and having a constraint system 108 of the present disclosure. The secondary battery 102 includes battery enclosure 104 and an electrode assembly 106 within the battery enclosure 104, the electrode assembly 106 having a first longitudinal end surface 116, an opposing second longitudinal end surface 118 (i.e., separated from first longitudinal end surface 116 along the Y axis the Cartesian coordinate system shown), as described above. Alternatively, the secondary battery 102 may comprise just a single electrode assembly 106 with constraints 108. Each electrode assembly 106 includes a population of electrode structures 110 and a population of counter-electrode structures 112, stacked relative to each other within each of the electrode assemblies 106 in a stacking direction D; stated differently, the populations of electrode 110 and counter-electrode 112 structures are arranged in an alternating series of electrodes 110 and counter-electrodes 112 with the series progressing in the stacking direction D between first and second longitudinal end surfaces 116, 118, respectively.

According to the embodiment shown in FIG. 2, tabs 190, 192 project out of the battery enclosure 104 and provide an electrical connection between the electrode assemblies 106 and an energy supply or consumer (not shown). More specifically, in this embodiment tab 190 is electrically connected to tab extension 191 (e.g., using an electrically conductive glue), and tab extension 191 is electrically connected to the electrodes 110 comprised by each of the electrode assemblies 106. Similarly, tab 192 is electrically connected to tab extension 193 (e.g., using an electrically conductive glue), and tab extension 193 is electrically connected to the counter-electrodes 112 comprised by each of electrode assemblies 106. The tab extensions 191, 193 may also serve as bus bars that pool current from each of the respective electrode and counter-electrode structures to which they are electrically connected.

Each electrode assembly 106 in the embodiment illustrated in FIG. 2 has an associated primary growth constraint system 151 to restrain growth in the longitudinal direction (i.e., stacking direction D). Alternatively, in one embodiment, a plurality of electrode assemblies 106 may share at least a portion of the primary growth constraint system 151. In the embodiment as shown, each primary growth constraint system 151 includes first and second primary growth constraints 154, 156, respectively, that may overlie first and second longitudinal end surfaces 116, 118, respectively, as described above; and first and second opposing primary connecting members 162, 164, respectively, that may overlie lateral surfaces 142, as described above. First and second opposing primary connecting members 162, 164, respectively, may pull first and second primary growth constraints 154, 156, respectively, towards each other, or alternatively stated, assist in restraining growth of the electrode assembly 106 in the longitudinal direction, and primary growth constraints 154, 156 may apply a compressive or restraint force to the opposing first and second longitudinal end surfaces 116, 118, respectively. As a result, expansion of the electrode assembly 106 in the longitudinal direction is inhibited during formation and/or cycling of the battery 102 between charged and discharged states. Additionally, primary growth constraint system 151 exerts a pressure on the electrode assembly 106 in the longitudinal direction (i.e., stacking direction D) that exceeds the pressure maintained on the electrode assembly 106 in either of the two directions that are mutually perpendicular to each other and are perpendicular to the longitudinal direction (e.g., as illustrated, the longitudinal direction corresponds to the direction of the Y axis, and the two directions that are mutually perpendicular to each other and to the longitudinal direction correspond to the directions of the X axis and the Z axis, respectively, of the illustrated Cartesian coordinate system).

Further, each electrode assembly 106 in the embodiment illustrated in FIG. 2 has an associated secondary growth constraint system 152 to restrain growth in the vertical direction (i.e., expansion of the electrode assembly 106, electrodes 110, and/or counter-electrodes 112 in the vertical direction (i.e., along the Z axis of the Cartesian coordinate system)). Alternatively, in one embodiment, a plurality of electrode assemblies 106 share at least a portion of the secondary growth constraint system 152. Each secondary growth constraint system 152 includes first and second secondary growth constraints 158, 160, respectively, that may overlie corresponding lateral surfaces 142, respectively, and at least one secondary connecting member 166, each as described in more detail above. Secondary connecting members 166 may pull first and second secondary growth constraints 158, 160, respectively, towards each other, or alternatively stated, assist in restraining growth of the electrode assembly 106 in the vertical direction, and first and second secondary growth constraints 158, 160, respectively, may apply a compressive or restraint force to the lateral surfaces 142), each as described above in more detail. As a result, expansion of the electrode assembly 106 in the vertical direction is inhibited during formation and/or cycling of the battery 102 between charged and discharged states. Additionally, secondary growth constraint system 152 exerts a pressure on the electrode assembly 106 in the vertical direction (i.e., parallel to the Z axis of the Cartesian coordinate system) that exceeds the pressure maintained on the electrode assembly 106 in either of the two directions that are mutually perpendicular to each other and are perpendicular to the vertical direction (e.g., as illustrated, the vertical direction corresponds to the direction of the Z axis, and the two directions that are mutually perpendicular to each other and to the vertical direction correspond to the directions of the X axis and the Y axis, respectively, of the illustrated Cartesian coordinate system).

When fully assembled, the sealed secondary battery 102 occupies a volume bounded by its exterior surfaces (i.e., the displacement volume), the secondary battery enclosure 104 occupies a volume corresponding to the displacement volume of the battery (including lid 104a) less its interior volume (i.e., the prismatic volume bounded by interior surfaces 104c, 104d, 104e, 104f, 104g and lid 104a) and each growth constraint 151, 152 occupies a volume corresponding to its respective displacement volume. In combination, therefore, the battery enclosure 104 and growth constraints 151, 152 occupy no more than 75% of the volume bounded by the outer surface of the battery enclosure 104 (i.e., the displacement volume of the battery). For example, in one such embodiment, the growth constraints 151, 152 and battery enclosure 104, in combination, occupy no more than 60% of the volume bounded by the outer surface of the battery enclosure 104. By way of further example, in one such embodiment, the constraints 151, 152 and battery enclosure 104, in combination, occupy no more than 45% of the volume bounded by the outer surface of the battery enclosure 104. By way of further example, in one such embodiment, the constraints 151, 152 and battery enclosure 104, in combination, occupy no more than 30% of the volume bounded by the outer surface of the battery enclosure 104. By way of further example, in one such embodiment, the constraints 151, 152 and battery enclosure 104, in combination, occupy no more than 20% of the volume bounded by the outer surface of the battery enclosure.

In general, the primary growth constraint system 151 and/or secondary growth constraint system 152 will typically comprise a material that has an ultimate tensile strength of at least 10,000 psi (>70 MPa), that is compatible with the battery electrolyte, does not significantly corrode at the floating or anode potential for the battery 102, and does not significantly react or lose mechanical strength at 45° C., and even up to 70° C. For example, the primary growth constraint system 151 and/or secondary growth constraint system 152 may comprise any of a wide range of metals, alloys, ceramics, glass, plastics, or a combination thereof (i.e., a composite). In one exemplary embodiment, primary growth constraint system 151 and/or secondary growth constraint system 155 comprises a metal such as stainless steel (e.g., SS 316, 440C or 440 C hard), aluminum (e.g., aluminum 7075-T6, hard H18), titanium (e.g., 6Al-4V), beryllium, beryllium copper (hard), copper (O₂ free, hard), nickel; in general, however, when the primary growth constraint system 151 and/or secondary growth constraint system 155 comprises metal it is generally preferred that it be incorporated in a manner that limits corrosion and limits creating an electrical short between the electrodes 110 and counter-electrodes 112. In another exemplary embodiment, the primary growth constraint system 151 and/or secondary growth constraint system 155 comprises a ceramic such as alumina (e.g., sintered or Coorstek AD96), zirconia (e.g., Coorstek YZTP), yttria-stabilized zirconia (e.g., ENrG E-Strate®). In another exemplary embodiment, the primary growth constraint system 151 comprises a glass such as Schott D263 tempered glass. In another exemplary embodiment, the primary growth constraint system 151 and/or secondary growth constraint system 155 comprises a plastic such as polyetheretherketone (PEEK) (e.g., Aptiv 1102), PEEK with carbon (e.g., Victrex 90HMF40 or Xycomp 1000-04), polyphenylene sulfide (PPS) with carbon (e.g., Tepex Dynalite 207), polyetheretherketone (PEEK) with 30% glass, (e.g., Victrex 90HMF40 or Xycomp 1000-04), polyimide (e.g., Kapton®). In another exemplary embodiment, the primary growth constraint system 151 and/or secondary growth constraint system comprises a composite such as E Glass Std Fabric/Epoxy, 0 deg, E Glass UD/Epoxy, 0 deg, Kevlar Std Fabric/Epoxy, 0 deg, Kevlar UD/Epoxy, 0 deg, Carbon Std Fabric/Epoxy, 0 deg, Carbon UD/Epoxy, 0 deg, Toyobo Zylon® HM Fiber/Epoxy. In another exemplary embodiment, the primary growth constraint system 151 and/or secondary growth constraint system 155 comprises fibers such as Kevlar 49 Aramid Fiber, S Glass Fibers, Carbon Fibers, Vectran UM LCP Fibers, Dyneema, Zylon. In yet another embodiment, the primary growth constraint system 151 and/or secondary growth constraint system comprise a coating of insulating material such as insulating polymeric material on inner and/or outer surfaces thereof, such as for example on the inner and outer surfaces 400a, 400b, 401a, 401b of the first and second primary connecting members 162, 164.

### Fast Charging Structures and Methods Thereof

Another aspect of the present disclosure is directed to structures including an electrode assembly, and a sealed secondary battery cell comprising such electrode assembly, that are capable of fast charging, as well as methods for fast charging such structures.

Accordingly, one embodiment of the present disclosure is an electrode assembly 106 for a secondary battery 102. Referring to FIGS. 1A-1D, in one embodiment, the electrode assembly 106 has mutually perpendicular transverse, longitudinal and vertical axes corresponding to the x, y and z axes, respectively, of an imaginary three-dimensional Cartesian coordinate system, opposing longitudinal end surfaces 116, 118 that are separated from each other in the longitudinal direction, and a lateral surface surrounding an electrode assembly longitudinal axis A_{EA} and connecting the first and second longitudinal end surfaces 116, 118, the lateral surface having opposing vertical surfaces that are separated from each other in the vertical direction on opposing vertical sides of the longitudinal axis, opposing transverse surfaces that are separated from each other in the transverse direction on opposing transverse sides of the longitudinal axis, wherein the opposing longitudinal surfaces have a combined surface area, L_{SA}, the opposing transverse surfaces have a combined surface area, T_{SA}, the opposing vertical surfaces have a combined surface area, V_{SA}. The electrode assembly 106 further comprises an electrode structure population 110, an electrically insulating separator population 130, and a counter-electrode structure population 112, wherein members of the electrode structure, electrically insulating separator and counter-electrode structure populations are arranged in an alternating sequence along the longitudinal direction.

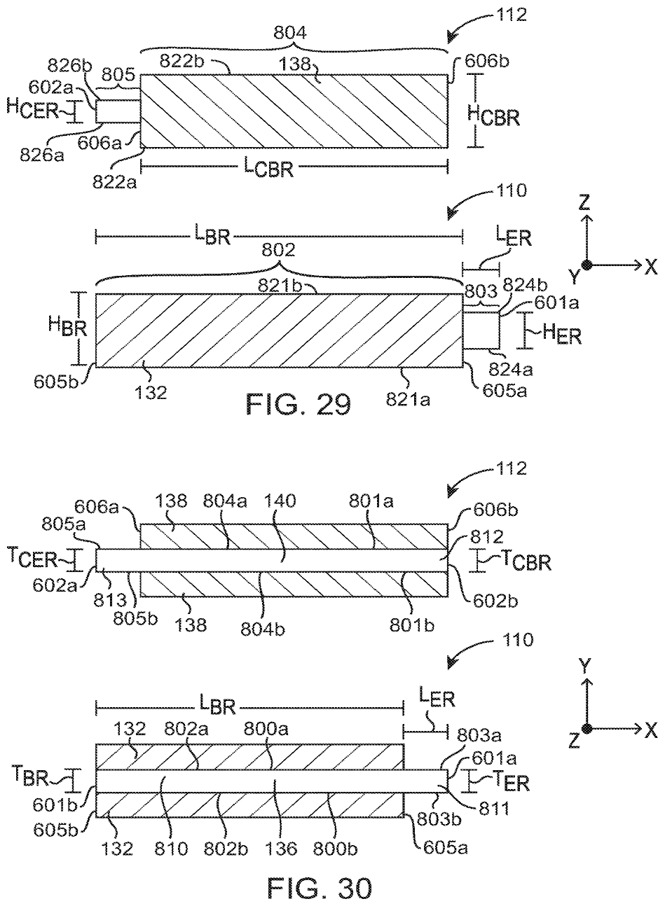

Referring to FIGS. 29-30, in one embodiment, members of the electrode structure population 110 comprise an electrode current collector 136 adjacent an electrode active material layer 132, the electrode active material layer 132 comprising opposing transverse ends 605a, 605b, and wherein members of the counter-electrode structure population 112 comprise a counter-electrode current collector 140 adjacent a counter-electrode active material layer 138, the counter-electrode active material layer comprising opposing transverse ends 606a, 606b.

Referring to FIG. 1C, in one embodiment, the electrode assembly 106 comprises a population of unit cells 504, each member of the unit cell population comprises, in a stacked series in the longitudinal direction, a unit cell portion of an electrode current collector 136, an electrode active material layer 132, an electrically insulating separator 130, a a counter-electrode active material layer 138, and a unit cell portion of a counter-electrode current collector 140.

Referring to FIGS. 29-30, in one embodiment, the electrode current collectors 136 have opposing electrode current collector surfaces 800a, 800b separated from each other in the longitudinal direction and the counter-electrode current collectors 140 have opposing counter-electrode current collector surfaces 801a, 801b separated from each other in the longitudinal direction, and one of the opposing electrode current collector surfaces comprises a coated region 802 that is covered with the electrode active material layer 132 and an uncoated region 803 that lacks the electrode active material layer, the uncoated region being proximate one of the transverse ends 601a, 601b of the electrode current collector 136.

In one embodiment, the electrode current collectors 136 have opposing electrode current collector surfaces 800a, 800b separated from each other in the longitudinal direction and the counter-electrode current collectors 140 have opposing counter-electrode current collector surfaces 801a, 801b separated from each other in the longitudinal direction, and one of the opposing counter-electrode current collector surfaces comprises a coated region 804 that is covered with the counter-electrode active material layer 138 and an uncoated region 805 that lacks the counter-electrode active material layer, the uncoated region being proximate one of the transverse ends 602a, 602b of the counter-electrode current collector 140.

In one embodiment, the electrode current collectors 136 have opposing electrode current collector surfaces 800a, 800b separated from each other in the longitudinal direction and the counter-electrode current collectors 140 have opposing counter-electrode current collector surfaces 801a, 801b separated from each other in the longitudinal direction, and each of the opposing electrode current collector surfaces comprises a coated region 802a, 802b that is covered with the electrode active material layer 132 and an uncoated region 803a, 803b that lacks the electrode active material layer, the uncoated region being proximate one of the transverse ends 601a, 601b of the electrode current collector 136.

In one embodiment, the electrode current collectors 136 have opposing electrode current collector surfaces 800a, 800b separated from each other in the longitudinal direction and the counter-electrode current collectors 140 have opposing counter-electrode current collector surfaces 801a, 801b separated from each other in the longitudinal direction, and each of the opposing counter-electrode current collector surfaces comprises a coated region 804a, 804b that is covered with the counter-electrode active material layer 132 and an uncoated region 805a, 805b that lacks the counter-electrode active material layer, the uncoated region being proximate one of the transverse ends 602a, 602b of the counter-electrode current collector 140.

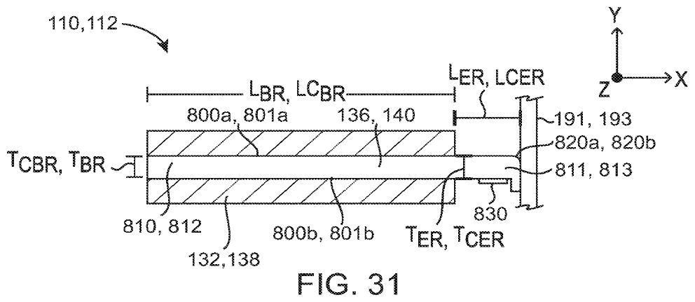

In another embodiment, members of the electrode structure population 110 comprise an electrode current collector 136 adjacent an electrode active material layer 132, the electrode active material layer 132 comprising opposing transverse ends 605a, 605b, and wherein members of the counter-electrode structure population 112 comprise a counter-electrode current collector 140 adjacent a counter-electrode active material layer 138, the counter-electrode active material layer 138 comprising opposing transverse ends 606a, 606b. In one embodiment, each member of the electrode structure population 110 comprises an electrode current collector 136 that is partially coated by the adjacent electrode active material layer 132, the electrode current collector 136 having (i) an electrode current collector body region 810 coated by the adjacent electrode active material layer 132 and extending between the opposing first and second transverse ends 605a, 605b of the adjacent electrode active material layer 132, and (ii) an electrode current collector end region 811 on a first or second transverse end 601a, 601b of the electrode current collector 136, the electrode current collector end region 811 being bounded by and extending past the first or second transverse end 605a, 605b of the adjacent electrode active material layer 132 that is on a same transverse side as the electrode current collector end region 811 In one embodiment, each member of the counter-electrode structure population 112 comprises a counter-electrode current collector 140 that is partially coated by the adjacent counter-electrode active material layer 138, the counter-electrode current collector 140 having (i) a counter-electrode current collector body region 812 coated by the adjacent counter-electrode active material layer 138 and extending between the opposing first and second transverse ends 606a, 606b of the adjacent counter-electrode active material layer 138, and (ii) a counter-electrode current collector end region 813 on a first or second transverse end 602a, 602b of the counter-electrode current collector 140, the counter-electrode current collector end region 813 being bounded by and extending past the first or second transverse end 606a, 606b of the adjacent counter-electrode active material layer 138 that is on a same transverse side as the counter-electrode current collector end region 813. Referring to FIG. 31, in one embodiment, the electrode assembly 106 further comprises an electrode busbar 191 connected to the electrode current collector end regions 811 of the electrode current collectors 136 to electrically pool current from members of the electrode structure population 110. In another embodiment, the electrode assembly further comprises a counter-electrode busbar 193 connected to the counter-electrode current collector end regions 813 of the counter-electrode current collectors 140 to electrically pool current from members of the counter-electrode structure population 112.

Referring to FIGS. 29-31, in one embodiment, the length of the electrode current collector end region 811 in the transverse direction (L_{ER}) is as measured from the first or second transverse end 605a, 605b of the adjacent electrode active material layer 132 that is on a same transverse side as the electrode current collector end region 811, to a region 820a where the electrode current collector end region 811 connects with the electrode busbar 191. In another embodiment, the length of the counter-electrode current collector end region 813 in the transverse direction (L_{CER}) is as measured from the first or second transverse end 606a, 606b of the adjacent counter-electrode active material layer 138 that is on a same transverse side as the counter-electrode current collector end region 813, to a region 820b where the counter-electrode current collector end region 813 connects with the electrode busbar 193. In one embodiment, a height of the electrode current collector body region 810 in the vertical direction (H_{BR}) is as measured between opposing vertical surfaces 821a, 821b of the electrode current collector body region 810. In one embodiment, a height of the counter-electrode current collector body region 812 in the vertical direction (H_{CBR}) is as measured between opposing vertical surfaces 822a, 822b of the counter-electrode current collector body region 812. In one embodiment, a height of the electrode current collector end region 811 in the vertical direction (H_{ER}) is as measured between opposing vertical surfaces 824a, 824b of the current collector end region 811. In one embodiment, a height of the counter-electrode current collector end region 813 in the vertical direction (H_{CER}) is as measured between opposing vertical surfaces 826a, 826b of the current collector end region 813.

In one embodiment, the length of the electrode current collector end region 811 in the transverse direction (L_{ER}) and the height of the electrode current collector body region in the vertical direction (H_{BR}) satisfy the following relationship:

L_{ER}<0.5×H_{BR}.

In another embodiment, the length of the electrode current collector end region in the transverse direction (L_{ER}) and the height of the electrode current collector body region in the vertical direction (H_{BR}) satisfy the relationship L_{ER}<0.4×H_{BR}. In another embodiment, the length of the electrode current collector end region in the transverse direction (L_{ER}) and the height of the electrode current collector body region in the vertical direction (H_{BR}) satisfy the relationship

L_{ER}<0.3×H_{BR}.

In one embodiment, the length of the counter-electrode current collector end region 813 in the transverse direction (L_{CER}) and the height of the counter-electrode current collector body region in the vertical direction (H_{CBR}) satisfy the following relationship:

L_{CER}<0.5×H_{CBR}.

In another embodiment, the length of the counter-electrode current collector end region in the transverse direction (L_{CER}) and the height of the counter-electrode current collector body region in the vertical direction (H_{CBR}) satisfy the relationship L_{CER}<0.4×H_{BR}. In another embodiment, the length of the counter-electrode current collector end region in the transverse direction (L_{CER}) and the height of the counter-electrode current collector body region in the vertical direction (H_{CBR}) satisfy the relationship L_{CER}<0.3×H_{CBR}.

In one embodiment, the height of the electrode current collector end region in the vertical direction (H_{ER}) and the height of the electrode current collector body region in the vertical direction (H_{BR}) satisfy the following relationship:

H_{ER}>0.5×H_{BR}.

In another embodiment, the height of the electrode current collector end region in the vertical direction (H_{ER}) and the height of the electrode current collector body region in the vertical direction (H_{BR}) satisfy the following relationship H_{ER}>0.7×H_{BR}. In another embodiment, the height of the electrode current collector end region in the vertical direction (H_{ER}) and the height of the electrode current collector body region in the vertical direction (H_{BR}) satisfy the relationship H_{ER}>0.9×H_{BR}.

In one embodiment, the height of the counter-electrode current collector end region in the vertical direction (H_{CER}) and the height of the counter-electrode current collector body region in the vertical direction (H_{CBR}) satisfy the following relationship:

H_{CER}>0.5×H_{CBR}.

In one embodiment, the height of the counter-electrode current collector end region in the vertical direction (H_{CER}) and the height of the counter-electrode current collector body region in the vertical direction (H_{CBR}) satisfy the relationship H_{CER}>0.7×H_{CBR}. In another embodiment, the height of the counter-electrode current collector end region in the vertical direction (H_{CER}) and the height of the counter-electrode current collector body region in the vertical direction (H_{CBR}) satisfy the relationship H_{CER}>0.9×H_{CBR}.

In one embodiment, the length of the electrode current collector end region in the transverse direction (L_{ER}) and the height of the electrode current collector end region in the vertical direction (H_{ER}) satisfy the following relationship:

L_{ER}/H_{ER}<1

In one embodiment, the length of the counter-electrode current collector end region in the transverse direction (L_{CER}) and the height of the counter-electrode current collector end region in the vertical direction (H_{CER}) satisfy the following relationship:

L_{CER}/H_{CER}<1

Referring to FIG. 31, in one embodiment, members of the electrode structure population 110 comprise electrode current collector end regions 811 having opposing surfaces 800a, 800b separated from each other in the longitudinal direction, and wherein at least one of the opposing surfaces of electrode current collector end regions comprise a layer 830 of thermally conductive material disposed thereon. In one embodiment, the electrode current collector end regions 811 electrically connect to the electrode busbar 191 via at least one of the opposing surfaces 800a, 800b, and wherein the layer of thermally conductive material is disposed on the other of the opposing surfaces 800a, 800b. In one embodiment, members of the counter-electrode structure population 112 comprise counter-electrode current collector end regions 813 having opposing surfaces 801a, 801b separated from each other in the longitudinal direction, and wherein at least one of the opposing surfaces 801a, 801b of counter-electrode current collector end regions comprise a layer 830 of thermally conductive material disposed thereon. In one embodiment, the counter-electrode current collector end regions 813 electrically connect to the counter-electrode busbar 193 via at least one of the opposing surfaces 801a, 801b, and wherein the layer 830 of thermally conductive material is disposed on the other of the opposing surfaces 801a, 801b. In one embodiment, the thermally conductive material comprises a thermally conductive ceramic material, such as alumina.

To restrain growth of the secondary battery cell during charging/discharging cycles, as shown in FIGS. 1-2 and 10, in one embodiment, the sealed secondary battery cell 102 comprises a set of electrode constraints 108, and wherein the set of electrode constraints 108 comprises a vertical constraint system 2000 comprising first and second vertical growth constraints 2001, 2002 that are separated from each other in the vertical direction, the first and second vertical growth constraints 2001, 2002 being connected to members of the population of electrode structures 110 and/or members of the population of counter-electrode structures 112, and the vertical constraint system 2000 being capable of restraining growth of the electrode assembly 106 in the vertical direction.

Another embodiment of the present disclosure is a method of charging a sealed secondary battery cell. This method comprises charging at a rate of at least 1 C, at least 2 C, at least 3 C, at least 4 C, at least 6 C, at least 10 C, at least 12 C, at least 15 C, at least 18 C, at least 20 C, and/or at least 30 C, until the sealed secondary battery reaches at predetermined capacity. In one embodiment, the method comprises charging at the charging rate until the secondary battery reaches at least 80%, at least 85%, at least 90%, at least 95%, and/or at least 99% of its rated capacity. In some embodiments, the sealed secondary battery is charged at the charging rate, and discharged, at least 200 times, (at least 300, at least 400, at least 500, at least 600, at least 800, and/or at least 1000 times. In some other embodiments, the sealed secondary battery comprises any of the electrode assemblies disclosed herein, any of the sealed secondary battery disclosed herein, or any combination thereof.

According to one embodiment, the sealed secondary battery cell disclosed herein has a rated capacity of at least 500 mAmp·hr, at least 1 Amp·hr, at least 5 Amp·hr, at least 10 Amp·hr, at least 15 Amp·hr, at least 20 Amp·hr, at least 25 Amp·hr, at least 30 Amp·hr, at least 35 Amp·hr and/or at least 50 Amp·hr.

According to another embodiment, the electrode assembly 106 disclosed herein has a substantially polyhedral shape, with opposing longitudinal end surfaces 116, 118 that are substantially flat, opposing vertical surfaces 148, 150 that are substantially flat, and opposing transverse surfaces 144, 146 that are substantially flat. In some embodiments, for the electrode assembly disclosed herein, the ratio of V_{SA} to each of L_{SA} and T_{SA} is at least 5:1.

In one embodiment, the sealed secondary battery disclosed herein comprises a core energy density of at least at least 700 Whr/liter, at least 800 Whr/liter, at least 900 Whr/liter, at least 1000 Whr/liter, at least 1100 Whr/liter, or at least 1200 Whr/liter, wherein the core energy density is defined as the rated capacity of the sealed secondary battery divided by the combined weight of the electrode structures, counter-electrode structures, separators, and any electrolyte that makes up the electrode assembly of the sealed secondary battery. The combined weight does not include the weight of the set of constraints, pack, enclosure, or pouch, etc.

In an electrode assembly disclosed herein, members of the electrode structure population comprise layers of electrode active material, and wherein the layers of electrode active material comprise a thickness in the longitudinal direction in a range of from 15 microns to 75 microns, 20 microns to 60 microns, or 30 microns to 50 microns, such as about 45 microns. In another embodiment, members of the electrode structure population comprise layers of electrode active material, and wherein the layers of electrode active material comprise a porosity in a range of from 10-40%, 12-30%, or 18-20%.

According to certain aspects, the porosity referred to herein can be measured by any suitable technique known to those of ordinary skill in the art. For example, according to one embodiment, the porosity can be determined by a mercury porosimetry technique, which is a technique that characterizes the porosity of a material by applying varying levels of pressure to a sample of the material immersed in mercury. The pressure required to intrude mercury into the pores of the sample is inversely proportional to the size of the pores. A mercury porosimetry technique is described in the National Institute of Standards and Technology (NIST) Practice Guide for Porosity and Specific Surface Area Measurements for Solid Materials, by Peter Klobes, Klaus Meyer and Ronald Munro, dated September 2006, which is hereby incorporated by reference herein in its entirety. In other embodiments, the porosity can be determined by calculating the porosity using the volume of electrode active material layer being used, as well as the weight of the electrode active material used in the electrode active material layer and its density, with the porosity being the difference between the total volume of the electrode active material layer and the volume occupied by electrode active material (the weight of the electrode active material divided by its density), as a percentage of the total volume of the electrode active material layer, as would be understood by those of ordinary skill in the art.

### Sealed Secondary Battery Cell

Referring to FIGS. 7-12, according to embodiments of the disclosure, a sealed secondary battery cell 902 that is chargeable between the charged state and the discharged state is provided. The sealed secondary battery cell 902 comprises an enclosure 104 that is a hermetically sealed case 2020 comprising a polymer enclosure material, and an electrode assembly 106 enclosed by the hermetically sealed case 2020. According to certain embodiments, a rated capacity of the sealed secondary battery cell is at least 100 mAmp·hr. According to certain embodiments, the charged state is at least 75% of the rated capacity of the secondary battery cell, and the discharged state is less than 25% of the rated capacity of the secondary battery cell.

According to certain embodiments, the electrode assembly 106 has a substantially polyhedral shape with mutually perpendicular transverse, longitudinal and vertical axes corresponding to the x, y and z axes, respectively, of an imaginary three-dimensional Cartesian coordinate system. For example, in certain embodiments the electrode assembly 106 can substantially comprise 6 substantially flat and/or entirely flat surfaces, and/or can comprise further flat surfaces, such as 8 or more flat surfaces. The electrode assembly can also, in certain embodiments, comprise curved portions, such as for example at the corners and/or vertices between otherwise flat surfaces.

According to certain embodiments, and referring again to FIGS. 7-12, the electrode assembly 106 comprises opposing longitudinal surfaces 116, 118 (i.e. first and second longitudinal end surfaces) that are substantially flat and are separated from each other in the longitudinal direction, and a lateral surface 142 surrounding an electrode assembly longitudinal axis A_{EA} and connecting the opposing longitudinal end surfaces. The lateral surface 142 comprises opposing vertical surfaces 906, 908 that are substantially flat and are separated from each other in the vertical direction on opposing vertical sides of the longitudinal axis, and comprises opposing transverse surfaces 910, 912 that are substantially flat and are separated from each other in the transverse direction on opposing transverse sides of the longitudinal axis. According to one embodiment, the opposing longitudinal surfaces 116, 118 have a combined surface area, L_{SA}, the opposing transverse surfaces 910, 912 have a combined surface area, T_{SA}, and the opposing vertical surfaces 906, 908 have a combined surface area, V_{SA}, where the ratio of V_{SA} to each of L_{SA} and T_{SA} is at least 5:1, The combined surface area is the surface area of each surface added to its opposing surface (e.g. the combined surface area of the opposing longitudinal surfaces 116, 118 is the surface area of the longitudinal surface 116 added to the surface area of the longitudinal surface 118).

According to one embodiment, the opposing longitudinal, vertical, and transverse surfaces (which are substantially flat) make up a combined surface area of greater than 66%. According to one embodiment, the opposing longitudinal, vertical, and transverse surfaces (which are substantially flat) make up a combined surface area of greater than 75%. According to one embodiment, the opposing longitudinal, vertical, and transverse surfaces (which are substantially flat) make up a combined surface area of greater than 80%. According to one embodiment, the opposing longitudinal, vertical, and transverse surfaces (which are substantially flat) make up a combined surface area of greater than 95%. According to one embodiment, the opposing longitudinal, vertical, and transverse surfaces (which are substantially flat) make up a combined surface area of greater than 99%. According to one embodiment, the opposing longitudinal, vertical, and transverse surfaces (which are substantially flat) make up substantially the entire combined surface area of the electrode assembly.

Furthermore, according to certain embodiments, and as similarly described with respect to energy storage devices and/or secondary batteries 102 above, the electrode assembly 106 of the secondary battery cell 902 comprises an electrode structure population 110, an electrically insulating separator population 130, and a counter-electrode structure population 112, wherein members of the electrode structure, electrically insulating separator and counter-electrode structure populations are arranged in an alternating sequence within the electrode assembly. In one embodiment, the members of the electrode structure, electrically insulating separator and counter-electrode structure populations are arranged in an alternating sequence in the longitudinal direction. According to one embodiment, members of the electrode structure population 110 comprise electrode active material layers 132 and electrode current collectors 136, and members of the counter-electrode structure population 112 comprise counter-electrode active material layers 138 and counter-electrode current collectors 140.

According to one embodiment, the hermetically sealed case 202 has opposing first and second case ends 2021, 2022 separated in the longitudinal direction, and a case sidewall 2023 that connects the first and second case ends 2021, 2022, the opposing first and second case ends 2021, 2022 and case sidewall 2023 forming a hermetic seal about the electrode assembly 106, wherein the case sidewall 2023 comprises upper and lower sidewalls 2024, 2025 separated from each other in the vertical direction, and first and second transverse sidewalls 2026, 2027 that are separated from each other in the transverse direction. In the embodiment as shown in FIGS. 7-12, the first and second case ends 2021, 2022, the first and second transverse sidewalls 2026, 2027 and lower sidewall 2025 form a lower enclosure portion of the case 2020, with the upper sidewall 2024 being in the form of a lid that is sealable to the lower enclosure portion to form the hermetically sealed case 2020.

According to one embodiment, a thickness ti of the secondary battery cell 902 as measured in the vertical direction between vertically opposing regions 2028, 2028 of external vertical surfaces 2030, 2031 of the upper and lower sidewalls 2024, 2025 of the hermetically sealed case 2020, is at least 1 mm. According to certain embodiments, the thickness of the secondary battery cell 902 as measured in the vertical direction between vertically opposing regions 2028, 2028 of external vertical surfaces 2030, 2031 of the upper and lower sidewalls 2024, 2025 of the hermetically sealed case 2020, is at least 2 mm. According to another embodiment, the thickness of the secondary battery cell 902 as measured in the vertical direction between vertically opposing regions 2028, 2028 of external vertical surfaces 2030, 2031 of the upper and lower sidewalls 2024, 2025 of the hermetically sealed case 2020, is at least 3 mm. According to another embodiment, the thickness of the secondary battery cell 902 as measured in the vertical direction between vertically opposing regions 2028, 2028 of external vertical surfaces 2030, 2031 of the upper and lower sidewalls 2024, 2025 of the hermetically sealed case 2020, is at least 5 mm. According to another embodiment, the thickness of the secondary battery cell 902 as measured in the vertical direction between vertically opposing regions 2028, 2028 of external vertical surfaces 2030, 2031 of the upper and lower sidewalls 2024, 2025 of the hermetically sealed case 2020, is at least 8 mm. According to another embodiment, the thickness of the secondary battery cell 902 as measured in the vertical direction between vertically opposing regions 2028, 2028 of external vertical surfaces 2030, 2031 of the upper and lower sidewalls 2024, 2025 of the hermetically sealed case 2020, is at least 10 mm.

According to one embodiment, members of the electrode structure population 110 and/or counter-electrode structure population 112 are connected to the upper and lower sidewalls 2024, 2025 of the hermetically sealed case 2020 to restrain growth of the electrode assembly in the vertical direction during cycling of the secondary battery between the charged and discharged states. According to certain embodiments, the upper and lower sidewalls 2024, 2025 (in combination with the electrode and/or counter-electrode structures to which they are connected) corresponds to the secondary growth constraint system 152 described herein, and accordingly the description of the secondary growth constraint system 152 can be considered as also applying to the upper and lower sidewalls 2024, 2025 connected to the electrode and/or counter-electrode structures. For example, the upper and lower sidewalls 2024, 2025 can correspond to the first and second secondary growth constraints 158, 160, described herein, and the members of the population of electrode structures 110 and/or members of the population of counter-electrode structures 112 can correspond to the at least one connecting member 166. As with the secondary growth constraint system described above, the upper and lower sidewalls 2024, 2025 connected to the electrode and/or counter-electrode structures are capable of restraining growth of the electrode assembly in the vertical direction. Members of the population of electrode structures and/or members of the population of counter-electrode structures that are connected to the upper and lower sidewalls 2024, 2025 have a thickness as measured in the longitudinal direction that is in a range of between 5 and 50 μm, and a yield strength of greater than 100 MPa, to provide the restraint of growth in the vertical direction.

Furthermore, according to certain embodiments, the first and second case ends 2021, 2022 that are separated from each other in the longitudinal direction can act to restrain growth in the longitudinal direction. For example, the opposing first and second case ends 2021, 2022 can be connected together by one or more of the upper and lower sidewalls of the case 2024, 2025, and restrain growth of the electrode assembly in the longitudinal direction. In one embodiment, the first and second case ends 2021, 2022 (in combination with one or more of the upper and lower sidewalls 2024, 2025) can correspond to the primary growth constraint system 151 described elsewhere herein, and accordingly the description of the primary growth constraint system 151 can be considered as also applying to the first and second case ends 2021, 2022 as connected by one or more of the upper and lower sidewalls 2024, 2025). For example, the opposing first and second case ends 2021, 2022 can correspond to the first and second primary growth constraints 154, 156, described herein, and they can be connected by primary connecting members 162, 164 corresponding to the upper and lower sidewalls 2024, 2025 of the case.

In one embodiment, the sealed secondary battery cell 902 further comprises a set of electrode constraints 108 internal to the hermetically sealed case 2020, the set of electrode constraints comprising an internal vertical constraint system 2020 comprising first and second vertical growth constraints 2001, 2002 that are separated from each other in the vertical direction, the first and second vertical growth constraints 2001, 2002 being connected to members of the population of electrode structures and/or members of the population of counter-electrode structures. The vertical constraint system 2000 is capable of restraining growth of the electrode assembly in the vertical direction and the first and second vertical growth constraints 2001, 2002 are connected to the respective upper and lower sidewalls 2024, 2025, to indirectly connect the members of the population of electrode structures and/or members of the population of counter-electrode structures to the upper and lower sidewalls. For example, the first and second vertical growth constraints 2001, 2002 can be adhered to the upper and lower sidewalls 2024, 2025 with an adhesive, to complete a connection of the members of the electrode and/or counter-electrode population to the upper and lower sidewalls 2024, 2025 of the hermetically sealed case 2020. According to certain embodiments, the vertical constraint system 2000, either alone or in combination with the upper and lower sidewalls 2024, 2025 of the case, can correspond to the primary growth constraint system 151 described elsewhere herein, and accordingly the description of the primary growth constraint system 151 can be considered as also applying to the vertical constraints system 2000. For example, the first and second vertical growth constraints 2001, 2002, either alone or in combination with the upper and lower sidewalls 2024, 2025, can correspond to the first and second secondary growth constraints 158, 160, described herein, and they can be connected by secondary connecting members 166 corresponding to members of the electrode and/or counter-electrode structure population. In embodiments where an internal set of electrode constraints 108 are provided, members of the population of electrode structures and/or members of the population of counter-electrode structures that are connected to the upper and lower sidewalls have a thickness as measured in the longitudinal direction that is in a range of between 5 and 50 μm, and a yield strength of greater than 100 MPa, to restrain growth in the vertical direction.

According to yet another embodiment, the set of electrode constraints 108 that are internal to the hermetically sealed case 2020 further comprise a longitudinal constraint system 2010 comprising first and second longitudinal growth constraints 2012, 2014 separated from each other in the longitudinal direction, and connected by a connecting member 2016 to restrain growth of the electrode assembly in the longitudinal direction. According to certain embodiments, the longitudinal constraint system 2010, either alone or in combination with the first and second case ends 2021, 2022, can correspond to the primary growth constraint system 151 described elsewhere herein, and accordingly the description of the primary growth constraint system 151 can be considered as also applying to the longitudinal constraint system 2010. For example, the first and second longitudinal growth constraints 2012, 2014, either alone or in combination with the first and second case ends 2021, 2022, can correspond to the first and second primary growth constraints 154, 156, described herein, and they can be connected by primary connecting members 162, 164 corresponding to first and second vertical growth constraints 2002, 2002, either alone or in combination with the upper and lower sidewalls 2024, 2025.

According to one embodiment, a thermal conductivity of the secondary battery cell 902 along a thermally conductive path 2008 between the vertically opposing regions 2028, 2029 of the external vertical surfaces 2030, 2031 of the upper and lower sidewalls 2024, 2025 of the hermetically sealed case 2020 in the vertical direction is at least 7.5 W/m·K. According to another embodiment, the thermal conductivity of the secondary battery cell 902 along the thermally conductive path 2008 between the vertically opposing regions 2028, 2029 of the external vertical surfaces 2030, 2031 of the upper and lower sidewalls 2024, 2025 of the hermetically sealed case 2020 in the vertical direction is at least 8 W/m·K. According to another embodiment, the thermal conductivity of the secondary battery cell 902 along the thermally conductive path 2008 between the vertically opposing regions 2028, 2029 of the external vertical surfaces 2030, 2031 of the upper and lower sidewalls 2024, 2025 of the hermetically sealed case 2020 in the vertical direction is at least 10 W/m·K. According to another embodiment, the thermal conductivity of the secondary battery cell 902 along the thermally conductive path 2008 between the vertically opposing regions 2028, 2029 of the external vertical surfaces 2030, 2031 of the upper and lower sidewalls 2024, 2025 of the hermetically sealed case 2020 in the vertical direction is at least 15 W/m·K. According to certain embodiments, the thermally conductive path 2008 is along the vertical direction of members of the population of electrode structures 110 and/or members of the population of counter-electrode structures 112 that are connected to the first and second vertical growth constraints 2001, 2002.

According to certain embodiments, the sealed secondary battery cell 902 has a rated capacity of at least 150 mAmp·hr. According to another embodiment, the sealed secondary battery cell 902 has a rated capacity of at least 200 mAmp·hr. According to another embodiment, the sealed secondary battery cell 902 has a rated capacity of at least 400 mAmp·hr. According to another embodiment, the sealed secondary battery cell 902 has a rated capacity of at least 0.1 Amp·hr. According to another embodiment, the sealed secondary battery cell 902 has a rated capacity of at least 0.5 Amp·hr. According to another embodiment, the sealed secondary battery cell 902 has a rated capacity of at least 1 Amp·hr. According to another embodiment, the sealed secondary battery cell 902 has a rated capacity of at least 3 Amp·hr. According to another embodiment, the sealed secondary battery cell 902 has a rated capacity of at least 5 Amp·hr.

According to one embodiment, the hermetically sealed case 2020 comprises a metal material comprising any selected from the group consisting of stainless steel, aluminum, titanium, beryllium, beryllium, copper, nickel, and alloys thereof. For example, the metal material in certain embodiments is any of the metal materials disclosed as suitable for the primary growth constraint system 151 and/or secondary growth constraint system 152 herein. In one embodiment, the metal material used for the case, such as the upper and lower sidewalls, comprises any of stainless steel and aluminum. In certain embodiments, the metal materials used for the case can be resistant to erosion by any electrolyte used in the secondary battery cell, and can serve to contain such electrolyte within the cell. According to certain embodiments where an internal set of electrode constraints 108 is provided within the hermetically sealed case 2020, the first and second vertical growth constraints, and/or first and second longitudinal constraints, can comprise any of the materials specified for either of the primary and secondary growth constraint systems 151, 152 herein, such as for example any of metals, alloys, ceramics, glass, plastics, or a combination thereof. In one embodiment, the first and second vertical growth constraints 2001, 2002 comprise any one or more of stainless steel and aluminum.

According to one embodiment, the upper and lower sidewalls 2024, 2025, either alone or in combination with the first and second vertical growth constraints 2001, 2002, have a yield strength of at least 70 MPa. According to one embodiment, the upper and lower sidewalls 2024, 2025, either alone or in combination with the first and second vertical growth constraints 2001, 2002, have a yield strength of at least 100 MPa. According to another embodiment, the upper and lower sidewalls 2024, 2025, either alone or in combination with the first and second vertical growth constraints 2001, 2002, have a yield strength of at least 150 MPa. According to another embodiment, the upper and lower sidewalls 2024, 2025, either alone or in combination with the first and second vertical growth constraints 2001, 2002, have a yield strength of at least 200 MPa. According to another embodiment, the upper and lower sidewalls 2024, 2025, either alone or in combination with the first and second vertical growth constraints 2001, 2002, have a yield strength of at least 300 MPa. According to another embodiment, the upper and lower sidewalls 2024, 2025, either alone or in combination with the first and second vertical growth constraints 2001, 2002, have a yield strength of at least 500 MPa.

According to one embodiment, the upper and lower sidewalls 2024, 2025 either alone or in combination with the first and second vertical growth constraints 2001, 2002 have a tensile strength of at least 70 MPa. According to one embodiment, the upper and lower sidewalls, either alone or in combination with the first and second vertical growth constraints, have a tensile strength of at least 100 MPa. According to another embodiment, the upper and lower sidewalls 2024, 2025, either alone or in combination with the first and second vertical growth constraints 2001, 2002, have a tensile strength of at least 150 MPa. According to another embodiment, the upper and lower sidewalls 2024, 2025, either alone or in combination with the first and second vertical growth constraints 2001, 2002, have a tensile strength of at least 200 MPa. According to another embodiment, the upper and lower sidewalls 2024, 2025, either alone or in combination with the first and second vertical growth constraints 2001, 2002, have a tensile strength of at least 300 MPa. According to another embodiment, the upper and lower sidewalls 2024, 2025, either alone or in combination with the first and second vertical growth constraints 2001, 2002, have a tensile strength of at least 500 MPa.

According to one embodiment, the first and second case ends 2021, 2022, either alone or in combination with first and second longitudinal growth constraints 2012, 2014, have a yield strength of at least 70 MPa. According to one embodiment, the first and second case ends 2021, 2022, either alone or in combination with first and second longitudinal growth constraints 2012, 2014, have a yield strength of at least 100 MPa. In another embodiment, the first and second case ends 2021, 2022, either alone or in combination with first and second longitudinal growth constraints 2012, 2014, have a yield strength of at least 150 MPa. In another embodiment, the first and second case ends 2021, 2022, either alone or in combination with first and second longitudinal growth constraints 2012, 2014, have a yield strength of at least 200 MPa. In another embodiment, the first and second case ends 2021, 2022, either alone or in combination with first and second longitudinal growth constraints 2012, 2014, have a yield strength of at least 300 MPa. In another embodiment, the first and second case ends 2021, 2022, either alone or in combination with first and second longitudinal growth constraints 2012, 2014, have a yield strength of at least 500 MPa.

According to one embodiment, the first and second case ends 2021, 2022, either alone or in combination with first and second longitudinal growth constraints 2012, 2014, have a tensile strength of at least 70 MPa. According to one embodiment, the first and second case ends 2021, 2022, either alone or in combination with first and second longitudinal growth constraints 2012, 2014, have a tensile strength of at least 100 MPa. In another embodiment, the first and second case ends 2021, 2022, either alone or in combination with first and second longitudinal growth constraints 2012, 2014, have a tensile strength of at least 150 MPa. In another embodiment, the first and second case ends 2021, 2022, either alone or in combination with first and second longitudinal growth constraints 2012, 2014, have a tensile strength of at least 200 MPa. In another embodiment, the first and second case ends 2021, 2022, either alone or in combination with first and second longitudinal growth constraints 2012, 2014, have a tensile strength of at least 300 MPa. In another embodiment, the first and second case ends 2021, 2022, either alone or in combination with first and second longitudinal growth constraints 2012, 2014 have a tensile strength of at least 500 MPa.

According to one embodiment, the members of the population of electrode structures and/or members of the population of counter-electrode structures that are connected to the upper and lower sidewalls 2024, 2025 have a yield strength of greater than 70 MPa. In another embodiment, the members of the population of electrode structures and/or members of the population of counter-electrode structures that are connected to the upper and lower sidewalls 2024, 2025 have a yield strength of greater than 100 MPa. In another embodiment, the members of the population of electrode structures and/or members of the population of counter-electrode structures that are connected to the upper and lower sidewalls 2024, 2025 have a yield strength of greater than 150 MPa. In another embodiment, the members of the population of electrode structures and/or members of the population of counter-electrode structures that are connected to the upper and lower sidewalls 2024, 2025 have a yield strength of greater than 200 MPa. In another embodiment, the members of the population of electrode structures and/or members of the population of counter-electrode structures that are connected to the upper and lower sidewalls 2024, 2025 have a yield strength of greater than 300 MPa. In another embodiment, the members of the population of electrode structures and/or members of the population of counter-electrode structures that are connected to the upper and lower sidewalls 2024, 2025 have a yield strength of greater than 500 MPa.

According to one embodiment, the members of the population of electrode structures and/or members of the population of counter-electrode structures that are connected to the upper and lower sidewalls 2024, 2025 have a tensile strength of greater than 70 MPa. In another embodiment, the members of the population of electrode structures and/or members of the population of counter-electrode structures that are connected to the upper and lower sidewalls 2024, 2025 have a tensile strength of greater than 100 MPa. In another embodiment, the members of the population of electrode structures and/or members of the population of counter-electrode structures that are connected to the upper and lower sidewalls 2024, 2025 have a tensile strength of greater than 150 MPa. In another embodiment, the members of the population of electrode structures and/or members of the population of counter-electrode structures that are connected to the upper and lower sidewalls 2024, 2025 have a tensile strength of greater than 200 MPa. In another embodiment, the members of the population of electrode structures and/or members of the population of counter-electrode structures that are connected to the upper and lower sidewalls 2024, 2025 have a tensile strength of greater than 300 MPa. In another embodiment, the members of the population of electrode structures and/or members of the population of counter-electrode structures that are connected to the upper and lower sidewalls 2024, 2025 have a tensile strength of greater than 500 MPa.

According to one embodiment, the first and second longitudinal growth constraints comprise a thickness in the longitudinal direction of at least 150 μm. In another embodiment, the first and second longitudinal growth constraints comprise a thickness in the longitudinal direction of at least 250 μm. In another embodiment, the first and second longitudinal growth constraints comprise a thickness in the longitudinal direction of at least 400 um.

According to one embodiment, the upper and lower sidewalls 2024, 2025 are connected to upper and lower surfaces of members of the electrode structure population and/or counter-electrode structure population. For example, the upper and lower sidewalls 2024, 2025 can be connected to upper and lower end surfaces 500a, 500b separated in the vertical direction of members of the electrode structure population, and/or upper and lower end surfaces 501a, 501b of counter-electrode structures separated in the vertical direction. According to another embodiment, the upper and lower sidewalls 2024, 2025 can be connected to upper and lower end surfaces 502a, 502b separated in the vertical direction of the separator 130. In one embodiment, the upper and lower sidewalls 2024, 2025 are connected to upper and lower surfaces of electrode current collectors of members of the electrode structure population, and/or upper and lower surfaces of counter-electrode current collectors of members of the counter-electrode population. In one embodiment, the first and second vertical growth constraints 2001, 2002 are connected to upper and lower surfaces of members of the electrode structure population and/or counter-electrode structure population, which first and second vertical growth constraints 2001, 2002 are in turn connected to the upper and lower sidewalls 2024, 2025. In another embodiment, the first and second vertical growth constraints 2001, 2002 are connected to upper and lower surfaces of electrode current collectors of members of the electrode structure population, and/or upper and lower surfaces of counter-electrode current collectors of members of the counter-electrode population, which first and second vertical growth constraints 2001, 2002 are in turn directly connected to the upper and lower sidewalls 2024, 2025. For example, in one embodiment, the electrode and/or counter-electrode current collectors are connected to the upper and lower sidewalls 2024, 2025 (e.g. either directly or via the first and second vertical growth constraints), and comprise a thickness as measured in the longitudinal direction that is in a range of between 5 and 50 μm, and a yield strength of greater than 100 MPa, to provide restraint of growth in the vertical direction. In one embodiment, the electrode current collectors are connected to the upper and lower sidewalls 2024, 2025 (e.g. either directly or via the first and second vertical growth constraints), and comprise a thickness as measured in the longitudinal direction that is in a range of between 5 and 50 μm, and a yield strength of greater than 100 MPa. The electrode and/or counter-electrode current collectors may also have any of the yield strengths and/or tensile strengths otherwise described herein as suitable for members of the electrode and/or counter-electrode structure population that are connected to the upper and lower sidewalls 2024, 2025.

According to one embodiment, the upper and lower sidewalls 2024, 2025 connected to the members of the electrode structure population or counter-electrode structure population, alone or together with the internal vertical constraint system, constrain growth in the vertical direction such that any increase in the Feret diameter of the electrode assembly over 20 consecutive cycles is less than 2%. In another embodiment the upper and lower sidewalls 2024, 2025 connected to the members of the electrode structure population or counter-electrode structure population, alone or together with the internal vertical constraint system, constrain growth in the vertical direction such that any increase in the Feret diameter of the electrode assembly over 30 consecutive cycles is less than 2%. In another embodiment, the upper and lower sidewalls 2024, 2025 connected to the members of the electrode structure population or counter-electrode structure population, alone or together with the internal vertical constraint system, constrain growth in the vertical direction such that any increase in the Feret diameter of the electrode assembly over 50 consecutive cycles is less than 2%. In another embodiment, the upper and lower sidewalls 2024, 2025 connected to the members of the electrode structure population or counter-electrode structure population, alone or together with the internal vertical constraint system, constrain growth in the vertical direction such that any increase in the Feret diameter of the electrode assembly over 80 consecutive cycles is less than 2%. In another embodiment, the upper and lower sidewalls 2024, 2025 connected to the members of the electrode structure population or counter-electrode structure population, alone or together with the internal vertical constraint system, constrain growth in the vertical direction such that any increase in the Feret diameter of the electrode assembly over 100 consecutive cycles is less than 2%.

In one embodiment, members of the population of electrode structures 110 and/or members of the population of counter-electrode structures 112 are connected directly to the upper and lower sidewalls 2024, 2025 of the case. According to another embodiment, the members of the population of electrode structures 110 and/or members of the population of counter-electrode structures 112 are connected indirectly to the upper and lower sidewalls 2024, 2025 of the case, such as via the first and second vertical growth constraints. For example, the members of the population of electrode structures and/or members of the population of counter-electrode structures can be directly connected to first and second vertical growth constraints, which in turn are connected to the upper and lower sidewalls 2024 2025. According to certain embodiments, members of the population of electrode structures and/or members of the population of counter-electrode structures are connected directly to the upper and lower sidewalls by any one or more of one or more of adhering, gluing, welding, bonding, joining, soldering, sintering, press contacting, brazing, thermal spraying joining, clamping, wire bonding, ribbon bonding, ultrasonic bonding, ultrasonic welding, resistance welding, laser beam welding, electron beam welding, induction welding, cold welding, plasma spraying, flame spraying, and arc spraying. According to certain embodiments, members of the population of electrode structures and/or members of the population of counter-electrode structures are connected directly to the first and second vertical growth constraints by any one or more of one or more of adhering, gluing, welding, bonding, joining, soldering, sintering, press contacting, brazing, thermal spraying joining, clamping, wire bonding, ribbon bonding, ultrasonic bonding, ultrasonic welding, resistance welding, laser beam welding, electron beam welding, induction welding, cold welding, plasma spraying, flame spraying, and arc spraying. According to certain embodiments, the first and second vertical growth constraints are connected directly to respective upper and lower sidewalls by any one or more of one or more of adhering, gluing, welding, bonding, joining, soldering, sintering, press contacting, brazing, thermal spraying joining, clamping, wire bonding, ribbon bonding, ultrasonic bonding, ultrasonic welding, resistance welding, laser beam welding, electron beam welding, induction welding, cold welding, plasma spraying, flame spraying, and arc spraying. In one embodiment, opposing vertical surfaces of the members of the electrode structures and/or members of the population of counter-electrode structures are connected to any of the first and second vertical growth constraints, and/or upper and lower sidewalls, and/or the first and second vertical growth constraints are connected to the upper and lower sidewalls, by an adhesive.

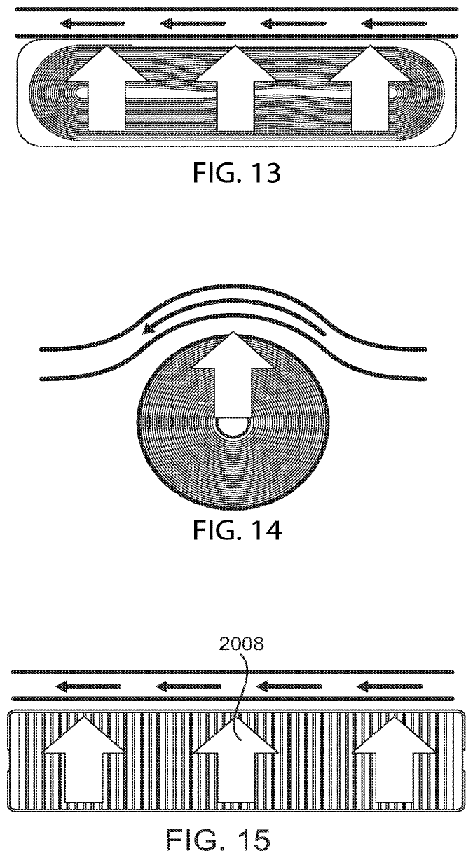

Referring to FIG. 15, comparing to other secondary battery cells (FIGS. 13 and 14), aspects of the present disclosure provide an efficient thermally conductive path for heat dissipation during battery cycling (hollow arrows indicate the heat path inside a secondary battery cell, and solid lines indicate the cooling paths used to cool the outside of the secondary battery cell). As can be seen in FIG. 15, according to aspects herein, a direct thermally conductive pathway is provided along the electrode and/or counter electrode structures to the greatest surface area surfaces (i.e. vertical surfaces) of the secondary battery cell, such that cooling of these surfaces removes a significant amount of heat. In contrast, in FIGS. 13-14, the heat exit path crosses numerous different layers of the electrode assemblies, such that heat not efficiently conveyed to the surface of the secondary battery cell.

Members of the electrode 110 and counter-electrode 112 populations include an electroactive material capable of absorbing and releasing a carrier ion such as lithium, sodium, potassium, calcium, magnesium or aluminum ions. In some embodiments, members of the electrode structure 110 population include an anodically active electroactive material (sometimes referred to as a negative electrode) and members of the counter-electrode structure 112 population include a cathodically active electroactive material (sometimes referred to as a positive electrode). In other embodiments, members of the electrode structure 110 population include a cathodically active electroactive material and members of the counter-electrode structure 112 population comprise an anodically active electroactive material. In each of the embodiments and examples recited in this paragraph, negative electrode active material may be, for example, a particulate agglomerate electrode, an electrode active material formed from a particulate material, such as by forming a slurry of the particulate material and casting into a layer shape, or a monolithic electrode.

According to one embodiment, an electrode active material used in an electrode structure 110 corresponding to an anode of the electrode assembly 106 comprises a material that expands upon insertion of carrier ions into the electrode active material during charge of the secondary battery 102 and/or electrode assembly 106. For example, the electrode active materials may comprise anodically active materials that accept carrier ions during charging of the secondary battery, such as by intercalating with or alloying with the carrier ions, in an amount that is sufficient to generate an increase in the volume of the electrode active material. For example, in one embodiment the electrode active material may comprise a material that has the capacity to accept more than one mole of carrier ion per mole of electrode active material, when the secondary battery 102 is charged from a discharged to a charged state. By way of further example, the electrode active material may comprise a material that has the capacity to accept 1.5 or more moles of carrier ion per mole of electrode active material, such as 2.0 or more moles of carrier ion per mole of electrode active material, and even 2.5 or more moles of carrier ion per mole of electrode active material, such as 3.5 moles or more of carrier ion per mole of electrode active material. The carrier ion accepted by the electrode active material may be at least one of lithium, potassium, sodium, calcium, and magnesium. Examples of electrode active materials that expand to provide such a volume change include one or more of silicon (e.g., SiO), aluminum, tin, zinc, silver, antimony, bismuth, gold, platinum, germanium, palladium, and alloys and compounds thereof. For example, in one embodiment, the electrode active material can comprise a silicon-containing material in particulate form, such as one or more of particulate silicon, particulate silicon oxide, and mixtures thereof. In yet another embodiment, the electrode active material can comprise a material that exhibits a smaller or even negligible volume change. For example, in one embodiment the electrode active material can comprise a carbon-containing material, such as graphite. In yet another embodiment, the electrode structure comprises a layer of lithium metal, which can serve as an electrode current collector, and on which electrode active material deposits via transfer of carrier ions to the lithium metal layer during a charging process.

Exemplary anodically active electroactive materials include carbon materials such as graphite and soft or hard carbons, or any of a range of metals, semi-metals, alloys, oxides and compounds capable of forming an alloy with lithium. Specific examples of the metals or semi-metals capable of constituting the anode material include graphite, tin, lead, magnesium, aluminum, boron, gallium, silicon, Si/C composites, Si/graphite blends, SiOx, porous Si, intermetallic Si alloys, indium, zirconium, germanium, bismuth, cadmium, antimony, silver, zinc, arsenic, hafnium, yttrium, lithium, sodium, graphite, carbon, lithium titanate, palladium, and mixtures thereof. In one exemplary embodiment, the anodically active material comprises aluminum, tin, or silicon, or an oxide thereof, a nitride thereof, a fluoride thereof, or other alloy thereof. In another exemplary embodiment, the anodically active material comprises silicon, silicon oxide, or an alloy thereof.

In yet further embodiment, the anodically active material can comprise lithium metals, lithium alloys, carbon, petroleum cokes, activated carbon, graphite, silicon compounds, tin compounds, and alloys thereof. In one embodiment, the anodically active material comprises carbon such as non-graphitizable carbon, graphite-based carbon, etc.; a metal complex oxide such as LiₓFe₂O₃ (0≤x≤1), LiₓWO₂ (0≤x≤1), SnₓMe₁₋ₓMe′_{y}O_{z}(Me: Mn, Fe, Pb, Ge; Me′: Al, B, P, Si, elements found in Group 1, Group 2 and Group 3 in a periodic table, halogen; 0≤x≤1; 1≤y≤3; 1≤z≤8), etc.; a lithium metal; a lithium alloy; a silicon-based alloy; a tin-based alloy; a metal oxide such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, Bi₂O₅, etc.; a conductive polymer such as polyacetylene, etc.; Li—Co—Ni-based material, etc. In one embodiment, the anodically active material can comprise carbon-based active material include crystalline graphite such as natural graphite, synthetic graphite and the like, and amorphous carbon such as soft carbon, hard carbon and the like. Other examples of carbon material suitable for anodically active material can comprise graphite, Kish graphite, pyrolytic carbon, mesophase pitch-based carbon fibers, meso-carbon microbeads, mesophase pitches, graphitized carbon fiber, and high-temperature sintered carbon such as petroleum or coal tar pitch derived cokes. In one embodiment, the negative electrode active material may comprise tin oxide, titanium nitrate and silicon. In another embodiment, the negative electrode can comprise lithium metal, such as a lithium metal film, or lithium alloy, such as an alloy of lithium and one or more types of metals selected from the group consisting of Na, K, Rb, Cs, Fr, Be, Mg, Ca, Sr, Ba, Ra, Al and Sn. In yet another embodiment, the anodically active material can comprise a metal compound capable of alloying and/or intercalating with lithium, such as Si, Al, C, Pt, Sn, Pb, Ir, Ni, Cu, Ti, Na, K, Rb, Cs, Fr, Be, Ca, Sr, Sb, Ba, Ra, Ge, Zn, Bi, In, Mg, Ga, Cd, a Si alloy, a Sn alloy, an Al alloy or the like; a metal oxide capable of doping and dedoping lithium ions such as SiOᵥ (0<v<2), SnO₂, vanadium oxide or lithium vanadium oxide; and a composite including the metal compound and the carbon material such as a Si—C composite or a Sn—C composite. For example, in one embodiment, the material capable of alloying/intercalating with lithium may be a metal, such as lithium, indium, tin, aluminum, or silicon, or an alloy thereof; a transition metal oxide, such as Li₄/3Ti₅/3O₄ or SnO; and a carbonaceous material, such as artificial graphite, graphite carbon fiber, resin calcination carbon, thermal decomposition vapor growth carbon, corks, mesocarbon microbeads (“MCMB”), furfuryl alcohol resin calcination carbon, polyacene, pitch-based carbon fiber, vapor growth carbon fiber, or natural graphite. In yet another embodiment, the negative electrode active material can comprise a composition suitable for a carrier ion such as sodium or magnesium. For example, in one embodiment, the negative electrode active material can comprise a layered carbonaceous material; and a composition of the formula NaₓSn_{y-z}M_{z} disposed between layers of the layered carbonaceous material, wherein M is Ti, K, Ge, P, or a combination thereof, and 0<x≤15, 1≤y≤5, and 0≤z≤1.

In one embodiment, the negative electrode active material may further comprise a conductive material and/or conductive aid, such as carbon-based materials, carbon black, graphite, graphene, active carbon, carbon fiber, carbon black such as acetylene black, Ketjen black, channel black, furnace black, lamp black, thermal black or the like; a conductive fiber such as carbon fiber, metallic fiber or the like; a conductive tube such as carbon nanotubes or the like; metallic powder such as carbon fluoride powder, aluminum powder, nickel powder or the like; a conductive whisker such as zinc oxide, potassium titanate or the like; a conductive metal oxide such as titanium oxide or the like; or a conductive material such as a polyphenylene derivative or the like. In addition, metallic fibers such as metal mesh; metallic powders such as copper, silver, nickel and aluminum; or organic conductive materials such as polyphenylene derivatives may also be used. In yet another embodiment, a binder may be provided, such as for example one or more of polyethylene, polyethylene oxide, polypropylene, polytetrafluoroethylene (PTFE), polyvinylidene fluoride (PVDF), styrene-butadiene rubber, a tetrafluoroethylene-perfluoro alkylvinyl ether copolymer, a vinylidene fluoride-hexafluoropropylene copolymer, a vinylidene fluoride-chlorotrifluoroethylene copolymer, an ethylene-tetrafluoroethylene copolymer, a polychlorotrifluoroethylene, vinylidene fluoride-pentafluoro propylene copolymer, a propylene-tetrafluoroethylene copolymer, an ethylene-chlorotrifluoroethylene copolymer, a vinylidene fluoride-hexafluoropropylene-tetrafluoroethylene copolymer, a vinylidene fluoride-perfluoromethylvinyl ether-tetrafluoro ethylene copolymer, an ethylene-acrylic acid copolymer and the like may be used either alone or as a mixture.

Exemplary cathodically active materials include any of a wide range of cathode active materials. For example, for a lithium-ion battery, the cathodically active material may comprise a cathode material selected from transition metal oxides, transition metal sulfides, transition metal nitrides, lithium-transition metal oxides, lithium-transition metal sulfides, and lithium-transition metal nitrides may be selectively used. The transition metal elements of these transition metal oxides, transition metal sulfides, and transition metal nitrides can include metal elements having a d-shell or f-shell. Specific examples of such metal element are Sc, Y, lanthanoids, actinoids, Ti, Zr, Hf, V, Nb, Ta, Cr, Mo, W, Mn, Tc, Re, Fe, Ru, Os, Co, Rh, Ir, Ni, Pb, Pt, Cu, Ag, and Au. Additional cathode active materials include LiCoO₂, LiNi_{0.5}Mn_{1.5}O₄, Li(NiₓCo_{y}Al_{z})O₂, LiFePO₄, Li₂MnO₄, V₂O₅, molybdenum oxysulfides, phosphates, silicates, vanadates, sulfur, sulfur compounds, oxygen (air), Li(NiₓMn_{y}Co_{z})O₂, and combinations thereof. Furthermore, compounds for the cathodically active material layers can comprise lithium-containing compounds further comprising metal oxides or metal phosphates such as compounds comprising lithium, cobalt and oxygen (e.g., LiCoO₂), compounds comprising lithium, manganese and oxygen (e.g., LiMn₂O₄) and compound comprising lithium iron and phosphate (e.g., LiFePO). In one embodiment, the cathodically active material comprises at least one of lithium manganese oxide, lithium cobalt oxide, lithium nickel oxide, lithium iron phosphate, or a complex oxide formed from a combination of aforesaid oxides. In another embodiment, the cathodically active material can comprise one or more of lithium cobalt oxide (LiCoO₂), lithium nickel oxide (LiNiO₂), etc. or a substituted compound with one or more transition metals; lithium manganese oxide such as Li₁₊ₓMn₂₋ₓO₄ (where, x is 0 to 0.33), LiMnO₃, LiMn₂O₃, LiMnO₂, etc.; lithium copper oxide (Li₂CuO₂); vanadium oxide such as LiV₃O₈, LiFe₃O₄, V₂O₅, Cu₂V₂O₇ etc.; Ni site-type lithium nickel oxide represented by the chemical formula of LiNi₁₋ₓMₓO₂ (where, M=Co, Mn, Al, Cu, Fe, Mg, B or Ga, and x=0.01 to 0.3); lithium manganese complex oxide represented by the chemical formula of LiMn₂₋ₓMₓO₂ (where, M=Co, Ni, Fe, Cr, Zn or Ta, and x=0.01 to 0.1) or Li₂Mn₃MO₈ (where, M=Fe, Co, Ni, Cu or Zn); LiMn₂O₄ in which a portion of Li is substituted with alkaline earth metal ions; a disulfide compound; Fe₂(MoO₄)₃, and the like. In one embodiment, the cathodically active material can comprise a lithium metal phosphate having an olivine crystal structure of Formula Li₁₊ₐFe₁₋ₓM′ₓ(PO_{4-b})X_{b} wherein M′ is at least one selected from Al, Mg, Ni, Co, Mn, Ti, Ga, Cu, V, Nb, Zr, Ce, In, Zn, and Y, X is at least one selected from F, S, and N, −0.5≤a≤+0.5, 0≤x≤0.5, and 0≤b≤0.1, such at least one of LiFePO₄, Li(Fe, Mn)PO₄, Li(Fe, Co)PO₄, Li(Fe, Ni)PO₄, or the like. In one embodiment, the cathodically active material comprises at least one of LiCoO₂, LiNiO₂, LiMnO₂, LiMn₂O₄, LiNi_{1-y}Co_{y}O₂, LiCo_{1-y}Mn_{y}O₂, LiNi_{1-y}Mn_{y}O₂ (0≤y≤1), Li(NiₐCo_{b}Mn_{c})O₄ (0≤a≤2, 0≤b≤2, 0≤c≤2, and a+b+c=2), LiMn_{2-z}Ni_{z}O₄, LiMn_{2-z}Co_{z}O₄ (0<z<2), LiCoPO₄ and LiFePO₄, or a mixture of two or more thereof.

In yet another embodiment, a cathodically active material can comprise elemental sulfur (S8), sulfur series compounds or mixtures thereof. The sulfur series compound may specifically be Li₂Sₙ(n≥1), an organosulfur compound, a carbon-sulfur polymer ((C₂Sₓ)ₙ: x=2.5 to 50, n≥2) or the like. In yet another embodiment, the cathodically active material can comprise an oxide of lithium and zirconium.

In yet another embodiment, the cathodically active material can comprise at least one composite oxide of lithium and metal, such as cobalt, manganese, nickel, or a combination thereof, may be used, and examples thereof are LiₐA_{1-b}M_{b}D₂ (wherein, 0.90≤a≤1, and 0≤b≤0.5); LiₐE_{1-b}M_{b}O_{2-c} (wherein, 0.90≤a≤1, 0≤b≤0.5, and 0≤c≤0.05); LiE_{2-b}M_{b}O_{4-c}D_{c} (wherein, 0≤b≤0.5, and 0≤c≤0.05); LiₐNi_{1-c}Co_{b}M_{c}Dₐ (wherein, 0.90≤a≤1, 0≤b≤0.5, 0≤c≤0.05, and 0≤a≤2); LiₐNi_{1-c}Co_{b}M_{c}O₂₋ₐXₐ (wherein, 0.90≤a≤1, 0≤b≤0.5, 0≤c≤0.05, and 0≤a≤2); LiₐNi_{1-b-c}CO_{b}M_{c}O₂₋ₐX₂ (wherein, 0.90≤a≤1, 0≤b≤0.5, 0≤c≤0.05, and 0≤a≤2); LiₐNi_{1-b-c}Mn_{b}M_{c}Dₐ (wherein, 0.90≤a≤1, 0≤b≤0.5, 0≤c≤0.05, and 0≤a≤2); LiₐNi_{1-b-c}Mn_{b}M_{c}O₂₋ₐXₐ (wherein, 0.90≤a≤1, 0≤b≤0.5, 0≤c≤0.05, and 0≤a≤2); LiₐNi_{1-b-c}Mn_{b}M_{c}O₂₋ₐX₂ (wherein, 0.90≤a≤1, 0≤b≤0.5, 0≤c≤0.05, and 0≤a≤2); LiₐNi_{b}E_{c}G_{d}O₂ (wherein, 0.90≤a≤1, 0b≤0.9, 0≤c≤05.5, and 0.001<d<0.1); LiₐNi_{b}Co_{c}Mn_{d}GₑO₂ (wherein, 0.90≤a≤1, 0≤b≤0.9, 0≤c≤0.5, 0≤d≤0.5, and 0.001≤e≤0.1); LiₐNiG_{b}O₂ (wherein, 0.90≤a≤1 and 0.001≤b≤0.1); LiₐCoG_{b}O₂ (wherein, 0.90≤a≤1 and 0.001≤b≤0.1); LiₐMnG_{b}O₂ (wherein, 0.90≤a≤1 and 0.001≤b≤0.1); LiₐMn₂G_{b}O₄ (wherein, 0.90≤a≤1 and 0.001≤b≤0.1); QO₂; QS₂; LiQS₂; V₂O₅; LiV₂O₈; LiX′O₂; LiNiVO₄; Li_{(3-f)}J₂(PO₄)₃ (0≤f≤2); Li_{(3-f)}Fe₂(PO₄)₃ (0≤f≤2); and LiFePO₄. In the formulas above, A is Ni, Co, Mn, or a combination thereof; M is Al, Ni, Co, Mn, Cr, Fe, Mg, Sr, V, a rare-earth element, or a combination thereof; D is O, F, S, P, or a combination thereof; E is Co, Mn, or a combination thereof; X is F, S, P, or a combination thereof; G is Al, Cr, Mn, Fe, Mg, La, Ce, Sr, V, or a combination thereof; Q is Ti, Mo, Mn, or a combination thereof, X′ is Cr, V, Fe, Sc, Y, or a combination thereof, and J is V, Cr, Mn, Co, Ni, Cu, or a combination thereof. For example, LiCoO₂, LiMnxO₂ₓ (x=1 or 2), LiNi₁₋ₓMnₓO₂ₓ(0≤x≤1), LiNi_{1-x-y}CoₓMn_{y}O₂ (0≤x≤0.5, 0≤y≤0.5), or FePO₄ may be used. In one embodiment, the cathodically active material comprises at least one of a lithium compound such as lithium cobalt oxide, lithium nickel oxide, lithium nickel cobalt oxide, lithium nickel cobalt aluminum oxide, lithium nickel cobalt manganese oxide, lithium manganese oxide, or lithium iron phosphate; nickel sulfide; copper sulfide; sulfur; iron oxide; or vanadium oxide.

In one embodiment, the cathodically active material can comprise a sodium containing material, such as at least one of an oxide of the formula NₐM¹ₐO₂ such as NaFeO₂, NaMnO₂, NaNiO₂, or NaCoO₂; or an oxide represented by the formula NaMn₁₋ₐM¹ₐO₂, wherein M¹ is at least one transition metal element, and 0≤a≤1. Representative positive active materials include Na[Ni_{1/2}Mn_{1/2}]O₂, Na_{2/3}[Fe_{1/2}Mn_{1/2}]O₂, and the like; an oxide represented by Na_{0.44}Mn₁₋ₐM¹ₐO₂, an oxide represented by Na_{0.7}Mn₁₋ₐM¹ₐ O_{2.05} an (wherein M¹ is at least one transition metal element, and 0≤a≤1); an oxide represented by Na_{b}M²_{c}Si₁₂O₃₀ as Na₆Fe₂Si₁₂O₃₀ or Na₂Fe₅Si₁₂O (wherein M² is at least one transition metal element, 2≤b≤6, and 2≤c≤5); an oxide represented by Na_{d}M³ₑSi₆O₁₈ such as Na₂Fe₂Si₆O₁₈ or Na₂MnFeSi₆O₁₈ (wherein M³ is at least one transition metal element, 3<d<6, and 1≤e≤2); an oxide represented by Na_{f}M⁴_{g}Si₂O₆ such as Na₂FeSiO₆ (wherein M⁴ is at least one element selected from transition metal elements, magnesium (Mg) and aluminum (Al), 1≤f≤2 and 1≤g≤2); a phosphate such as NaFePO₄, Na₃Fe₂(PO₄)₃, Na₃V₂(PO₄)₃, Na₄Co₃(PO₄)₂P₂O₇ and the like; a borate such as NaFeBO₄ or Na₃Fe₂(BO₄)₃; a fluoride represented by NaₕM⁵F₆ such as Na₃FeF₆ or Na₂MnF₆ (wherein M⁵ is at least one transition metal element, and 2≤h≤₃), a fluorophosphate such as Na₃V₂(PO₄)₂F₃, Na₃V₂(PO₄)₂FO₂ and the like. The positive active material is not limited to the foregoing and any suitable positive active material that is used in the art can be used. In an embodiment, the positive active material preferably comprises a layered-type oxide cathode material such as NaMnO₂, Na[Ni_{1/2}Mn_{1/2}]O₂ and Na_{2/3}[Fe_{1/2}Mns_{1/2}]O₂, a phosphate cathode such as Na₃V₂(PO₄)₃ and Na₄Co₃(PO₄)₂P₂O₇, or a fluorophosphate cathode such as Na₃V₂(PO₄)₂F₃ and Na₃V₂(PO₄)₂FO₂.

In one embodiment, the electrode current collector can comprise a negative electrode current collector, and can comprise a suitable conductive material, such as a metal material. For example, in one embodiment, the negative electrode current collector can comprise at least one of copper, nickel, aluminum, stainless steel, titanium, palladium, baked carbon, calcined carbon, indium, iron, magnesium, cobalt, germanium, lithium a surface treated material of copper or stainless steel with carbon, nickel, titanium, silver, an aluminum-cadmium alloy, and/or other alloys thereof. As another example, in one embodiment, the negative electrode current collector comprises at least one of copper, stainless steel, aluminum, nickel, titanium, baked carbon, a surface treated material of copper or stainless steel with carbon, nickel, titanium, silver, an aluminum-cadmium alloy, and/or other alloys thereof. In one embodiment, the negative electrode current collector comprises at least one of copper and stainless steel.

In one embodiment, the counter-electrode current collector can comprise a positive electrode current collector, and can comprise a suitable conductive material, such as a metal material. In one embodiment, the positive electrode current collector comprises at least one of stainless steel, aluminum, nickel, titanium, baked carbon, sintered carbon, a surface treated material of aluminum or stainless steel with carbon, nickel, titanium, silver, and/or an alloy thereof. In one embodiment, the positive electrode current collector comprises aluminum.

In yet another embodiment, the cathodically active material can further comprise one or more of a conductive aid and/or binder, which for example may be any of the conductive aids and/or binders described for the anodically active material herein.

According to certain embodiments, electrically insulating separator layers 130 may electrically isolate each member of the electrode structure 110 population from each member of the counter-electrode structure 112 population. The electrically insulating separator layers are designed to prevent electrical short circuits while also allowing the transport of ionic charge carriers that are needed to close the circuit during the passage of current in an electrochemical cell. In one embodiment, the electrically insulating separator layers are microporous and permeated with an electrolyte, e.g., a non-aqueous liquid or gel electrolyte. Alternatively, the electrically insulating separator layer may comprise a solid electrolyte, i.e., a solid ion conductor, which can serve as both a separator and the electrolyte in a battery.

In certain embodiments, electrically insulating separator layers 130 will typically include a microporous separator material that can be permeated with a non-aqueous electrolyte; for example, in one embodiment, the microporous separator material includes pores having a diameter of at least 50 Å, more typically in the range of about 2,500 Å, and a porosity in the range of about 25% to about 75%, more typically in the range of about 35-55%. Additionally, the microporous separator material may be permeated with a non-aqueous electrolyte to permit conduction of carrier ions between adjacent members of the electrode and counter-electrode populations. In certain embodiments, for example, and ignoring the porosity of the microporous separator material, at least 70 vol % of electrically insulating separator material between a member of the electrode structure 110 population and the nearest member(s) of the counter-electrode structure 112 population (i.e., an “adjacent pair”) for ion exchange during a charging or discharging cycle is a microporous separator material; stated differently, microporous separator material constitutes at least 70 vol % of the electrically insulating material between a member of the electrode structure 110 population and the nearest member of the counter-electrode 112 structure population.

In one embodiment, the microporous separator material comprises a particulate material and a binder, and has a porosity (void fraction) of at least about 20 vol. % The pores of the microporous separator material will have a diameter of at least 50 Å and will typically fall within the range of about 250 to 2,500 Å. The microporous separator material will typically have a porosity of less than about 75%. In one embodiment, the microporous separator material has a porosity (void fraction) of at least about 25 vol %. In one embodiment, the microporous separator material will have a porosity of about 35-55%.

The binder for the microporous separator material may be selected from a wide range of inorganic or polymeric materials. For example, in one embodiment, the binder can be an organic polymeric material such as a fluoropolymer derived from monomers containing vinylidene fluoride, hexafluoropropylene, tetrafluoropropene, and the like. In another embodiment, the binder is a polyolefin such as polyethylene, polypropylene, or polybutene, having any of a range of varying molecular weights and densities. In another embodiment, the binder is selected from the group consisting of ethylene-diene-propene terpolymer, polystyrene, polymethyl methacrylate, polyethylene glycol, polyvinyl acetate, polyvinyl butyral, polyacetal, and polyethyleneglycol diacrylate. In another embodiment, the binder is selected from the group consisting of methyl cellulose, carboxymethyl cellulose, styrene rubber, butadiene rubber, styrene-butadiene rubber, isoprene rubber, polyacrylamide, polyvinyl ether, polyacrylic acid, polymethacrylic acid, polyacrylonitrile, polyvinylidene fluoride polyacrylonitrile and polyethylene oxide. In another embodiment, the binder is selected from the group consisting of acrylates, styrenes, epoxies, and silicones. Other suitable binders may be selected from polyvinylidene fluoride-co-hexafluoropropylene, polyvinylidene fluoride-co-trichloroethylene, polymethylmethacrylate, polyacrylonitrile, polyvinylpyrrolidone, polyvinyl acetate, polyethylene-co-vinyl acetate, polyethylene oxide, cellulose acetate, cellulose acetate butyrate, cellulose acetate propionate, cyanoethylpullulan, cyanoethyl polyvinylalcohol, cyanoethylcellulose, cyanoethylsucrose, pullulan, carboxymethyl cellulose, acrylonitrile-styrene-butadiene copolymer, polyimide or mixtures thereof. In yet another embodiment, the binder may be selected from any of polyvinylidene fluoride-hexafluoro propylene, polyvinylidene fluoride-trichloroethylene, polymethyl methacrylate, polyacrylonitrile, polyvinyl pyrrolidone, polyvinyl acetate, ethylene vinyl acetate copolymer, polyethylene oxide, cellulose acetate, cellulose acetate butyrate, cellulose acetate propionate, cyanoethyl pullulan, cyanoethyl polyvinyl alcohol, cyanoethyl cellulose, cyanoethyl sucrose, pullulan, carboxyl methyl cellulose, acrylonitrile styrene butadiene copolymer, polyimide, polyethylene terephthalate, polybutylene terephthalate, polyester, polyacetal, polyamide, polyetheretherketone, polyether sulfone, polyphenylene oxide, polyphenylene sulfide, polyethylene naphthalene, and/or combinations thereof. In another embodiment, the binder is a copolymer or blend of two or more of the aforementioned polymers.

The particulate material comprised by the microporous separator material may also be selected from a wide range of materials. In general, such materials have a relatively low electronic and ionic conductivity at operating temperatures and do not corrode under the operating voltages of the battery electrode or current collector contacting the microporous separator material. For example, in one embodiment, the particulate material has a conductivity for carrier ions (e.g., lithium) of less than 1×10⁻⁴ S/cm. By way of further example, in one embodiment, the particulate material has a conductivity for carrier ions of less than 1×10⁻⁵ S/cm. By way of further example, in one embodiment, the particulate material has a conductivity for carrier ions of less than 1×10⁻⁶ S/cm. For example, in one embodiment, the particulate material is an inorganic material selected from the group consisting of silicates, phosphates, aluminates, aluminosilicates, and hydroxides such as magnesium hydroxide, calcium hydroxide, etc. Exemplary particulate materials include particulate polyethylene, polypropylene, a TiO₂-polymer composite, silica aerogel, fumed silica, silica gel, silica hydrogel, silica xerogel, silica sol, colloidal silica, alumina, titania, magnesia, kaolin, talc, diatomaceous earth, calcium silicate, aluminum silicate, calcium carbonate, magnesium carbonate, or a combination thereof. For example, in one embodiment, the particulate material comprises a particulate oxide or nitride such as TiO₂, SiO₂, Al₂O₃, GeO₂, B₂O₃, Bi₂O₃, BaO, ZnO, ZrO₂, BN, Si₃N₄, Ge₃N₄. See, for example, P. Arora and J. Zhang, “Battery Separators” Chemical Reviews 2004, 104, 4419-4462). Other suitable particles can comprise BaTiO₃, Pb(Zr,Ti)O₃ (PZT), Pb₁₋ₓLaₓZr_{1-y}Ti_{y}O₃(PLZT), PB(Mg₃Nb_{2/3})O₃—PbTiO₃ (PMN-PT), hafnia (HfO₂), SrTiO₃, SnO₂, CeO₂, MgO, NiO, CaO, ZnO, ZrO₂, Y₂O₃, Al₂O₃, TiO₂, SiC or mixtures thereof. In one embodiment, the particulate material will have an average particle size of about 20 nm to 2 micrometers, more typically 200 nm to 1.5 micrometers. In one embodiment, the particulate material will have an average particle size of about 500 nm to 1 micrometer.

In yet another embodiment, the electrically insulating separator 130 comprises a solid electrolyte, for example as in a solid state battery. Generally speaking, the solid electrolyte can facilitate transport of carrier ions, without requiring addition of a liquid or gel electrolyte. According to certain embodiments, in a case where a solid electrolyte is provided, the solid electrolyte may itself be capable of providing insulation between the electrodes and allowing for passage of carrier ions therethrough, and may not require addition of a liquid electrolyte permeating the structure.

In one embodiment, the secondary battery 102 can comprise electrolyte that may be any of an organic liquid electrolyte, an inorganic liquid electrolyte, an aqueous electrolyte, a non-aqueous electrolyte, a solid polymer electrolyte, a solid ceramic electrolyte, a solid glass electrolyte, a garnet electrolyte, a gel polymer electrolyte, an inorganic solid electrolyte, a molten-type inorganic electrolyte or the like. Other arrangements and/or configurations of electrically insulating separator 130, with or without liquid electrolyte, may also be provided. In one embodiment, the solid electrolyte can comprise a ceramic or glass material that is capable of providing electrical insulation while also conducting carrier ions therethrough. Examples of ion conducting material can include garnet materials, a sulfide glass, a lithium ion conducting glass ceramic, or a phosphate ceramic material. In one embodiment, a solid polymer electrolyte can comprise any of a polymer formed of polyethylene oxide (PEO)-based, polyvinyl acetate (PVA)-based, polyethyleneimine (PEI)-based, polyvinylidene fluoride (PVDF)-based, polyacrylonitrile (PAN)-based, LiPON (lithium phosphorus oxynitride), and polymethyl methacrylate (PMMA)-based polymers or copolymers thereof. In another embodiment, a sulfide-based solid electrolyte may be provided, such as a sulfide-based solid electrolyte comprising at least one of lithium and/or phosphorous, such as at least one of Li₂S and P₂S₅, and/or other sulfides such as SiS₂, GeS₂, Li₃PS₄, Li₄P₂S₇, Li₄SiS₄, Li₂S—P₂S₅, and 50Li₄SiO₄·50Li₃BO₃, and/or B₂S₃. Yet other embodiments of solid electrolyte can include nitrides, halides and sulfates of lithium (Li) such as Li₃N, LiI, Li₅NI₂, Li₃N—LiI—LiOH, LiSiO₄, LiSiO₄LiI LiOH, Li₂SiS₃, Li₄SiO₄, Li₄SiO₄LiI LiOH, and Li₃PO₄Li₂S SiS₂, Li₂S—P₂S₅, Li₂S P₂S₅-L₄SiO₄, Li₂S Ga₂S₃—GeS₂, Li₂S Sb₂S₃GeS₂, Li_{3.25}—Ge_{0.25}P_{0.75}S₄, (La,Li)TiO₃ (LLTO), Li₆La₂CaTa₂O₁₂, Li₆La₂ANb₂O₁₂ (A=Ca, Sr), Li₂Nd₃TeSbO₁₂, Li₃BO_{2.5}N_{0.5}, Li₉SiAlO₈, Li₁₊ₓAlₓGe₂₋ₓ(PO₄)₃(LAGP), Li₁₊ₓAlₓTi₂₋ₓ(PO₄)₃(LATP), Li₁₊ₓTi₂₋ₓAlₓSi_{y}(PO₄)_{3-y}, LiAlₓZr₂₋ₓ(PO₄)₃, LiTiₓZr₂₋ₓ(PO₄)₃, Yet other embodiments of solid electrolyte can include garnet materials, such as for example described in U.S. Pat. No. 10,361,455, which is hereby incorporated herein in its entirety. In one embodiment, the garnet solid electrolyte is a nesosilicate having the general formula X₃Y₂(SiO₄)₃, where X may be a divalent cation such as Ca, Mg, Fe or Mn, or Y may be a trivalent cation such as Al, Fe, or Cr.

According to one embodiment of an assembled energy storage device, the electrically insulating separator comprises a microporous separator material that is permeated with a non-aqueous electrolyte suitable for use as a secondary battery electrolyte. Typically, the non-aqueous electrolyte comprises a lithium salt and/or mixture of salts dissolved in an organic solvent and/or solvent mixture. Exemplary lithium salts include inorganic lithium salts such as LiClO₄, LiBF₄, LiPF₆, LiAsF₆, LiCl, and LiBr; and organic lithium salts such as LiB(C₆H₅)₄, LiN(SO₂CF₃)₂, LiN(SO₂CF₃)₃, LiNSO₂CF₃, LiNSO₂CF₅, LiNSO₂C₄F₉, LiNSO₂C₅F₁₁, LiNSO₂C₆F₁₃, and LiNSO₂C₇F₁₅. As yet another example, the electrolyte can comprise sodium ions dissolved therein, such as for example any one or more of NaClO₄, NaPF₆, NaBF₄, NaCF₃SO₃, NaN(CF₃SO₂)₂, NaN(C₂F₅SO₂)₂, NaC(CF₃SO₂)₃. Salts of magnesium and/or potassium can similarly be provided. For example magnesium salts such as magnesium chloride (MgCl₂), magnesium bromide MgBr₂), or magnesium iodide (MgI₂) may be provided, and/or as well as a magnesium salt that may be at least one selected from the group consisting of magnesium perchlorate (Mg(ClO₄)₂), magnesium nitrate (Mg(NO₃)₂), magnesium sulfate (MgSO₄), magnesium tetrafluoroborate (Mg(BF₄)₂), magnesium tetraphenylborate (Mg(B(C₆H₅)₄)₂, magnesium hexafluorophosphate (Mg(PF₆)₂), magnesium hexafluoroarsenate (Mg(AsF₆)₂), magnesium perfluoroalkylsulfonate ((Mg(R_{f1}SO₃)₂), in which R_{f1} is a perfluoroalkyl group), magnesium perfluoroalkylsulfonylimide (Mg((R_{f2}SO₂)₂N)₂, in which R_{f2} is a perfluoroalkyl group), and magnesium hexaalkyl disilazide ((Mg(HRDS)₂), in which R is an alkyl group). Exemplary organic solvents to dissolve the lithium salt include cyclic esters, chain esters, cyclic ethers, and chain ethers. Specific examples of the cyclic esters include propylene carbonate, ethylene carbonate, butylene carbonate, γ-butyrolactone, vinylene carbonate, 2-methyl-γ-butyrolactone, acetyl-γ-butyrolactone, and γ-valerolactone. Specific examples of the chain esters include dimethyl carbonate, diethyl carbonate, dibutyl carbonate, dipropyl carbonate, methyl ethyl carbonate, methyl butyl carbonate, methyl propyl carbonate, ethyl butyl carbonate, ethyl propyl carbonate, butyl propyl carbonate, alkyl propionates, dialkyl malonates, and alkyl acetates. Specific examples of the cyclic ethers include tetrahydrofuran, alkyltetrahydrofurans, dialkyltetrahydrofurans, alkoxytetrahydrofurans, dialkoxytetrahydrofurans, 1,3-dioxolane, alkyl-1,3-dioxolanes, and 1,4-dioxolane. Specific examples of the chain ethers include 1,2-dimethoxyethane, 1,2-diethoxythane, diethyl ether, ethylene glycol dialkyl ethers, diethylene glycol dialkyl ethers, triethylene glycol dialkyl ethers, and tetraethylene glycol dialkyl ethers.

### EXAMPLES

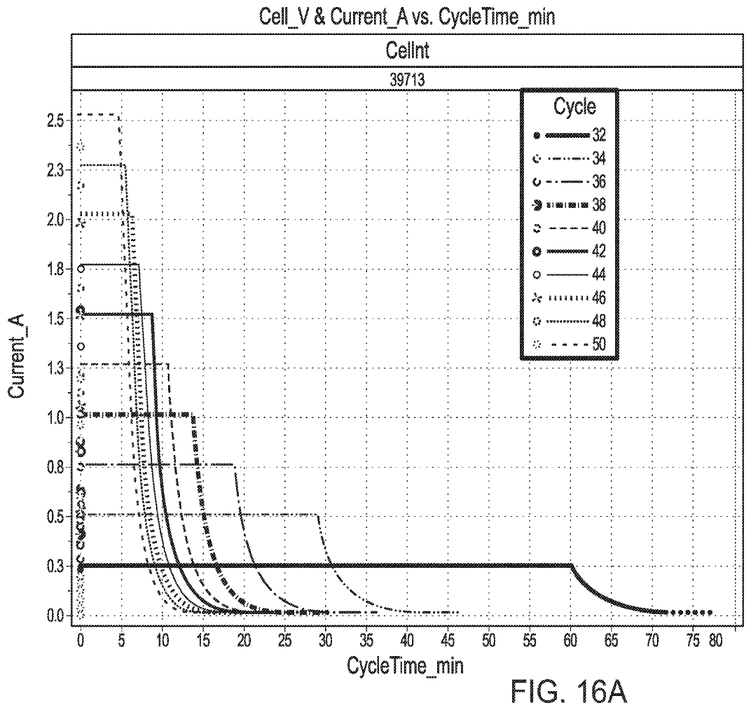

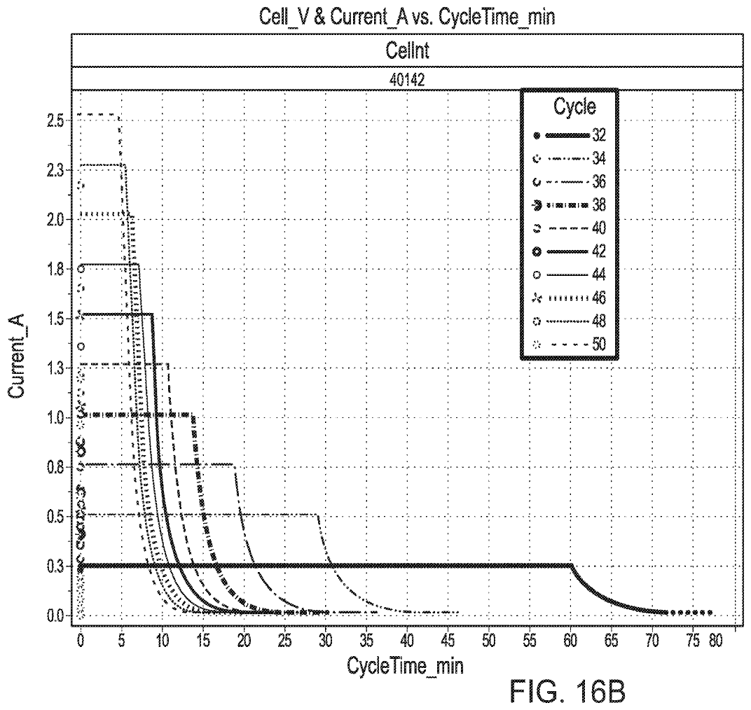

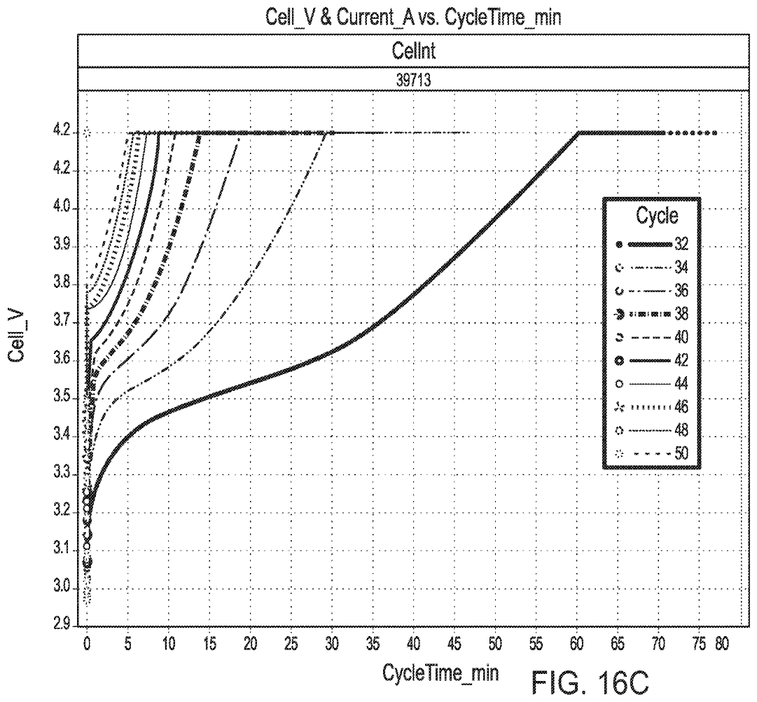

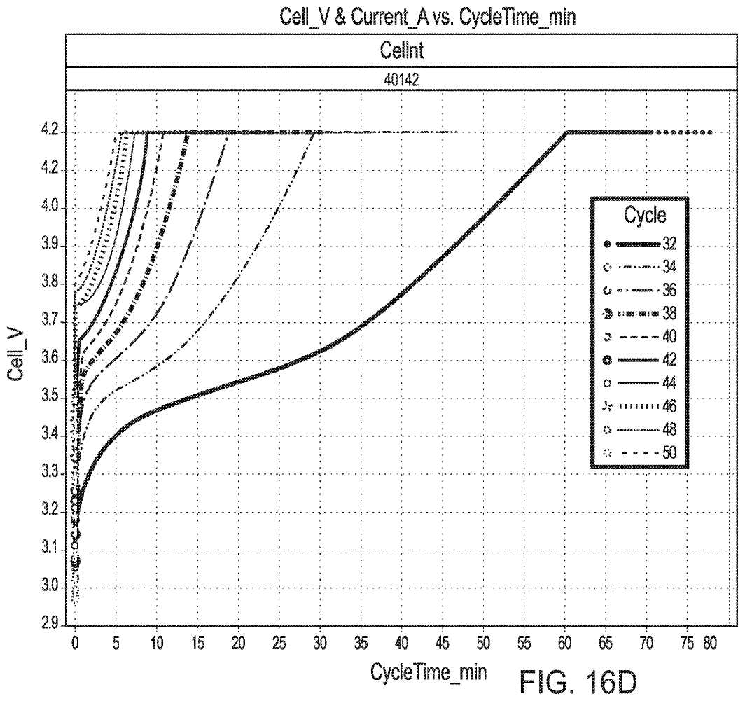

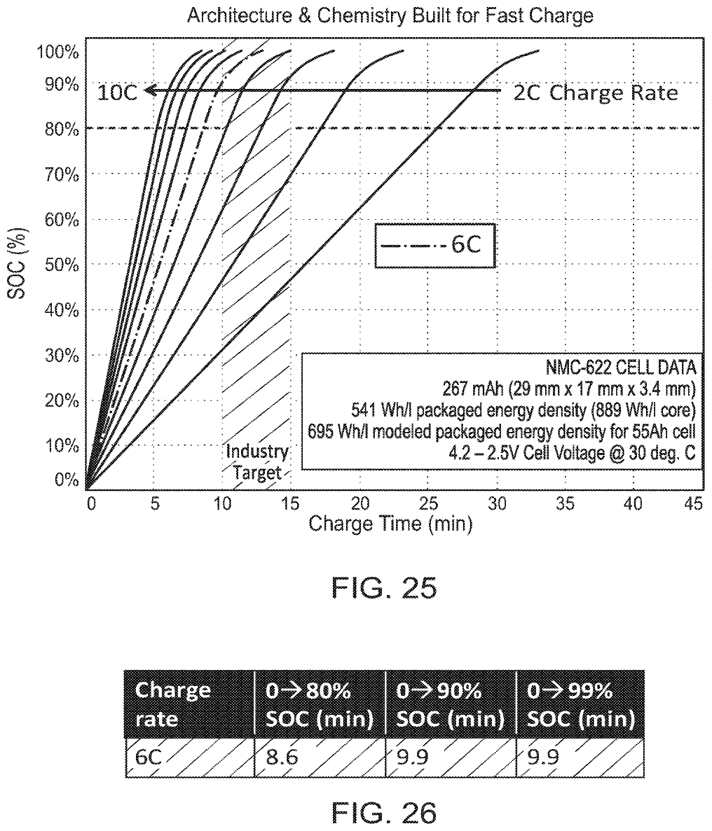

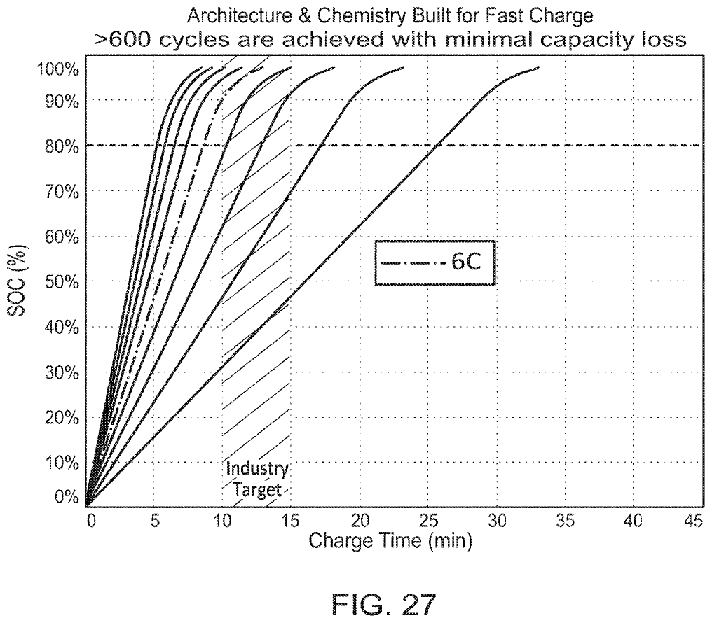

The following non-limiting examples are provided to further illustrate aspects of the present invention, with reference to FIGS. 16A-28. It should be appreciated by those of skill in the art that the techniques disclosed in the examples that follow represent approaches the inventors have found function well in the practice of the invention, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the invention.

### Charge Acceptance and Discharge Rate Capability Test Protocols

C-rate of the cell was determined using the cycle 1 capacity measured at 0.1 C. The protocol used for charge acceptance tests was as follows: after using a standard 0.33 C cycling protocol for 25 cycles, the specified charge C-rate was input for a given cycle. For charge acceptance tests, every second cycle used the standard 0.33 C constant current charge with a constant voltage step at top of charge voltage of 4.2 V, using a current cutoff of 0.04 C, followed by a 5 minute rest at top of charge, followed by 0.33 C constant current discharge with 2.5 V voltage cutoff, followed by a 5 minute rest at bottom of charge. Each alternating cycle then used charge rates which include: 1 C, 2 C, 3 C, 4 C, 5 C, 6 C, 7 C, 8 C, 9 C, or 10 C, with otherwise the same protocol; i.e. a constant current charge at the specified C-rate, followed by a constant voltage hold at the top of charge 4.2 V, with current cutoff of 0.04 C, followed by a 5 minute rest at top of charge, followed by 0.33 C constant current discharge with 2.5 V voltage cutoff. For discharge rate tests, the same cells were then used to discharge the cell using the standard protocol described above, except the 0.33 C constant current discharge was replaced with the specified rate, i.e. up to 4 C discharge. Consecutive cycles were used to ramp current and include: 0.2 C, 0.5 C, 1 C, 2 C, 3 C, 4 C discharge rates.

The following examples provided batteries repurposed from EXP 4049 (˜530 Wh/L) for charge and discharge rate capability tests and high rate cycle tests. These cells use 3.6 mAh/cm² NMC622 electrode with 96.4% by weight active material, 3.2 g/cc density and a POR-type SiOx anode balanced with 80% buffer and target 26% anode formed porosity after formation using 2.5-4.2 V cell cutoff voltages.

### Example 1—Charge Rate Capability

Table 1 and Table 2 show the charge rate, discharge rate, the constant current charge step (CC) capacity in units of amp hours, the constant voltage charge step (CV) capacity at cell top of charge, and the first recorded time with >80% of the charge capacity. Good reproducibility was demonstrated with two cells (TM40142 as shown in Table 1 and TM39713 as shown in Table 2) and the maximum tested rate of 10 C (2.53 amps) approached 5.2 minutes to 80% SOC.

TABLE 1
Summary of charge rate capability for EXP4049-type cell TM40142.
TM40142 charge rate capability

| | | | | | time |
|---|---|---|---|---|---|
| | | | CC | CV | to >80% |
| | charge | discharge | capacity | capacity | SOC |
| cycle | rate | rate | (Ah) | (Ah) | (mins) |
| 31 | C/3 | C/3 | 0.2583 | 0.0101 | 154.6 |
| 32 | 1 C | C/3 | 0.2496 | 0.0194 | 51.1 |
| 34 | 2 C | C/3 | 0.2406 | 0.0285 | 25.6 |
| 36 | 3 C | C/3 | 0.2343 | 0.0351 | 17.0 |
| 38 | 4 C | C/3 | 0.2275 | 0.0421 | 12.9 |
| 40 | 5 C | C/3 | 0.2234 | 0.0470 | 10.3 |
| 42 | 6 C | C/3 | 0.2186 | 0.0527 | 8.60 |
| 44 | 7 C | C/3 | 0.2143 | 0.0569 | 7.37 |
| 46 | 8 C | C/3 | 0.2095 | 0.0622 | 6.46 |
| 48 | 9 C | C/3 | 0.2035 | 0.0686 | 5.77 |
| 50 | 10 C | C/3 | 0.1977 | 0.0748 | 5.23 |

TABLE 2
summary of charge rate capability for EXP4049-type cell TM39713.
TM39713 charge rate capability

| | | | | | time |
|---|---|---|---|---|---|
| | | | CC | CV | to >80% |
| | charge | discharge | capacity | capacity | SOC |
| cycle | rate | rate | (Ah) | (Ah) | (mins) |
| 31 | C/3 | C/3 | 0.2596 | 0.0100 | 155.4 |
| 32 | 1 C | C/3 | 0.2513 | 0.0188 | 51.2 |
| 34 | 2 C | C/3 | 0.2425 | 0.0281 | 25.7 |
| 36 | 3 C | C/3 | 0.2363 | 0.0346 | 17.2 |
| 38 | 4 C | C/3 | 0.2303 | 0.0407 | 12.9 |
| 40 | 5 C | C/3 | 0.2257 | 0.0454 | 10.3 |
| 42 | 6 C | C/3 | 0.2207 | 0.0505 | 8.60 |
| 44 | 7 C | C/3 | 0.2168 | 0.0543 | 7.38 |
| 46 | 8 C | C/3 | 0.2105 | 0.0611 | 6.45 |
| 48 | 9 C | C/3 | 0.2065 | 0.0653 | 5.75 |
| 50 | 10 C | C/3 | 0.2009 | 0.0712 | 5.20 |

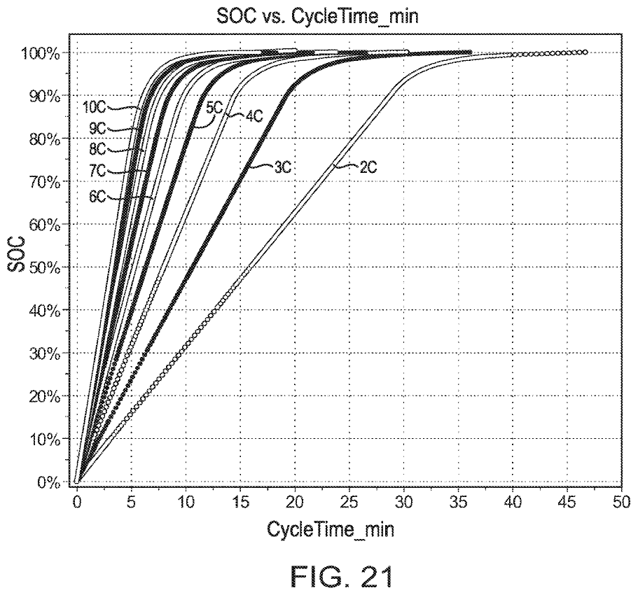

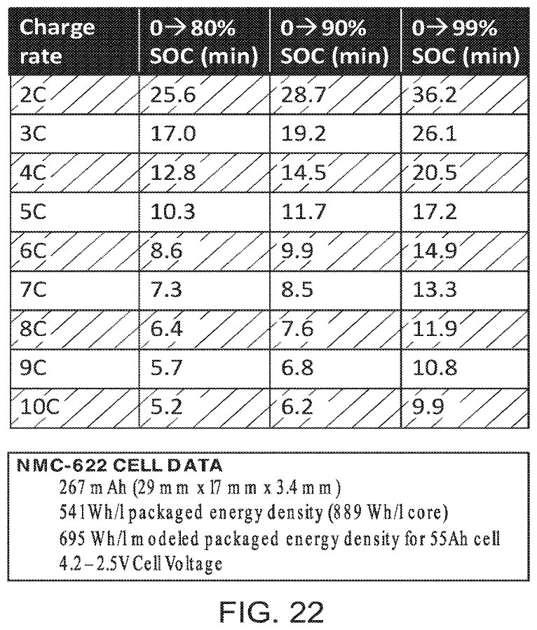

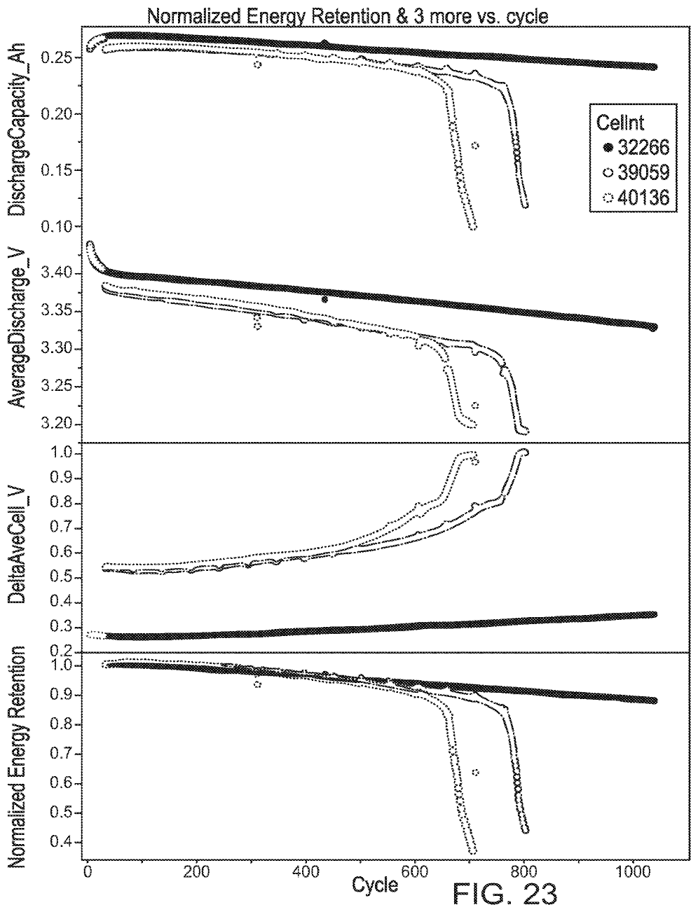

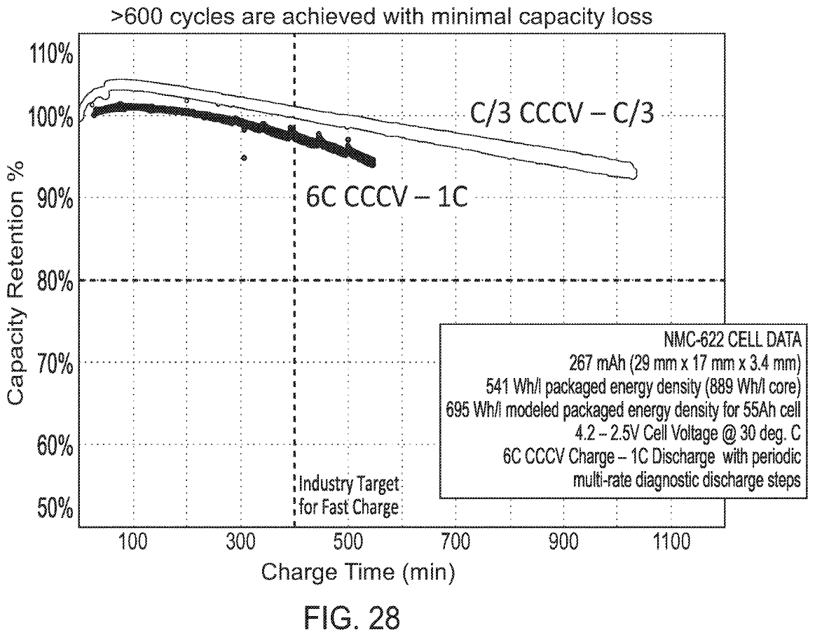

In supporting Tables 1 and 2, the current (A) and voltage (V) vs. time (minutes) plots for TM39713 and TM40142 were further shown in FIGS. 16A-16C. These plots show the relative CC and CV step times for charge rates 1 C to 10 C as well as currents used for the CC and CV steps. FIG. 21 shows plots of SOC vs. cycle time and charge times at various C-rates using a NMC-622 cell, and FIG. 22 summarizes results. Furthermore, as shown in FIG. 28, at charge rate of 6 C, over 600 cycles were achieved with minimal capacity loss (˜5%).

### Example 2—Discharge Rate Capability

Table 3 and Table 4 show the discharge rate normalized to the 0.1 C reference cycle 52 and 0.2 C reference cycle 53 for comparison (*Cycle 52 included 1 C discharge pulses and 0.75 C charge pulses every 10% SOC according to a DOE standard reference protocol). Also shown are the charge rates, the discharge rates (with a C/25 CV step) and the discharge capacity in units of amp-hours. The maximum tested 4 C discharge rate was found to be approximately 88% when normalized to the C/10 capacity.

TABLE 3
Summary of discharge rate capability for EXP4049-type cell TM40142.
TM40142 discharge rate capability

| | | | discharge | discharge | discharge |
|---|---|---|---|---|---|
| | charge | discharge | capacity | C-rate/ | C-rate/ |
| cycle | rate | rate | (Ah) | 0.2 C | 0.1 C |
| 51 | C/3 | C/3 | 0.2722 | 98.52% | 96.76% |
| 52 | C/3 | C/10* | 0.2814 | 101.83% | 100.00% |
| 53 | C/3 | C/5 | 0.2763 | 100.00% | 98.21% |
| 54 | C/3 | C/2 | 0.2683 | 97.10% | 95.36% |
| 55 | C/3 | 1 C | 0.2614 | 94.60% | 92.90% |
| 56 | C/3 | 2 C | 0.2558 | 92.59% | 90.93% |
| 57 | C/3 | 3 C | 0.2520 | 91.21% | 89.58% |
| 58 | C/3 | 4 C | 0.2455 | 88.84% | 87.25% |

TABLE 4
Summary of discharge rate capability for EXP4049-type cell TM39713.
TM39713 discharge rate capability

| | | | discharge | discharge | discharge |
|---|---|---|---|---|---|
| | charge | discharge | capacity | C-rate/ | C-rate/ |
| cycle | rate | rate | (Ah) | 0.2 C | 0.1 C |
| 51 | C/3 | C/3 | 0.2721 | 98.57% | 96.83% |
| 52 | C/3 | C/10* | 0.2810 | 101.80% | 100.00% |
| 53 | C/3 | C/5 | 0.2760 | 100.00% | 98.23% |
| 54 | C/3 | C/2 | 0.2682 | 97.16% | 95.44% |
| 55 | C/3 | 1 C | 0.2618 | 94.84% | 93.17% |
| 56 | C/3 | 2 C | 0.2567 | 92.98% | 91.34% |
| 57 | C/3 | 3 C | 0.2536 | 91.85% | 90.23% |
| 58 | C/3 | 4 C | 0.2487 | 90.09% | 88.50% |

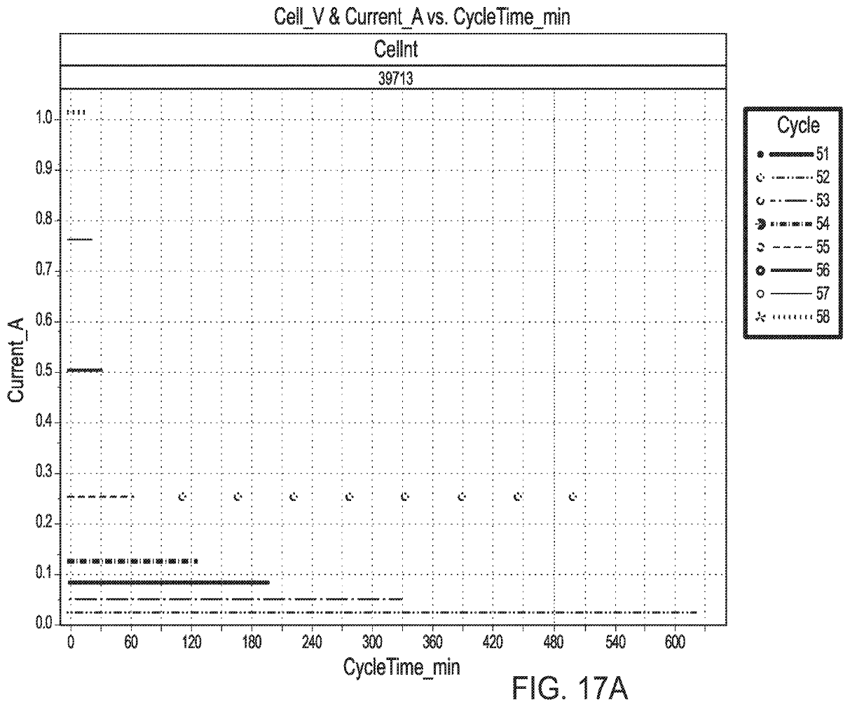

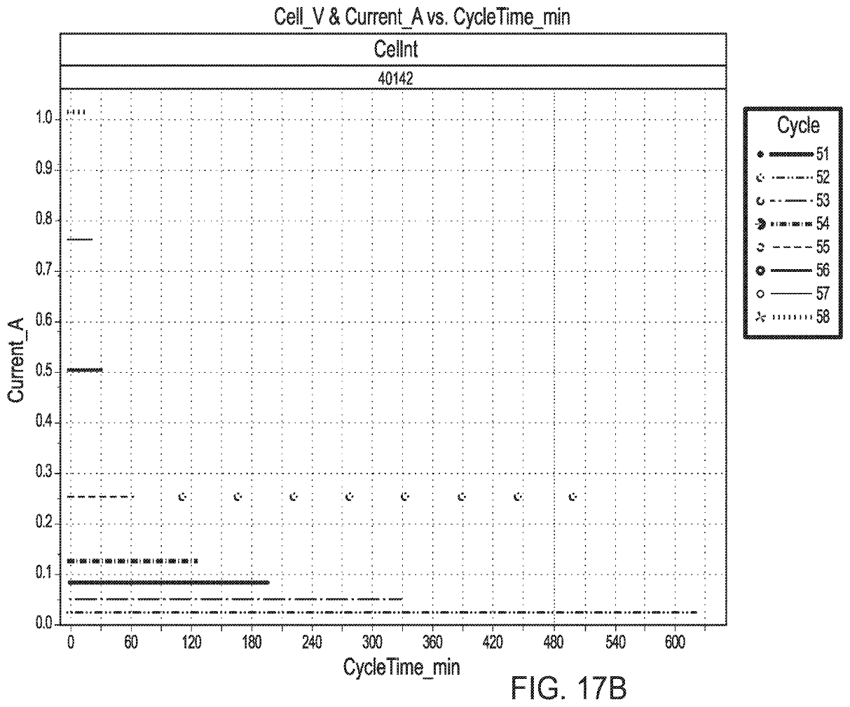

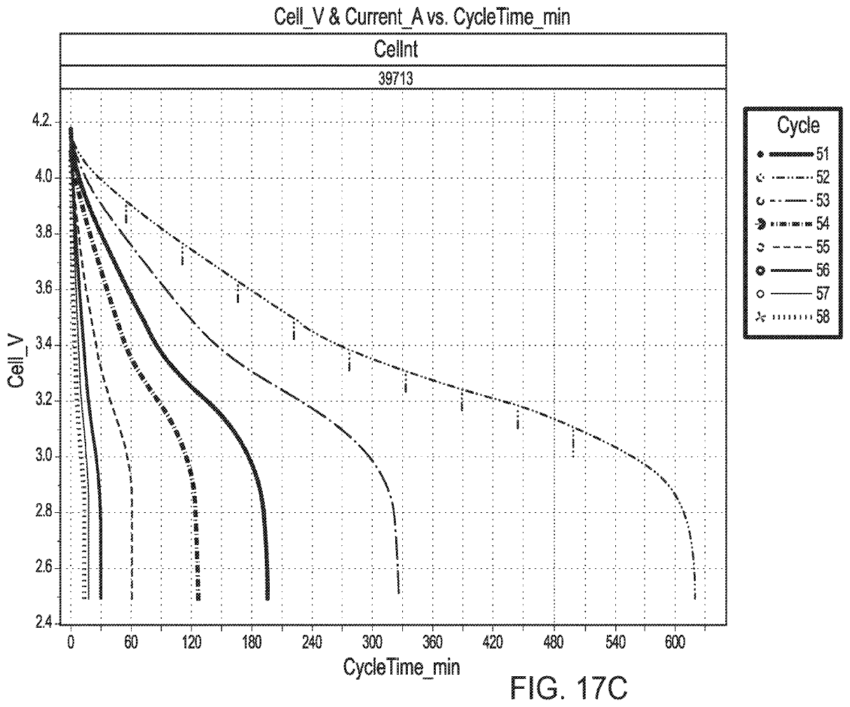

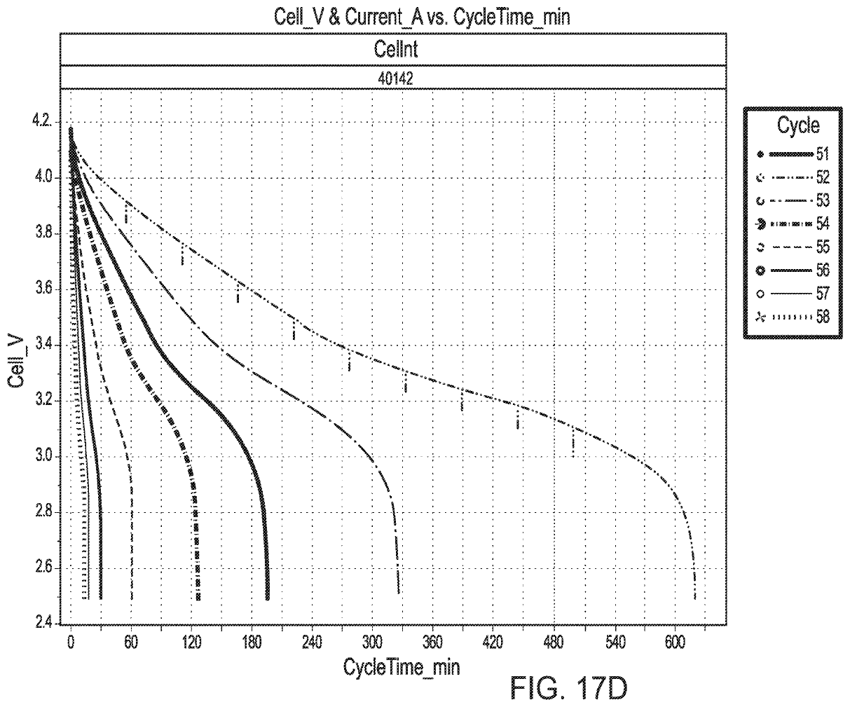

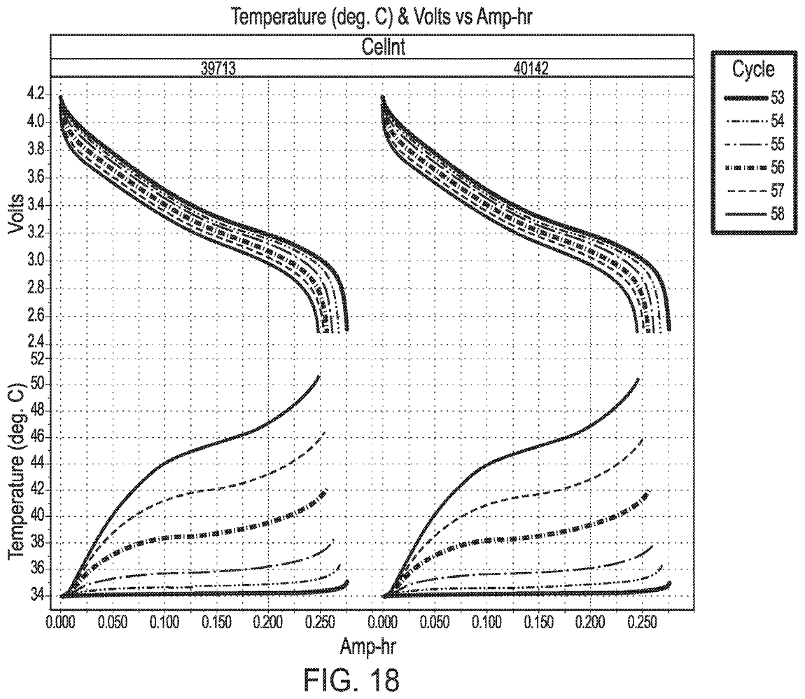

FIGS. 17A-17D provide supporting data for Tables 3 and 4 with the current (A) and voltage (V) vs. time (minutes) plots for TM39713 and TM40142 for the indicated cycles. FIG. 18 shows the discharge voltage curves from cycle 53-58 for the same two cells with discharge rates ranging from C/5 to 4 C along with a temperature profile as a function of capacity. Discharge rate capability observed in these cells exceeded that expected by the fundamental rate capability of the NMC 622 material procured from BASF. Thermocouples placed directly on the surface of the cell were used to monitor the surface temperature as a function of SOC and indicate the surface exceeds 50° C. at 4 C rate near bottom of charge. The elevated cell temperature in comparison to the test chamber set point of 30° C. was likely responsible for the rate capability increase at rates above 1 C and higher, expected to be ˜90% at 1 C at room temperature from the manufacturer spec sheet.

FIG. 18 shows the cell voltage (V) and cell temperature (° C.) vs. capacity (Ah) for cells TM39713 (left) and TM40142 (right) for indicated cycles using rates tested from C/5 to 4 C discharge rates with standard C/3 charge rate on all cycles with C/25 CV step, as described in Tables 3 and 4.

The discharge capacity and average discharge voltage were compared in Table 5 and showed similar values for all three cells (TM39713, TM40142 and the reference cell TM36721), suggesting that TM39713 and TM40142 were not damaged after charge acceptance tests up to 10 C during cycles indicated in Table 1.

TABLE 5
Comparison of C/3 cycles in TM39713 and TM40142 to a C/3 reference cell TM36721.

| | Rate | | Capacity (Ah) | | | Discharge voltage (V) | | |
|---|---|---|---|---|---|---|---|---|
| Cycle | Charge | Discharge | Reference | TM39713 | TM40142 | Reference | TM39713 | TM40142 |
| 33 | C/3 | C/3 | 0.2698 | 0.2701 | 0.2683 | 3.4019 | 3.4095 | 3.4081 |
| 35 | C/3 | C/3 | 0.2699 | 0.2703 | 0.2685 | 3.4011 | 3.4089 | 3.4077 |
| 37 | C/3 | C/3 | 0.2701 | 0.2705 | 0.2689 | 3.4009 | 3.4084 | 3.4067 |
| 39 | C/3 | C/3 | 0.2702 | 0.2707 | 0.2694 | 3.4004 | 3.4080 | 3.4054 |
| 41 | C/3 | C/3 | 0.2702 | 0.2708 | 0.2708 | 3.4002 | 3.4074 | 3.4051 |
| 43 | C/3 | C/3 | 0.2703 | 0.2710 | 0.2711 | 3.3998 | 3.4069 | 3.4052 |
| 45 | C/3 | C/3 | 0.2704 | 0.2713 | 0.2714 | 3.3995 | 3.4066 | 3.4054 |
| 47 | C/3 | C/3 | 0.2705 | 0.2716 | 0.2716 | 3.3992 | 3.4057 | 3.4049 |
| 49 | C/3 | C/3 | 0.2705 | 0.2718 | 0.2719 | 3.3990 | 3.4048 | 3.4038 |
| 51 | C/3 | C/3 | 0.2710 | 0.2721 | 0.2722 | 3.3987 | 3.4039 | 3.4022 |

### Example 3—High Rate Cycle Life Stability

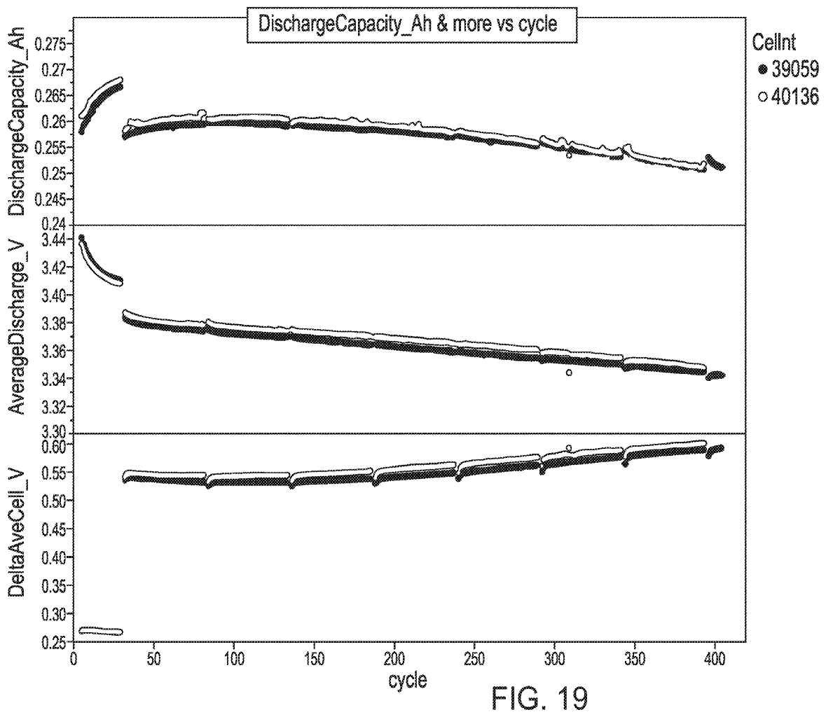

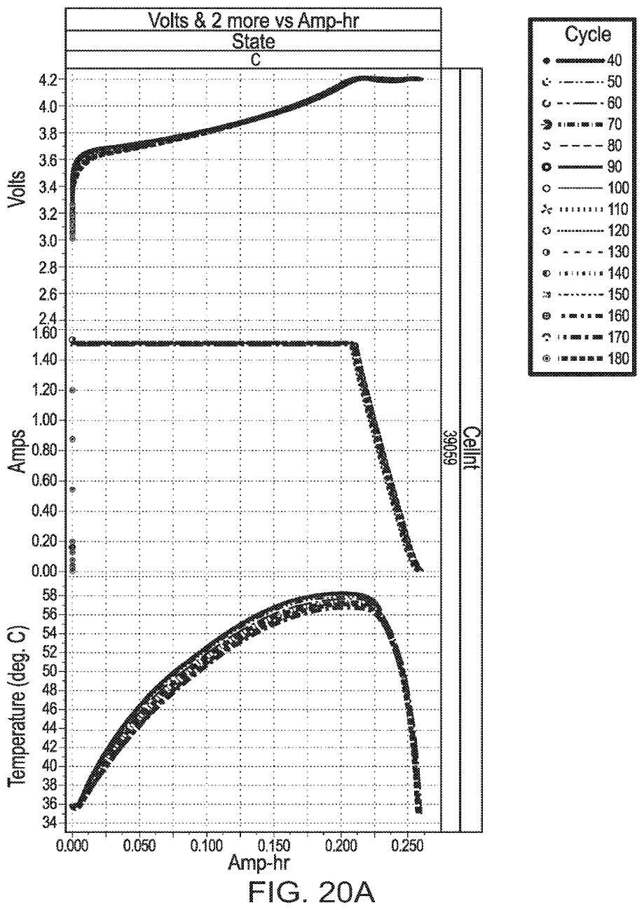

FIG. 19 shows cell capacity (Ah), average discharge voltage (V), and the difference between the average charge and discharge voltage DeltaAveCell_V (V) vs. cycle number for EXP4049-type cells TM39059 and TM40136. For cycles 5-29, C/3 charge and discharge rates were used with the C/25 CV step at top of charge. For cycles 32 and higher, a 6 C charge step (with C/25 CV step) and 1 C discharge step were used for every cycle, except at 50 cycle intervals where a standard C/3 reference cycle was used, along with the standard US Department of Energy defined test protocol with current pulse routines described above.

FIG. 23 shows the cell cycled using 0.33 C/0.33 C charge/discharge rate with C/25 CV step (CellInt=32266) compared to cells cycled with 6 C/1 C charge/discharge rate with C/25 CV step (CellInt=39059 and CellInt=40136) including discharge capacity, average discharge voltage, the difference between average charge and discharge voltage DeltaAveCell_V, and normalized capacity retention (using cycle 32 as reference) plotted vs. cycle number. Every 50th cycle had a DOE defined diagnostic cycle using C/10 discharge with 1 C discharge pulses and 0.75 C charge pulses, and a standard 0.33 C/0.33 C diagnostic cycle (not shown).

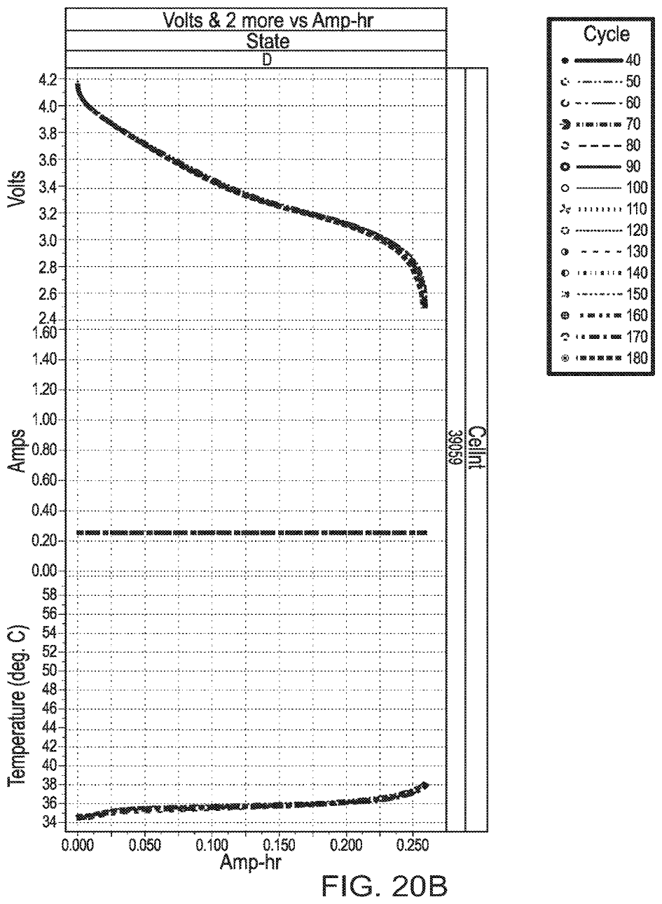

Cells TM39059 and TM40136 both showed stable and reproducible performance with >350 cycles using the 6 C charge and 1 C discharge test protocol. FIGS. 20A-20B shows the charge and discharge voltage profiles for the same cells along with the current in amps and the temperature vs. capacity for every 10th cycle between cycle 40 and cycle 180. Both cells showed significantly elevated temperature during the charge profile, with temperature exceeding 58° C. near top of charge on cycle 40. This maximum temperature decreased to near 57° C. near top of charge on cycle 180. High temperature resulting from stressful test conditions in the 30° C. test chamber negatively affected cycle life and stability compared to standard C/3 cycling tests.

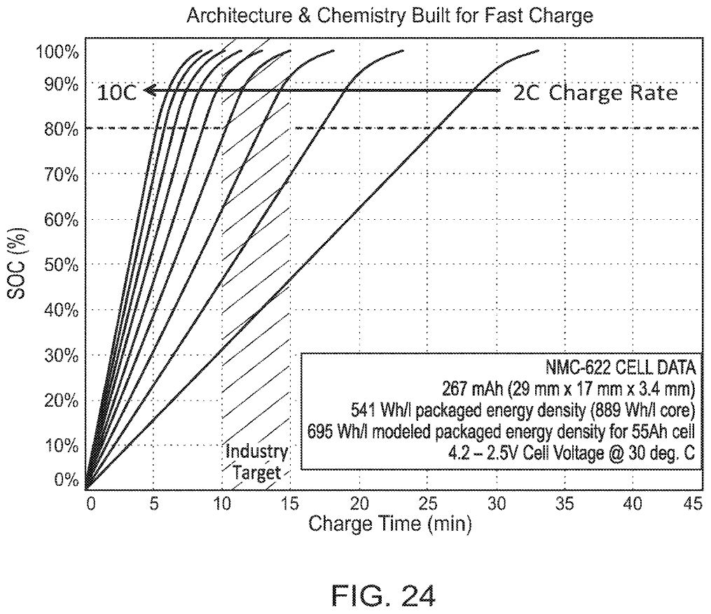

FIGS. 24-28 provide further examples of charging rates achievable with structures according to embodiments of the present disclosure.

The following embodiments are provided to illustrate aspects of the disclosure, although the embodiments are not intended to be limiting and other aspects and/or embodiments may also be provided.

Embodiment 1. An electrode assembly for a secondary battery, wherein
the electrode assembly has mutually perpendicular transverse, longitudinal and vertical axes corresponding to the x, y and z axes, respectively, of an imaginary three-dimensional Cartesian coordinate system, opposing longitudinal end surfaces that are separated from each other in the longitudinal direction, and a lateral surface surrounding an electrode assembly longitudinal axis ABA and connecting the first and second longitudinal end surfaces, the lateral surface having opposing vertical surfaces that are separated from each other in the vertical direction on opposing vertical sides of the longitudinal axis, opposing transverse surfaces that are separated from each other in the transverse direction on opposing transverse sides of the longitudinal axis, wherein the opposing longitudinal surfaces have a combined surface area, L_{SA}, the opposing transverse surfaces have a combined surface area, T_{SA}, the opposing vertical surfaces have a combined surface area, V_{SA},
the electrode assembly further comprises an electrode structure population, an electrically insulating separator population, and a counter-electrode structure population, wherein members of the electrode structure, electrically insulating separator and counter-electrode structure populations are arranged in an alternating sequence along the longitudinal direction.

Embodiment 2. The electrode assembly according to Embodiment 1, wherein members of the electrode structure population comprise an electrode current collector adjacent an electrode active material layer, the electrode active material layer comprising opposing transverse ends, and wherein members of the counter-electrode structure population comprise a counter-electrode current collector adjacent a counter-electrode active material layer, the counter-electrode active material layer comprising opposing transverse ends.

Embodiment 3. The electrode assembly of any preceding Embodiment wherein the electrode assembly comprises a population of unit cells, each member of the unit cell population comprises, in a stacked series in the longitudinal direction, a unit cell portion of an electrode current collector, an electrode active material layer, an electrically insulating separator, a counter-electrode active material layer, and a unit cell portion of a counter-electrode current collector.

Embodiment 4. The electrode assembly of any preceding Embodiment wherein the electrode current collectors have opposing electrode current collector surfaces separated from each other in the longitudinal direction and the counter-electrode current collectors have opposing counter-electrode current collector surfaces separated from each other in the longitudinal direction, and one of the opposing electrode current collector surfaces comprises a coated region that is covered with the electrode active material layer and an uncoated region that lacks the electrode active material layer, the uncoated region being proximate one of the transverse ends of the electrode current collector.

Embodiment 5. The electrode assembly of any preceding Embodiment wherein the electrode current collectors have opposing electrode current collector surfaces separated from each other in the longitudinal direction and the counter-electrode current collectors have opposing counter-electrode current collector surfaces separated from each other in the longitudinal direction, and one of the opposing counter-electrode current collector surfaces comprises a coated region that is covered with the counter-electrode active material layer and an uncoated region that lacks the counter-electrode active material layer, the uncoated region being proximate one of the transverse ends of the counter-electrode current collector.

Embodiment 6. The electrode assembly of any preceding Embodiment wherein the electrode current collectors have opposing electrode current collector surfaces separated from each other in the longitudinal direction and the counter-electrode current collectors have opposing counter-electrode current collector surfaces separated from each other in the longitudinal direction, and each of the opposing electrode current collector surfaces comprises a coated region that is covered with the electrode active material layer and an uncoated region that lacks the electrode active material layer, the uncoated region being proximate one of the transverse ends of the electrode current collector.

Embodiment 7. The electrode assembly of any preceding Embodiment wherein the electrode current collectors have opposing electrode current collector surfaces separated from each other in the longitudinal direction and the counter-electrode current collectors have opposing counter-electrode current collector surfaces separated from each other in the longitudinal direction, and each of the opposing counter-electrode current collector surfaces comprises a coated region that is covered with the counter-electrode active material layer and an uncoated region that lacks the counter-electrode active material layer, the uncoated region being proximate one of the transverse ends of the counter-electrode current collector.

Embodiment 8. The electrode assembly of any preceding Embodiment, wherein
members of the electrode structure population comprise an electrode current collector adjacent an electrode active material layer, the electrode active material layer comprising opposing transverse ends, and wherein members of the counter-electrode structure population comprise a counter-electrode current collector adjacent a counter-electrode active material layer, the counter-electrode active material layer comprising opposing transverse ends,
each member of the electrode structure population comprises an electrode current collector that is partially coated by the adjacent electrode active material layer, the electrode current collector having (i) an electrode current collector body region coated by the adjacent electrode active material layer and extending between the opposing first and second transverse ends of the adjacent electrode active material layer, and (ii) an electrode current collector end region on a first or second transverse end of the electrode current collector, the electrode current collector end region being bounded by and extending past the first or second transverse end of the adjacent electrode active material layer that is on a same transverse side as the electrode current collector end region.

Embodiment 9. The electrode assembly of any preceding Embodiment, wherein
members of the electrode structure population comprise an electrode current collector adjacent an electrode active material layer, the electrode active material layer comprising opposing transverse ends, and wherein members of the counter-electrode structure population comprise a counter-electrode current collector adjacent a counter-electrode active material layer, the counter-electrode active material layer comprising opposing transverse ends,
each member of the counter-electrode structure population comprises a counter-electrode current collector that is partially coated by the adjacent counter-electrode active material layer, the counter-electrode current collector having (i) a counter-electrode current collector body region coated by the adjacent counter-electrode active material layer and extending between the opposing first and second transverse ends of the adjacent counter-electrode active material layer, and (ii) a counter-electrode current collector end region on a first or second transverse end of the counter-electrode current collector, the counter-electrode current collector end region being bounded by and extending past the first or second transverse end of the adjacent counter-electrode active material layer that is on a same transverse side as the counter-electrode current collector end region,
Embodiment 10. The electrode assembly of any preceding Embodiment, wherein
the electrode assembly further comprises an electrode busbar connected to the electrode current collector end regions of the electrode current collectors to electrically pool current from members of the electrode structure population.

Embodiment 11. The electrode assembly of any preceding Embodiment, wherein
the electrode assembly further comprises a counter-electrode busbar connected to the counter-electrode current collector end regions of the counter-electrode current collectors to electrically pool current from members of the counter-electrode structure population.

Embodiment 12. The electrode assembly of any preceding Embodiment, wherein a length of the electrode current collector end region in the transverse direction (L_{ER}) is as measured from the first or second transverse end of the adjacent electrode active material layer that is on a same transverse side as the electrode current collector end region, to a region where the electrode current collector end region connects with the electrode busbar.

Embodiment 13. The electrode assembly of any preceding Embodiment, wherein a length of the counter-electrode current collector end region in the transverse direction (L_{CER}) is as measured from the first or second transverse end of the adjacent counter-electrode active material layer that is on a same transverse side as the counter-electrode current collector end region, to a region where the counter-electrode current collector end region connects with the counter-electrode busbar.

Embodiment 14. The electrode assembly of any preceding Embodiment, wherein a height of the electrode current collector body region in the vertical direction (H_{BR}) is as measured between opposing vertical surfaces of the electrode current collector body region.

Embodiment 15. The electrode assembly of any preceding Embodiment, wherein a height of the counter-electrode current collector body region in the vertical direction (H_{CBR}) is as measured between opposing vertical surfaces of the counter-electrode current collector body region.

Embodiment 16. The electrode assembly of any preceding Embodiment, wherein a height of the electrode current collector end region in the vertical direction (H_{ER}) is as measured between opposing vertical surfaces of the electrode current collector end region.

Embodiment 17. The electrode assembly of any preceding Embodiment, wherein a height of the counter-electrode current collector end region in the vertical direction (H_{CER}) is as measured between opposing vertical surfaces of the counter-electrode current collector end region.

Embodiment 18. The electrode assembly of any preceding Embodiment, wherein the length of the electrode current collector end region in the transverse direction (L_{ER}) and the height of the electrode current collector body region in the vertical direction (H_{BR}) satisfy the following relationship:

$${L}_{E R} < 0.5 \times {H}_{BR .}$$

Embodiment 19. The electrode assembly of any preceding Embodiment, wherein the length of the electrode current collector end region in the transverse direction (L_{ER}) and the height of the electrode current collector body region in the vertical direction (H_{BR}) satisfy the following relationship:

$${L}_{E R} < 0.4 \times {H}_{BR .}$$

Embodiment 20. The electrode assembly of any preceding Embodiment, wherein the length of the electrode current collector end region in the transverse direction (L_{ER}) and the height of the electrode current collector body region in the vertical direction (H_{BR}) satisfy the following relationship:

$${L}_{E R} < 0.3 \times {H}_{BR .}$$

Embodiment 21. The electrode assembly of any preceding Embodiment, wherein the length of the counter-electrode current collector end region in the transverse direction (L_{CER}) and the height of the counter-electrode current collector body region in the vertical direction (H_{CBR}) satisfy the following relationship:

$${L}_{C E R} < 0.5 \times {H}_{CBR .}$$

Embodiment 22. The electrode assembly of any preceding Embodiment, wherein the length of the counter-electrode current collector end region in the transverse direction (L_{CER}) and the height of the counter-electrode current collector body region in the vertical direction (H_{BR}) satisfy the following relationship:

$${L}_{C E R} < 0.4 \times {H}_{CBR .}$$

Embodiment 23. The electrode assembly of any preceding Embodiment, wherein the length of the counter-electrode current collector end region in the transverse direction (L_{CER}) and the height of the counter-electrode current collector body region in the vertical direction (H_{BR}) satisfy the following relationship:

$${L}_{C E R} < 0.3 \times {H}_{CBR .}$$

Embodiment 24. The electrode assembly of any preceding Embodiment, wherein the height of the electrode current collector end region in the vertical direction (H_{ER}) and the height of the electrode current collector body region in the vertical direction (H_{BR}) satisfy the following relationship:

$${H}_{E R} > 0.5 \times {H}_{BR .}$$

Embodiment 25. The electrode assembly of any preceding Embodiment, wherein the height of the electrode current collector end region in the vertical direction (H_{ER}) and the height of the electrode current collector body region in the vertical direction (H_{BR}) satisfy the following relationship:

$${H}_{E R} > 0.7 \times {H}_{BR .}$$

Embodiment 26. The electrode assembly of any preceding Embodiment, wherein the height of the electrode current collector end region in the vertical direction (H_{ER}) and the height of the electrode current collector body region in the vertical direction (H_{BR}) satisfy the following relationship:

$${H}_{E R} > 0.9 \times {H}_{BR .}$$

Embodiment 27. The electrode assembly of any preceding Embodiment, wherein the height of the counter-electrode current collector end region in the vertical direction (H_{CER}) and the height of the counter-electrode current collector body region in the vertical direction (H_{CBR}) satisfy the following relationship:

$${H}_{C E R} > 0.5 \times {H}_{CBR .}$$

Embodiment 28. The electrode assembly of any preceding Embodiment, wherein the height of the counter-electrode current collector end region in the vertical direction (H_{CER}) and the height of the counter-electrode current collector body region in the vertical direction (H_{CBR}) satisfy the following relationship:

$${H}_{C E R} > 0.7 \times {H}_{CBR .}$$

Embodiment 29. The electrode assembly of any preceding Embodiment, wherein the height of the counter-electrode current collector end region in the vertical direction (H_{CER}) and the height of the counter-electrode current collector body region in the vertical direction (H_{CBR}) satisfy the following relationship:

$${H}_{C E R} > 0.9 \times {H}_{CBR .}$$

Embodiment 30. The electrode assembly of any preceding Embodiment, wherein the length of the electrode current collector end region in the transverse direction (L_{ER}) and the height of the electrode current collector end region in the vertical direction (H_{ER}) satisfy the following relationship:

$${L}_{E R} / {H}_{E R} < 1 .$$

Embodiment 31. The electrode assembly of any preceding Embodiment, wherein the length of the counter-electrode current collector end region in the transverse direction (L_{CER}) and the height of the counter-electrode current collector end region in the vertical direction (H_{CER}) satisfy the following relationship:

$${L}_{C E R} / {H}_{C E R} < 1 .$$

Embodiment 32. The electrode assembly of any preceding Embodiment, wherein members of the electrode structure population comprise electrode current collector end regions having opposing surfaces separated from each other in the longitudinal direction, and wherein at least one of the opposing surfaces of electrode current collector end regions comprise a layer of thermally conductive material disposed thereon.

Embodiment 33. The electrode assembly of Embodiment 32, wherein electrode current collector end regions electrically connect to the electrode busbar via at least one of the opposing surfaces, and wherein the layer of thermally conductive material is disposed on the other of the opposing surfaces.

Embodiment 34. The electrode assembly of any preceding Embodiment, wherein members of the counter-electrode structure population comprise counter-electrode current collector end regions having opposing surfaces separated from each other in the longitudinal direction, and wherein at least one of the opposing surfaces of counter-electrode current collector end regions comprise a layer of thermally conductive material disposed thereon.

Embodiment 35. The electrode assembly of Embodiment 34, wherein counter-electrode current collector end regions electrically connect to the counter-electrode busbar via at least one of the opposing surfaces, and wherein the layer of thermally conductive material is disposed on the other of the opposing surfaces.

Embodiment 36. The electrode assembly of any of Embodiments 32-35, wherein the thermally conductive material comprises a thermally conductive ceramic material.

Embodiment 37. The electrode assembly of any preceding Embodiment, wherein the length L_{ER} of the electrode current collector end region is from (i) the first or second transverse end of the adjacent electrode active material layer that is on a same transverse side as the electrode current collector end region, to (ii) a region of electrical connection of the electrode current collector end region with the electrode busbar.

Embodiment 38. The electrode assembly of any preceding Embodiment, wherein the length L_{CER} of the counter-electrode current collector end region is from (i) the first or second transverse end of the adjacent counter-electrode active material layer that is on a same transverse side as the counter-electrode current collector end region, to (ii) a region of electrical connection of the counter-electrode current collector end region with the counter-electrode busbar.

Embodiment 39. A method of charging a sealed secondary battery cell, comprising charging at a rate of at least 1 C.

Embodiment 40. The method of Embodiment 39, comprising charging at a rate of at least 2 C.

Embodiment 41. The method of Embodiment 39, comprising charging at a rate of at least 3 C.

Embodiment 42. The method of Embodiment 39, comprising charging at a rate of at least 4 C.

Embodiment 43. The method of Embodiment 39, comprising charging at a rate of at least 6 C.

Embodiment 44. The method of Embodiment 39, comprising charging at a rate of at least 10 C.

Embodiment 45. The method of Embodiment 39, comprising charging at a rate of at least 12 C.

Embodiment 46. The method of Embodiment 39, comprising charging at a rate of at least 15 C.

Embodiment 47. The method of Embodiment 39, comprising charging at a rate of at least 18 C.

Embodiment 48. The method of Embodiment 39, comprising charging at a rate of at least 20 C.

Embodiment 49. The method of Embodiment 39, comprising charging at a rate of at least 30 C.

Embodiment 50. The method according to any of Embodiments 39-49, comprising charging at the rate until the sealed secondary battery cell reaches at least 80% of its rated capacity.

Embodiment 51. The method according to Embodiment 50, comprising charging at the rate until the sealed secondary battery cell reaches at least 85% of its rated capacity.

Embodiment 52. The method according to Embodiment 50, comprising charging at the rate until the sealed secondary battery cell reaches at least 90% of its rated capacity.

Embodiment 53. The method according to Embodiment 50, comprising charging at the rate until the sealed secondary battery cell reaches at least 95% of its rated capacity.

Embodiment 54. The method according to Embodiment 50, comprising charging at the rate until the sealed secondary battery cell reaches at least 99% of its rated capacity.

Embodiment 55. The method according to any of Embodiments 39-54, wherein the sealed secondary battery cell is charged at the charging rate, and discharged, at least 200 times.

Embodiment 56. The method according to Embodiment 55, wherein the sealed secondary battery cell is charged at the charging rate, and discharged, at least 300 times.

Embodiment 57. The method according to Embodiment 55, wherein the sealed secondary battery cell is charged at the charging rate, and discharged, at least 400 times.

Embodiment 58. The method according to Embodiment 55, wherein the sealed secondary battery cell is charged at the charging rate, and discharged, at least 500 times.

Embodiment 59. The method according to Embodiment 55, wherein the sealed secondary battery cell is charged at the charging rate, and discharged, at least 600 times.

Embodiment 60. The method according to Embodiment 55, wherein the sealed secondary battery cell is charged at the charging rate, and discharged, at least 800 times.

Embodiment 61. The method according to Embodiment 55, wherein the sealed secondary battery cell is charged at the charging rate, and discharged, at least 1000 times.

Embodiment 62. The method according to any of Embodiments 39-61, wherein the sealed secondary battery cell comprises any of the electrode assemblies according to Embodiments 1-38, or any combination thereof.

Embodiment 63. The method of any of Embodiments 39-62, wherein the sealed secondary battery cell has a rated capacity of at least 500 mAmp·hr.

Embodiment 64. The method of Embodiment 63, wherein the sealed secondary battery cell has a rated capacity of at least 1 Amp·hr.

Embodiment 65. The method of Embodiment 63, wherein the sealed secondary battery cell has a rated capacity of at least 5 Amp·hr.

Embodiment 66. The method of Embodiment 63, wherein the sealed secondary battery cell has a rated capacity of at least 10 Amp·hr.

Embodiment 67. The method of Embodiment 63, wherein the sealed secondary battery cell has a rated capacity of at least 15 Amp·hr.

Embodiment 68. The method of Embodiment 63, wherein the sealed secondary battery cell has a rated capacity of at least 20 Amp·hr.

Embodiment 69. The method of Embodiment 63, wherein the sealed secondary battery cell has a rated capacity of at least 25 Amp·hr.

Embodiment 70. The method of Embodiment 63, wherein the sealed secondary battery cell has a rated capacity of at least 30 Amp·hr.

Embodiment 71. The method of Embodiment 63, wherein the sealed secondary battery cell has a rated capacity of at least 35 Amp·hr.

Embodiment 72. The method of Embodiment 63, wherein the sealed secondary battery cell has a rated capacity of at least 50 Amp·hr.

Embodiment 73. The electrode assembly, or method of any preceding Embodiment, wherein the electrode assembly has a substantially polyhedral shape, with opposing longitudinal end surfaces that are substantially flat, opposing vertical surfaces that are substantially flat, and opposing transverse surfaces that are substantially flat.

Embodiment 74. The electrode assembly, or method of any preceding Embodiment, wherein the ratio of V_{SA} to each of L_{SA} and T_{SA} is at least 5:1.

Embodiment 75. The method of any preceding Embodiment, wherein the sealed secondary battery cell comprises a core energy density of at least 700 Whr/liter, wherein the core energy density is defined as the rated capacity of the sealed secondary battery cell divided by the combined weight of the electrode structures, counter-electrode structures, separators, and any electrolyte that makes up the electrode assembly of the sealed secondary battery cell.

Embodiment 76. The method of any preceding Embodiment, wherein the sealed secondary battery cell comprises a core energy density of at least 800 Whr/liter, wherein the core energy density is defined as the rated capacity of the sealed secondary battery cell divided by the combined weight of the electrode structures, counter-electrode structures, separators, and any electrolyte that makes up the electrode assembly of the sealed secondary battery cell.

Embodiment 77. The method of any preceding Embodiment, wherein the sealed secondary battery cell comprises a core energy density of at least 900 Whr/liter, wherein the core energy density is defined as the rated capacity of the sealed secondary battery cell divided by the combined weight of the electrode structures, counter-electrode structures, separators, and any electrolyte that makes up the electrode assembly of the sealed secondary battery cell.

Embodiment 78. The method of any preceding Embodiment, wherein the sealed secondary battery cell comprises a core energy density of at least 1000 Whr/liter, wherein the core energy density is defined as the rated capacity of the sealed secondary battery cell divided by the combined weight of the electrode structures, counter-electrode structures, separators, and any electrolyte that makes up the electrode assembly of the sealed secondary battery cell.

Embodiment 79. The method of any preceding Embodiment, wherein the sealed secondary battery cell comprises a core energy density of at least 1100 Whr/liter, wherein the core energy density is defined as the rated capacity of the sealed secondary battery cell divided by the combined weight of the electrode structures, counter-electrode structures, separators, and any electrolyte that makes up the electrode assembly of the sealed secondary battery cell.

Embodiment 80. The method of any preceding Embodiment, wherein the sealed secondary battery cell comprises a core energy density of at least 1200 Whr/liter, wherein the core energy density is defined as the rated capacity of the sealed secondary battery cell divided by the combined weight of the electrode structures, counter-electrode structures, separators, and any electrolyte that makes up the electrode assembly of the sealed secondary battery cell.

Embodiment 81. The electrode assembly, or method of any preceding Embodiment, wherein members of the electrode structure population comprise layers of electrode active material, and wherein the layers of electrode active material comprise a thickness in the longitudinal direction in a range of from 15 microns to 75 microns.

Embodiment 82. The electrode assembly, or method of any preceding Embodiment, wherein members of the electrode structure population comprise layers of electrode active material, and wherein the layers of electrode active material comprise a thickness in the longitudinal direction in a range of from 20 microns to 60 microns.

Embodiment 83. The electrode assembly, or method of any preceding Embodiment, wherein members of the electrode structure population comprise layers of electrode active material, and wherein the layers of electrode active material comprise a thickness in the longitudinal direction in a range of from 30 microns to 50 microns.

Embodiment 84. The electrode assembly, or method of any preceding Embodiment, wherein members of the electrode structure population comprise layers of electrode active material, and wherein the layers of electrode active material comprise a thickness in the longitudinal direction of about 45 microns.

Embodiment 85. The electrode assembly, or method of any preceding Embodiment, wherein members of the electrode structure population comprise layers of electrode active material, and wherein the layers of electrode active material comprise a porosity in a range of from 10-40%.

Embodiment 86. The electrode assembly, or method of any preceding Embodiment, wherein members of the electrode structure population comprise layers of electrode active material, and wherein the layers of electrode active material comprise a porosity in a range of from 12-30%.

Embodiment 87. The electrode assembly, or method of any preceding Embodiment, wherein members of the electrode structure population comprise layers of electrode active material, and wherein the layers of electrode active material comprise a porosity in a range of from 18-20%.

Embodiment 88. The method of any preceding Embodiment, wherein the sealed secondary battery cell comprises an electrode busbar that electrically connects to electrode current collectors to pool current from members of the electrode structure population, and comprises a counter-electrode busbar that electrically connects to counter-electrode current collectors to pool current from members of the counter-electrode structure population, and wherein the sealed secondary battery cell further comprises:
an electrode busbar tab that electrically connects the electrode busbar to electrical structures exterior to the sealed secondary battery cell, and a counter-electrode busbar tab that electrically connects the counter-electrode busbar to electrical structures exterior to the sealed secondary battery cell, and
a cooling system configured to cool the electrode or counter-electrode busbar tab, via one or more of convective or conductive cooling.

Embodiment 89. The sealed secondary battery cell, or method of Embodiment 88, wherein the cooling is by cooling tubes provided adjacent the tabs, or by a heat sink that is thermally connected to the tabs.

Embodiment 90. A sealed secondary battery cell chargeable between a charged state and a discharged state, the sealed secondary battery cell comprising a hermetically sealed case, an electrode assembly enclosed by the hermetically sealed case, and a rated capacity of at least 100 mAmp·hr, wherein,
the electrode assembly has a substantially polyhedral shape with mutually perpendicular transverse, longitudinal and vertical axes corresponding to the x, y and z axes, respectively, of an imaginary three-dimensional Cartesian coordinate system, opposing longitudinal end surfaces that are substantially flat and separated from each other in the longitudinal direction, and a lateral surface surrounding an electrode assembly longitudinal axis A_{EA} and connecting the first and second longitudinal end surfaces, the lateral surface having opposing vertical surfaces that are substantially flat and separated from each other in the vertical direction on opposing vertical sides of the longitudinal axis, and opposing transverse surfaces that are substantially flat and separated from each other in the transverse direction on opposing transverse sides of the longitudinal axis, wherein the opposing longitudinal surfaces have a combined surface area, L_{SA}, the opposing transverse surfaces have a combined surface area, T_{SA}, the opposing vertical surfaces have a combined surface area, V_{SA}, and the ratio of V_{SA} to each of L_{SA} and T_{SA} is at least 5:1,
the electrode assembly further comprises an electrode structure population, an electrically insulating separator population, and a counter-electrode structure population, wherein members of the electrode structure, electrically insulating separator and counter-electrode structure populations are arranged in an alternating sequence,
the hermetically sealed case has opposing first and second case ends separated in the longitudinal direction, and a case sidewall that connects the first and second case ends, the opposing first and second case ends and case sidewall forming a hermetic seal about the electrode assembly, wherein the case sidewall comprises upper and lower sidewalls separated from each other in the vertical direction, and first and second transverse sidewalls that are separated from each other in the transverse direction,
wherein members of the electrode structure population and/or counter-electrode structure are connected to the upper and lower sidewalls of the hermetically sealed case to restrain growth of the electrode assembly in the vertical direction during cycling of the secondary battery cell between the charged and discharged states, and
the charged state is at least 75% of a rated capacity of the secondary battery cell, and the discharged state is less than 25% of a rated capacity of the secondary battery cell.

Embodiment 91: The electrode assembly, sealed secondary battery cell, or method according to any preceding Embodiment, wherein members of the population of electrode structures and/or members of the population of counter-electrode structures that are connected to the upper and lower sidewalls have a thickness as measured in the longitudinal direction that is in a range of between 5 and 50 μm.

Embodiment 92: The electrode assembly, sealed secondary battery cell, or method according to any preceding Embodiment, wherein members of the population of electrode structures and/or members of the population of counter-electrode structures that are connected to the upper and lower sidewalls have a yield strength of greater than 70 MPa.

Embodiment 93: The electrode assembly, sealed secondary battery cell, or method according to any preceding Embodiment, wherein members of the population of electrode structures and/or members of the population of counter-electrode structures that are connected to the upper and lower sidewalls have a yield strength of greater than 100 MPa.

Embodiment 94: The electrode assembly, sealed secondary battery cell, or method according to any preceding Embodiment, wherein a thickness of the secondary battery cell as measured in the vertical direction between vertically opposing regions of external vertical surfaces of the upper and lower sidewalls of the hermetically sealed case, is at least 1 mm.

Embodiment 95: The electrode assembly, sealed secondary battery cell, or method according to any preceding Embodiment, wherein a thermal conductivity of the secondary battery cell along a thermally conductive path between the vertically opposing regions of the external vertical surfaces of the upper and lower sidewalls of the hermetically sealed case in the vertical direction is at least 7.5 W/m·K.

Embodiment 96: The electrode assembly, sealed secondary battery cell, or method according to any preceding Embodiment, wherein the opposing longitudinal, vertical, and transverse surfaces make up a combined surface area of greater than 66% of the electrode assembly.

Embodiment 97: The electrode assembly, sealed secondary battery cell, or method according to any preceding Embodiment, wherein the opposing longitudinal, vertical, and transverse surfaces make up a combined surface area of greater than 75% of the electrode assembly.

Embodiment 98: The electrode assembly, sealed secondary battery cell, or method according to any preceding Embodiment, wherein the opposing longitudinal, vertical, and transverse surfaces make up a combined surface area of greater than 80% of the electrode assembly.

Embodiment 99: The electrode assembly, sealed secondary battery cell, or method according to any preceding Embodiment, wherein the opposing longitudinal, vertical, and transverse surfaces make up a combined surface area of greater than 95% of the electrode assembly.

Embodiment 100: The electrode assembly, sealed secondary battery cell, or method according to any preceding Embodiment, wherein the opposing longitudinal, vertical, and transverse surfaces make up a combined surface area of greater than 99% of the electrode assembly.

Embodiment 101: The electrode assembly, sealed secondary battery cell, or method according to any preceding Embodiment, wherein the opposing longitudinal, vertical, and transverse surfaces make up a combined surface area corresponding to substantially the entire surface area of the electrode assembly.

Embodiment 102: The electrode assembly, sealed secondary battery cell, or method according to any preceding Embodiment, wherein the opposing first and second case ends are connected together by one or more of the upper and lower sidewalls of the case, and restrain growth of the electrode assembly in the longitudinal direction.

Embodiment 103: The electrode assembly, sealed secondary battery cell, or method according to any preceding Embodiment, wherein the sealed secondary battery further comprises a set of electrode constraints internal to the hermetically sealed case, the set of electrode constraints comprising a vertical constraint system comprising first and second vertical growth constraints that are separated from each other in the vertical direction, the first and second vertical growth constraints being connected to members of the population of electrode structures and/or members of the population of counter-electrode structures, and the vertical constraint system being capable of restraining growth of the electrode assembly in the vertical direction, and wherein the first and second vertical growth constraints are connected to the respective upper and lower sidewalls, to indirectly connect the members of the population of electrode structures and/or members of the population of counter-electrode structures to the upper and lower sidewalls.

Embodiment 104: The electrode assembly, sealed secondary battery cell, or method according to any preceding Embodiment, wherein the set of electrode constraints that are internal to the hermetically sealed case further comprise a longitudinal constraint system comprising first and second longitudinal constraints separated from each other in the longitudinal direction, and connected by a connecting member to restrain growth of the electrode assembly in the longitudinal direction.

Embodiment 105: The electrode assembly, sealed secondary battery cell, or method according to any preceding Embodiment, wherein the sealed secondary battery has a rated capacity of at least 150 mAmp·hr.

Embodiment 106: The electrode assembly, sealed secondary battery cell, or method according to any preceding Embodiment, wherein the sealed secondary battery has a rated capacity of at least 200 mAmp·hr.

Embodiment 107: The electrode assembly, sealed secondary battery cell, or method according to any preceding Embodiment, wherein the sealed secondary battery has a rated capacity of at least 400 mAmp·hr.

Embodiment 108: The electrode assembly, sealed secondary battery cell, or method according to any preceding Embodiment, wherein the sealed secondary battery has a rated capacity of at least 0.1 Amp-hr.

Embodiment 109: The electrode assembly, sealed secondary battery cell, or method according to any preceding Embodiment, wherein the sealed secondary battery has a rated capacity of at least 0.5 Amp-hr.

Embodiment 110: The electrode assembly, sealed secondary battery cell, or method according to any preceding Embodiment, wherein the sealed secondary battery has a rated capacity of at least 1 Amp·hr.

Embodiment 111: The electrode assembly, sealed secondary battery cell, or method according to any preceding Embodiment, wherein the sealed secondary battery has a rated capacity of at least 3 Amp·hr.

Embodiment 112: The electrode assembly, sealed secondary battery cell, or method according to any preceding Embodiment, wherein the sealed secondary battery has a rated capacity of at least 5 Amp·hr.

Embodiment 113: The electrode assembly, sealed secondary battery cell, or method according to any preceding Embodiment, wherein between vertically opposing regions of external vertical surfaces of the upper and lower sidewalls of the hermetically sealed case, is at least 2 mm.

Embodiment 114: The electrode assembly, sealed secondary battery cell, or method according to any preceding Embodiment, wherein between vertically opposing regions of external vertical surfaces of the upper and lower sidewalls of the hermetically sealed case, is at least 3 mm.

Embodiment 115: The electrode assembly, sealed secondary battery cell, or method according to any preceding Embodiment, wherein between vertically opposing regions of external vertical surfaces of the upper and lower sidewalls of the hermetically sealed case, is at least 5 mm.

Embodiment 116: The electrode assembly, sealed secondary battery cell, or method according to any preceding Embodiment, wherein between vertically opposing regions of external vertical surfaces of the upper and lower sidewalls of the hermetically sealed case, is at least 8 mm.

Embodiment 117: The electrode assembly, sealed secondary battery cell, or method according to any preceding Embodiment, wherein between vertically opposing regions of external vertical surfaces of the upper and lower sidewalls of the hermetically sealed case, is at least 10 mm.

Embodiment 118: The electrode assembly, sealed secondary battery cell, or method according to any preceding Embodiment, wherein the thermal conductivity of the secondary battery along the thermally conductive path between vertically opposing regions of external vertical surfaces of the upper and lower sidewalls of the hermetically sealed case in the vertical direction is at least 8 W/m·K.

Embodiment 119: The electrode assembly, sealed secondary battery cell, or method according to any preceding Embodiment, wherein the thermal conductivity of the secondary battery along the thermally conductive path between vertically opposing regions of external vertical surfaces of the upper and lower sidewalls of the hermetically sealed case in the vertical direction is at least 10 W/m·K.

Embodiment 120: The electrode assembly, sealed secondary battery cell, or method according to any preceding Embodiment, wherein the thermal conductivity of the secondary battery along the thermally conductive path between vertically opposing regions of external vertical surfaces of the upper and lower sidewalls of the hermetically sealed case in the vertical direction is at least 15 W/m·K.

Embodiment 121: The electrode assembly, sealed secondary battery cell, or method according to any preceding Embodiment, wherein the thermally conductive path is along the vertical direction of members of the population of electrode structures and/or members of the population of counter-electrode structures that are connected to the upper and lower sidewalls.

Embodiment 122: The electrode assembly, sealed secondary battery cell, or method according to any preceding Embodiment, wherein the hermetically sealed case comprises a metal material comprising any selected from the group consisting of stainless steel, aluminum, titanium, beryllium, beryllium, copper, nickel, and alloys thereof.

Embodiment 123: The electrode assembly, sealed secondary battery cell, or method according to any preceding Embodiment, wherein the upper and lower sidewalls comprise any of stainless steel and aluminum.

Embodiment 124: The electrode assembly, sealed secondary battery cell, or method according to any preceding Embodiment, wherein the first and second vertical growth constraints and/or first and second longitudinal constraints comprise any of metals, alloys, ceramics, glass, plastics, or a combination thereof.

Embodiment 125: The electrode assembly, sealed secondary battery cell, or method according to any preceding Embodiment, wherein the first and second vertical growth constraints and/or first and second longitudinal constraints comprise any of stainless steel and aluminum.

Embodiment 126: The electrode assembly, sealed secondary battery cell, or method according to any preceding Embodiment, wherein upper and lower sidewalls, either alone or in combination with first and second vertical growth constraints, have a yield strength of at least 70 MPa.

Embodiment 127: The electrode assembly, sealed secondary battery cell, or method according to any preceding Embodiment, wherein upper and lower sidewalls, either alone or in combination with first and second vertical growth constraints, have a yield strength of at least 100 MPa.

Embodiment 128: The electrode assembly, sealed secondary battery cell, or method according to any preceding Embodiment, wherein upper and lower sidewalls, either alone or in combination with first and second vertical growth constraints, have a yield strength of at least 150 MPa.

Embodiment 129: The electrode assembly, sealed secondary battery cell, or method according to any preceding Embodiment, wherein upper and lower sidewalls, either alone or in combination with first and second vertical growth constraints, have a yield strength of at least 200 MPa.

Embodiment 130: The electrode assembly, sealed secondary battery cell, or method according to any preceding Embodiment, wherein upper and lower sidewalls, either alone or in combination with first and second vertical growth constraints, have a yield strength of at least 300 MPa.

Embodiment 131: The electrode assembly, sealed secondary battery cell, or method according to any preceding Embodiment, wherein upper and lower sidewalls, either alone or in combination with first and second vertical growth constraints, have a yield strength of at least 500 MPa.

Embodiment 132: The electrode assembly, sealed secondary battery cell, or method according to any preceding Embodiment, wherein upper and lower sidewalls, either alone or in combination with first and second vertical growth constraints, have a tensile strength of at least 70 MPa.

Embodiment 133: The electrode assembly, sealed secondary battery cell, or method according to any preceding Embodiment, wherein upper and lower sidewalls, either alone or in combination with first and second vertical growth constraints, have a tensile strength of at least 100 MPa.

Embodiment 134: The electrode assembly, sealed secondary battery cell, or method according to any preceding Embodiment, wherein upper and lower sidewalls, either alone or in combination with first and second vertical growth constraints, have a tensile strength of at least 150 MPa.

Embodiment 135: The electrode assembly, sealed secondary battery cell, or method according to any preceding Embodiment, wherein upper and lower sidewalls, either alone or in combination with first and second vertical growth constraints, have a tensile strength of at least 200 MPa.

Embodiment 136: The electrode assembly, sealed secondary battery cell, or method according to any preceding Embodiment, wherein upper and lower sidewalls, either alone or in combination with first and second vertical growth constraints, have a tensile strength of at least 300 MPa.

Embodiment 137: The electrode assembly, sealed secondary battery cell, or method according to any preceding Embodiment, wherein upper and lower sidewalls, either alone or in combination with first and second vertical growth constraints, have a tensile strength of at least 500 MPa.

Embodiment 138: The electrode assembly, sealed secondary battery cell, or method according to any preceding Embodiment, wherein the first and second case ends, either alone or in combination with first and second longitudinal growth constraints, have a yield strength of at least 70 MPa.

Embodiment 139: The electrode assembly, sealed secondary battery cell, or method according to any preceding Embodiment, wherein the first and second case ends, either alone or in combination with first and second longitudinal growth constraints, have a yield strength of at least 100 MPa.

Embodiment 140: The electrode assembly, sealed secondary battery cell, or method according to any preceding Embodiment, wherein the first and second case ends, either alone or in combination with first and second longitudinal growth constraints, have a yield strength of at least 150 MPa.

Embodiment 141: The electrode assembly, sealed secondary battery cell, or method according to any preceding Embodiment, wherein the first and second case ends, either alone or in combination with first and second longitudinal growth constraints, have a yield strength of at least 200 MPa.

Embodiment 142: The electrode assembly, sealed secondary battery cell, or method according to any preceding Embodiment, wherein the first and second case ends, either alone or in combination with first and second longitudinal growth constraints, have a yield strength of at least 300 MPa.

Embodiment 143: The electrode assembly, sealed secondary battery cell, or method according to any preceding Embodiment, wherein the first and second case ends, either alone or in combination with first and second longitudinal growth constraints, have a yield strength of at least 500 MPa.

Embodiment 144: The electrode assembly, sealed secondary battery cell, or method according to any preceding Embodiment, wherein the first and second case ends, either alone or in combination with first and second longitudinal growth constraints, have a tensile strength of at least 70 MPa.

Embodiment 145: The electrode assembly, sealed secondary battery cell, or method according to any preceding Embodiment, wherein the first and second case ends, either alone or in combination with first and second longitudinal growth constraints, have a tensile strength of at least 100 MPa.

Embodiment 146: The electrode assembly, sealed secondary battery cell, or method according to any preceding Embodiment, wherein the first and second case ends, either alone or in combination with first and second longitudinal growth constraints, have a tensile strength of at least 150 MPa.

Embodiment 147: The electrode assembly, sealed secondary battery cell, or method according to any preceding Embodiment, wherein the first and second case ends, either alone or in combination with first and second longitudinal growth constraints, have a tensile strength of at least 200 MPa.

Embodiment 148: The electrode assembly, sealed secondary battery cell, or method according to any preceding Embodiment, wherein the first and second case ends, either alone or in combination with first and second longitudinal growth constraints, have a tensile strength of at least 300 MPa.

Embodiment 149: The electrode assembly, sealed secondary battery cell, or method according to any preceding Embodiment, wherein the first and second case ends, either alone or in combination with first and second longitudinal growth constraints, have a tensile strength of at least 500 MPa.

Embodiment 150: The electrode assembly, sealed secondary battery cell, or method according to any preceding Embodiment, wherein members of the population of electrode structures and/or members of the population of counter-electrode structures that are connected to the upper and lower sidewalls have a yield strength of greater than 70 MPa.

Embodiment 151: The electrode assembly, sealed secondary battery cell, or method according to any preceding Embodiment, wherein members of the population of electrode structures and/or members of the population of counter-electrode structures that are connected to the upper and lower sidewalls have a yield strength of greater than 150 MPa.

Embodiment 152: The electrode assembly, sealed secondary battery cell, or method according to any preceding Embodiment, wherein members of the population of electrode structures and/or members of the population of counter-electrode structures that are connected to the upper and lower sidewalls have a yield strength of greater than 200 MPa.

Embodiment 153: The electrode assembly, sealed secondary battery cell, or method according to any preceding Embodiment, wherein members of the population of electrode structures and/or members of the population of counter-electrode structures that are connected to the upper and lower sidewalls have a yield strength of greater than 300 MPa.

Embodiment 154: The electrode assembly, sealed secondary battery cell, or method according to any preceding Embodiment, wherein members of the population of electrode structures and/or members of the population of counter-electrode structures that are connected to the upper and lower sidewalls have a yield strength of greater than 500 MPa.

Embodiment 155: The electrode assembly, sealed secondary battery cell, or method according to any preceding Embodiment, wherein members of the population of electrode structures and/or members of the population of counter-electrode structures that are connected to the upper and lower sidewalls have a tensile strength of greater than 70 MPa.

Embodiment 156: The electrode assembly, sealed secondary battery cell, or method according to any preceding Embodiment, wherein members of the population of electrode structures and/or members of the population of counter-electrode structures that are connected to the upper and lower sidewalls have a tensile strength of greater than 100 MPa.

Embodiment 157: The electrode assembly, sealed secondary battery cell, or method according to any preceding Embodiment, wherein members of the population of electrode structures and/or members of the population of counter-electrode structures that are connected to the upper and lower sidewalls have a tensile strength of greater than 150 MPa.

Embodiment 158: The electrode assembly, sealed secondary battery cell, or method according to any preceding Embodiment, wherein members of the population of electrode structures and/or members of the population of counter-electrode structures that are connected to the upper and lower sidewalls have a tensile strength of greater than 200 MPa.

Embodiment 159: The electrode assembly, sealed secondary battery cell, or method according to any preceding Embodiment, wherein members of the population of electrode structures and/or members of the population of counter-electrode structures that are connected to the upper and lower sidewalls have a tensile strength of greater than 300 MPa.

Embodiment 160: The electrode assembly, sealed secondary battery cell, or method according to any preceding Embodiment, wherein members of the population of electrode structures and/or members of the population of counter-electrode structures that are connected to the upper and lower sidewalls have a tensile strength of greater than 500 MPa.

Embodiment 161: The electrode assembly, sealed secondary battery cell, or method according to any preceding Embodiment, wherein the members of the electrode structure, electrically insulating separator and counter-electrode structure populations are arranged in an alternating sequence in the longitudinal direction.

Embodiment 162: The electrode assembly, sealed secondary battery cell, or method according to any preceding Embodiment, wherein the members of the electrode structure population comprise electrode active material layers and electrode current collector layers, and members of the counter-electrode structure population comprise counter-electrode active material layers and counter-electrode current collector layers.

Embodiment 163: The electrode assembly, sealed secondary battery cell, or method according to any preceding Embodiment, wherein the upper and lower sidewalls are connected to upper and lower surfaces of members of the electrode structure population and/or counter-electrode structure population.

Embodiment 164: The electrode assembly, sealed secondary battery cell, or method according to any preceding Embodiment, wherein the upper and lower sidewalls are connected to upper and lower surfaces of electrode current collectors of members of the electrode structure population, and/or upper and lower surfaces of counter-electrode current collectors of members of the counter-electrode population.

Embodiment 165: The electrode assembly, sealed secondary battery cell, or method according to any preceding Embodiment, wherein the first and second vertical growth constraints are connected to upper and lower surfaces of members of the electrode structure population and/or counter-electrode structure population.

Embodiment 166: The electrode assembly, sealed secondary battery cell, or method according to any preceding Embodiment, wherein the first and second vertical growth constraints are connected to upper and lower surfaces of electrode current collectors of members of the electrode structure population, and/or upper and lower surfaces of counter-electrode current collectors of members of the counter-electrode population.

Embodiment 167: The electrode assembly, sealed secondary battery cell, or method according to any preceding Embodiment, wherein the electrode and/or counter-electrode current collectors that are connected to the upper and lower sidewalls comprise a thickness as measured in the longitudinal direction that is in a range of between 5 and 50 μm.

Embodiment 168: The electrode assembly, sealed secondary battery cell, or method according to any preceding Embodiment, wherein the electrode and/or counter-electrode current collectors that are connected to the upper and lower sidewalls comprise a yield strength of greater than 100 MPa.

Embodiment 169: The electrode assembly, sealed secondary battery cell, or method according to any preceding Embodiment, wherein the upper and lower sidewalls connected to the members of the electrode structure population or counter-electrode structure population, alone or together with the internal vertical constraint system constrain growth in the vertical direction such that any increase in the Feret diameter of the electrode assembly over 20 consecutive cycles is less than 2%.

Embodiment 170: The electrode assembly, sealed secondary battery cell, or method according to any preceding Embodiment, wherein the upper and lower sidewalls connected to the members of the electrode structure population or counter-electrode structure population, alone or together with the internal vertical constraint system constrain growth in the vertical direction such that any increase in the Feret diameter of the electrode assembly over 30 consecutive cycles is less than 2%.

Embodiment 171: The electrode assembly, sealed secondary battery cell, or method according to any preceding Embodiment, wherein the upper and lower sidewalls connected to the members of the electrode structure population or counter-electrode structure population, alone or together with the internal vertical constraint system constrain growth in the vertical direction such that any increase in the Feret diameter of the electrode assembly over 50 consecutive cycles is less than 2%.

Embodiment 172: The electrode assembly, sealed secondary battery cell, or method according to any preceding Embodiment, wherein the upper and lower sidewalls connected to the members of the electrode structure population or counter-electrode structure population, alone or together with the internal vertical constraint system constrain growth in the vertical direction such that any increase in the Feret diameter of the electrode assembly over 80 consecutive cycles is less than 2%.

Embodiment 173: The electrode assembly, sealed secondary battery cell, or method according to any preceding Embodiment, wherein the upper and lower sidewalls connected to the members of the electrode structure population or counter-electrode structure population, alone or together with the internal vertical constraint system constrain growth in the vertical direction such that any increase in the Feret diameter of the electrode assembly over 100 consecutive cycles is less than 2%.

Embodiment 174: The electrode assembly, sealed secondary battery cell, or method according to any preceding Embodiment, wherein the first and second longitudinal growth constraints comprise a thickness in the longitudinal direction of at least 150 μm.

Embodiment 175: The electrode assembly, sealed secondary battery cell, or method according to any preceding Embodiment, wherein the first and second longitudinal growth constraints comprise a thickness in the longitudinal direction of at least 250 μm.

Embodiment 176: The electrode assembly, sealed secondary battery cell, or method according to any preceding Embodiment, wherein the first and second longitudinal growth constraints comprise a thickness in the longitudinal direction of at least 400 μm.

Embodiment 177: The electrode assembly, sealed secondary battery cell, or method according to any preceding Embodiment, wherein members of the population of electrode structures and/or members of the population of counter-electrode structures are connected directly to the upper and lower sidewalls.

Embodiment 178: The electrode assembly, sealed secondary battery cell, or method according to any preceding Embodiment, wherein members of the population of electrode structures and/or members of the population of counter-electrode structures are connected directly to the upper and lower sidewalls by any one or more of one or more of adhering, gluing, welding, bonding, joining, soldering, sintering, press contacting, brazing, thermal spraying joining, clamping, wire bonding, ribbon bonding, ultrasonic bonding, ultrasonic welding, resistance welding, laser beam welding, electron beam welding, induction welding, cold welding, plasma spraying, flame spraying, and arc spraying.

Embodiment 179: The electrode assembly, sealed secondary battery cell, or method according to any preceding Embodiment, wherein the members of the population of electrode structures and/or members of the population of counter-electrode structures are connected indirectly to the upper and lower sidewalls.

Embodiment 180: The electrode assembly, sealed secondary battery cell, or method according to any preceding Embodiment, wherein members of the population of electrode structures and/or members of the population of counter-electrode structures are connected via first and second vertical growth constraints to the upper and lower sidewalls.

Embodiment 181: The electrode assembly, sealed secondary battery cell, or method according to any preceding Embodiment, wherein the members of the population of electrode structures and/or members of the population of counter-electrode structures are connected directly to first and second vertical growth constraints by any one or more of one or more of adhering, gluing, welding, bonding, joining, soldering, sintering, press contacting, brazing, thermal spraying joining, clamping, wire bonding, ribbon bonding, ultrasonic bonding, ultrasonic welding, resistance welding, laser beam welding, electron beam welding, induction welding, cold welding, plasma spraying, flame spraying, and arc spraying.

Embodiment 182: The electrode assembly, sealed secondary battery cell, or method according to any preceding Embodiment, wherein the first and second vertical growth constraints are connected to the respective upper and lower sidewalls by any one or more of adhering, gluing, welding, bonding, soldering, sintering, joining, press contacting, brazing, thermal spraying joining, clamping, wire bonding, ribbon bonding, ultrasonic bonding, ultrasonic welding, resistance welding, laser beam welding, electron beam welding, induction welding, cold welding, plasma spraying, flame spraying, and arc spraying.

Embodiment 183. The electrode assembly, sealed secondary battery cell, or method according to any preceding Embodiment, wherein the first and second vertical growth constraints comprise apertures through the vertical thicknesses thereof.

Embodiment 184. The electrode assembly, sealed secondary battery cell, or method according to any preceding Embodiment, where the surface area of the opposing longitudinal end surfaces is less than 33% of the surface area of the electrode assembly.

Embodiment 185. The electrode assembly, sealed secondary battery cell, or method according to any preceding Embodiment, wherein for members of the secondary battery cell population, a length L_{E} of each member of the electrode structure population and a length L_{CE} of each member of the counter-electrode structure population are measured in the transverse direction of their central longitudinal axis A_{E} and A_{CE}, a width W_{E} of each member of the electrode structure population and a width W_{CE} of each member of the counter-electrode structure population are measured in the longitudinal direction, and a height H_{E} of each member the electrode structure population and a height H_{CE} of each member of the counter-electrode structure population is measured in the vertical direction that is perpendicular to the central longitudinal axis A_{E} or A_{CE} of each such member and to the longitudinal direction, the ratio of L_{E} to each of W_{E} and H_{E} of each member of the electrode structure population being at least 5:1, respectively, the ratio of H_{E} to W_{E} for each member of the electrode structure population being between 0.4:1 and 1000:1, and the ratio of L_{CE} to each of W_{CE} and H_{CE} of each member of the counter-electrode structure population being at least 5:1, respectively, the ratio of H_{CE} to W_{CE} for each member of the counter-electrode structure population being between 0.4:1 and 1000:1.

Embodiment 186. The electrode assembly, sealed secondary battery cell, or method according to any preceding Embodiment, wherein for members of the population of secondary battery cells, the electrode assembly has a maximum width W_{EA} measured in the longitudinal direction, a maximum length L_{EA} bounded by the lateral surface and measured in the transverse direction, and a maximum height H_{EA} bounded by the lateral surface and measured in the vertical direction, and the ratio of each of L_{EA} and W_{EA} to H_{EA} is at least 2:1.

Embodiment 187. The electrode assembly, sealed secondary battery cell, or method according to any preceding Embodiment, wherein a projection of members of the electrode structure population and the counter electrode structure populations onto the first longitudinal surface circumscribes a first projected area and a projection of the members of the electrode structure population and the counter electrode structure population onto the second longitudinal surface circumscribes a second projected area, and wherein the first and second longitudinal growth constraints comprises first and second compression members that overlie the first and second projected areas.

Embodiment 188. The electrode assembly, sealed secondary battery cell, or method according to any preceding Embodiment, wherein the opposing first and second ends of the hermetically sealed case, or the first and second longitudinal growth constraints, either alone or in combination with one another maintain a pressure on the electrode assembly in the longitudinal direction that exceeds the pressure maintained on the electrode assembly in the each of the two directions that are mutually perpendicular and perpendicular to the longitudinal direction.

Embodiment 189. The electrode assembly, sealed secondary battery cell, or method according to any preceding Embodiment, wherein the opposing first and second ends of the hermetically sealed case, or the first and second longitudinal growth constraints, either alone or in combination with one another maintain a pressure on the electrode assembly in the longitudinal direction that exceeds the pressure maintained on the electrode assembly in the each of the two directions that are mutually perpendicular and perpendicular to the longitudinal direction by a factor of at least 3.

Embodiment 190. The electrode assembly, sealed secondary battery cell, or method according to any preceding Embodiment, wherein the opposing first and second ends of the hermetically sealed case, or the first and second longitudinal growth constraints, either alone or in combination with one another maintain a pressure on the electrode assembly in the longitudinal direction that exceeds the pressure maintained on the electrode assembly in the each of the two directions that are mutually perpendicular and perpendicular to the longitudinal direction by a factor of at least 4.

Embodiment 191. The electrode assembly, sealed secondary battery cell, or method according to any preceding Embodiment, wherein the opposing first and second ends of the hermetically sealed case, or the first and second longitudinal growth constraints, either alone or in combination with one another maintain a pressure on the electrode assembly in the longitudinal direction that exceeds the pressure maintained on the electrode assembly in the each of the two directions that are mutually perpendicular and perpendicular to the longitudinal direction by a factor of at least 5.

Embodiment 192. The electrode assembly, sealed secondary battery cell, or method according to any preceding Embodiment, wherein the opposing first and second ends of the hermetically sealed case, or the first and second longitudinal growth constraints, either alone or in combination with one another restrain growth of the electrode assembly in the longitudinal direction such that any increase in the Feret diameter of the electrode assembly in the longitudinal direction over 20 consecutive cycles is less than 20%.

Embodiment 193. The electrode assembly, sealed secondary battery cell, or method according to any preceding Embodiment, wherein the opposing first and second ends of the hermetically sealed case, or the first and second longitudinal growth constraints, either alone or in combination with one another restrain growth of the electrode assembly in the longitudinal direction such that any increase in the Feret diameter of the electrode assembly in the longitudinal direction over 10 consecutive cycles is less than 10%

Embodiment 194. The electrode assembly, sealed secondary battery cell, or method according to any preceding Embodiment, wherein the opposing first and second ends of the hermetically sealed case, or the first and second longitudinal growth constraints, either alone or in combination with one another restrain growth of the electrode assembly in the longitudinal direction such that any increase in the Feret diameter of the electrode assembly in the longitudinal direction over 5 consecutive cycles is less than 10%.

Embodiment 195. The electrode assembly, sealed secondary battery cell, or method according to any preceding Embodiment, wherein the opposing first and second ends of the hermetically sealed case, or the first and second longitudinal growth constraints, either alone or in combination with one another restrain growth of the electrode assembly in the longitudinal direction such that any increase in the Feret diameter of the electrode assembly in the longitudinal direction is less than 1% per cycle.

Embodiment 196. The electrode assembly, sealed secondary battery cell, or method according to any preceding Embodiment, wherein the upper and lower sidewalls of the hermetically sealed case, or the first and second vertical growth constraints, either alone or in combination with one another, restrain growth of the electrode assembly in the vertical direction, such that any increase in the Feret diameter of the electrode assembly in the vertical direction over 20 consecutive cycles is less than 20%.

Embodiment 197. The electrode assembly, sealed secondary battery cell, or method according to any preceding Embodiment, wherein the upper and lower sidewalls of the hermetically sealed case, or the first and second vertical growth constraints, either alone or in combination with one another, restrain growth of the electrode assembly in the vertical direction, such that any increase in the Feret diameter of the electrode assembly in the vertical direction over 10 consecutive cycles is less than 10%

Embodiment 198. The electrode assembly, sealed secondary battery cell, or method according to any preceding Embodiment, wherein the upper and lower sidewalls of the hermetically sealed case, or the first and second vertical growth constraints, either alone or in combination with one another, restrain growth of the electrode assembly in the vertical direction, such that any increase in the Feret diameter of the electrode assembly in the vertical direction over 5 consecutive cycles is less than 10%.

Embodiment 199. The electrode assembly, sealed secondary battery cell, or method according to any preceding Embodiment, wherein the upper and lower sidewalls of the hermetically sealed case, or the first and second vertical growth constraints, either alone or in combination with one another, restrain growth of the electrode assembly in the vertical direction, such that any increase in the Feret diameter of the electrode assembly in the vertical direction is less than 1% per cycle.

Embodiment 200. The electrode assembly, sealed secondary battery cell, or method according to any preceding Embodiment, wherein (i) members of the population of electrode structures are anode structures and members of the population of counter-electrode structures are cathode structures, or (ii) members of the population of electrode structures are cathode structures and members of the population of electrode structures are anode structures.

Embodiment 201. The electrode assembly, sealed secondary battery cell, or method according to any preceding Embodiment, wherein members of the population of electrode structures are anode structures comprising anodically active material layers, and members of the population of counter-electrode structures are cathode structures comprising cathodically active material layers.

Embodiment 202. The electrode assembly, sealed secondary battery cell, or method according to any preceding Embodiment, wherein carrier ions are contained within the hermetically sealed battery enclosure.

Embodiment 203. The electrode assembly, sealed secondary battery cell, or method according to any preceding Embodiment, wherein members of the population of electrode structures comprises anode active material comprising any one of more of carbon materials, graphite, soft or hard carbons, metals, semi-metals, alloys, oxides, compounds capable of forming an alloy with lithium, tin, lead, magnesium, aluminum, boron, gallium, silicon, Si/C composites, Si/graphite blends, SiOx, porous Si, intermetallic Si alloys, indium, zirconium, germanium, bismuth, cadmium, antimony, silver, zinc, arsenic, hafnium, yttrium, lithium, sodium, lithium titanate, palladium, lithium metals, carbon, petroleum cokes, activated carbon, graphite, silicon compounds, silicon alloys, tin compounds, non-graphitizable carbon, graphite-based carbon, LiₓFe₂O₃ (0≤x≤1), LiₓWO₂ (0≤x≤1), SnₓMe₁₋ₓMe′_{y}O_{z} (Me: Mn, Fe, Pb, Ge; Me′: Al, B, P, Si, elements found in Group 1, Group 2 and Group 3 in a periodic table, halogen; 0≤x≤1; 1≤y≤3; 1≤z≤8), a lithium alloy, a silicon-based alloy, a tin-based alloy; a metal oxide, SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, Bi₂O₅, a conductive polymer, polyacetylene, Li—Co—Ni-based material, crystalline graphite, natural graphite, synthetic graphite, amorphous carbon, Kish graphite, pyrolytic carbon, mesophase pitch-based carbon fibers, meso-carbon microbeads, mesophase pitches, graphitized carbon fiber, high-temperature sintered carbon, petroleum, coal tar pitch derived cokes, tin oxide, titanium nitrate, lithium metal film, an alloy of lithium and one or more types of metals selected from the group consisting of Na, K, Rb, Cs, Fr, Be, Mg, Ca, Sr, Ba, Ra, Al and Sn, a metal compound capable of alloying and/or intercalating with lithium selected from any of Si, Al, C, Pt, Sn, Pb, Ir, Ni, Cu, Ti, Na, K, Rb, Cs, Fr, Be, Ca, Sr, Sb, Ba, Ra, Ge, Zn, Bi, In, Mg, Ga, Cd, a Sn alloy, an Al alloy, a metal oxide capable of doping and dedoping lithium ions, SiOᵥ (0<v<2), SnO₂, vanadium oxide, lithium vanadium oxide, a composite including a metal compound and carbon material, a Si—C composite, a Sn—C composite, a transition metal oxide, Li₄/3Ti₅/3O₄, SnO, a carbonaceous material, graphite carbon fiber, resin calcination carbon, thermal decomposition vapor growth carbon, corks, mesocarbon microbeads (“MCMB”), furfuryl alcohol resin calcination carbon, polyacene, pitch-based carbon fiber, vapor growth carbon fiber, or natural graphite, and a composition of the formula NaₓSn_{y-z}M_{z} disposed between layers of the layered carbonaceous material, wherein Mis Ti, K, Ge, P, or a combination thereof, and 0≤x≤15, 1≤y≤5, and 0≤z≤1, as well as oxides, alloys, nitrides, fluorides of any of the foregoing, and any combination of any of the foregoing.

Embodiment 204. The electrode assembly, sealed secondary battery cell, or method according to any preceding Embodiment, wherein the anode active material comprises at least one of lithium metal, a lithium metal alloy, silicon, silicon alloy, silicon oxide, tin, tin alloy, tin oxide, and a carbon-containing material.

Embodiment 205. The electrode assembly, sealed secondary battery cell, or method according to any preceding Embodiment, wherein the anode active material comprises at least one of silicon and silicon oxide.

Embodiment 206. The electrode assembly, sealed secondary battery cell, or method according to any preceding Embodiment, wherein the anode active material comprises at least one of lithium and lithium metal alloy.

Embodiment 207. The electrode assembly, sealed secondary battery cell, or method according to any preceding Embodiment, wherein the anode active material comprises a carbon-containing material.

Embodiment 208. The electrode assembly, sealed secondary battery cell, or method according to any preceding Embodiment, wherein members of the population of electrically insulating separators comprise microporous separator material permeated with non-aqueous liquid electrolyte.

Embodiment 209. The electrode assembly, sealed secondary battery cell, or method according to any preceding Embodiments, wherein members of the population of electrically insulating separators comprise solid electrolyte.

Embodiment 210. The electrode assembly, sealed secondary battery cell, or method according to any preceding Embodiment, wherein members of the population of electrically insulating separators comprise a ceramic material, glass, or garnet material.

Embodiment 211. The electrode assembly, sealed secondary battery cell, or method according to any preceding Embodiment, the electrode assembly comprising an electrolyte selected from the group consisting of non-aqueous liquid electrolytes, gel electrolytes, solid electrolytes and combinations thereof.

Embodiment 212. The electrode assembly, sealed secondary battery cell, or method according to any preceding Embodiment, wherein the electrode assembly comprises a liquid electrolyte.

Embodiment 213. The electrode assembly, sealed secondary battery cell, or method according to any preceding Embodiment, wherein the electrode assembly comprises an aqueous liquid electrolyte.

Embodiment 214. The electrode assembly, sealed secondary battery cell, or method according to any preceding Embodiment, wherein the electrode assembly comprises a non-aqueous liquid electrolyte.

Embodiment 215. The electrode assembly, sealed secondary battery cell, or method according to any preceding Embodiment, wherein the electrode assembly comprises a gel electrolyte.

Embodiment 216. The electrode assembly, sealed secondary battery cell, or method according to any preceding Embodiment, wherein the electrically insulating separator comprises a solid electrolyte.

Embodiment 217. The electrode assembly, sealed secondary battery cell, or method according to any preceding Embodiment, wherein the electrically insulating separator comprises a solid polymer electrolyte.

Embodiment 218. The electrode assembly, sealed secondary battery cell, or method according to any preceding Embodiment, wherein the electrically insulating separator comprises a solid inorganic electrolyte.

Embodiment 219. The electrode assembly, sealed secondary battery cell, or method according to any preceding Embodiment, wherein the electrically insulating separator comprises a solid organic electrolyte.

Embodiment 220. The electrode assembly, sealed secondary battery cell, or method according to any preceding Embodiment, wherein the electrically insulating separator comprises a ceramic electrolyte.

Embodiment 221. The electrode assembly, sealed secondary battery cell, or method according to any preceding Embodiment, wherein the electrically insulating separator comprises an inorganic electrolyte.

Embodiment 222. The electrode assembly, sealed secondary battery cell, or method according to any preceding Embodiment, wherein the electrically insulating separator comprises a ceramic.

Embodiment 223. The electrode assembly, sealed secondary battery cell, or method according to any preceding Embodiment wherein the electrically insulating separator comprises a garnet material.

Embodiment 224. The electrode assembly, sealed secondary battery cell, or method according to any preceding Embodiment, comprising an electrolyte selected from the group consisting of aqueous electrolytes, a non-aqueous liquid electrolyte, a solid polymer electrolyte, a solid ceramic electrolyte, a solid glass electrolyte, a solid garnet electrolyte, a gel polymer electrolyte, an inorganic solid electrolyte, and a molten-type inorganic electrolyte.

Embodiment 225. The electrode assembly, sealed secondary battery cell, or method according to any preceding Embodiment, wherein members of the population of counter-electrode structures comprise a cathodically active material comprising at least one of transition metal oxides, transition metal sulfides, transition metal nitrides, lithium-transition metal oxides, lithium-transition metal sulfides, lithium-transition metal nitrides, including transition metal oxides, transition metal sulfides, and transition metal nitrides having metal elements having a d-shell or f-shell, and/or where the metal element is any selected from Sc, Y, lanthanoids, actinoids, Ti, Zr, Hf, V, Nb, Ta, Cr, Mo, W, Mn, Tc, Re, Fe, Ru, Os, Co, Rh, Ir, Ni, Pb, Pt, Cu, Ag, and Au, LiCoO₂, LiNi_{0.5}Mn_{1.5}O₄, Li(NiₓCo_{y}Al_{z})O₂, LiFePO₄, Li₂MnO₄, V₂O₅, molybdenum oxysulfides, phosphates, silicates, vanadates, sulfur, sulfur compounds, oxygen (air), Li(NiₓMn_{y}Co_{z})O₂, lithium-containing compounds comprising metal oxides or metal phosphates, compounds comprising lithium, cobalt and oxygen (e.g., LiCoO₂), compounds comprising lithium, manganese and oxygen (e.g., LiMn₂O₄) compounds comprising lithium iron and phosphate (e.g., LiFePO), lithium manganese oxide, lithium cobalt oxide, lithium nickel oxide, lithium iron phosphate, lithium cobalt oxide (LiCoO₂), lithium nickel oxide (LiNiO₂), a substituted compound with one or more transition metals, lithium manganese oxide, Li₁₊ₓMn₂₋ₓO₄ (where, x is 0 to 0.33), LiMnO₃, LiMn₂O₃, LiMnO₂, lithium copper oxide (Li₂CuO₂), vanadium oxide, LiV₃O₈, LiFe₃O₄, V₂O₅, Cu₂V₂O₇, Ni site-type lithium nickel oxide represented by the chemical formula of LiNi₁₋ₓMₓO₂ (where, M=Co, Mn, Al, Cu, Fe, Mg, B or Ga, and x=0.01 to 0.3), lithium manganese complex oxide represented by the chemical formula of LiMn₂₋ₓMₓO₂ (where, M=Co, Ni, Fe, Cr, Zn or Ta, and x=0.01 to 0.1), Li₂Mn₃MO₈ (where, M=Fe, Co, Ni, Cu or Zn), LiMn₂O₄ in which a portion of Li is substituted with alkaline earth metal ions, a disulfide compound, Fe₂(MoO₄)₃, a lithium metal phosphate having an olivine structure of Formula 2 crystal: Li₁₊ₐFe₁₋ₓM′ₓ(PO_{4-b})X_{b} wherein M′ is at least one selected from Al, Mg, Ni, Co, Mn, Ti, Ga, Cu, V, Nb, Zr, Ce, In, Zn, and Y, X is at least one selected from F, S, and N, −0.5≤a≤+0.5, 0≤x≤0.5, and 0≤b≤0.1, LiFePO₄, Li(Fe,Mn)PO₄, Li(Fe,Co)PO₄, Li(Fe,Ni)PO₄, LiCoO₂, LiNiO₂, LiMnO₂, LiMn₂O₄, LiNi_{1-y}Co_{y}O₂, LiCo_{1-y}Mn_{y}O₂, LiNi_{1-y}Mn_{y}O₂ (0≤y≤1), Li(NiₐCo_{b}Mn_{c})O₄ (0≤a≤2, 0≤b≤2, 0≤c≤2, and a+b+c=2), LiMn_{2-z}Ni₂O₄, LiMn_{2-z}CO₂O₄ (0<z<2), LiCoPO₄ and LiFePO₄, elemental sulfur (S8), sulfur series compounds, Li₂Sn (n≥1), an organosulfur compound, a carbon-sulfur polymer ((C₂Sₓ)ₙ: x=2.5 to 50, n≥2), an oxide of lithium and zirconium, a composite oxide of lithium and metal (cobalt, manganese, nickel, or a combination thereof), LiₐA_{1-b}M_{b}D₂ (wherein, 0.90≤a≤1, and 0≤b≤0.5), LiₐE_{1-b}M_{b}O₂-D_{c} (wherein, 0.90≤a≤1, 0≤b≤0.5, and 0≤c≤0.05), LiE_{2-b}M_{b}O_{4-c}D_{c} (wherein, 0≤b≤0.5, and 0≤c≤0.05), LiₐNi_{1-b-c}CO_{b}M_{c}Dₐ (wherein, 0.90≤a≤1, 0≤b≤0.5, 0≤c≤0.05, and 0≤a≤2), LiₐNi_{1-b-c}CO_{b}M_{c}O₂₋ₐXₐ (wherein, 0.90≤a≤1, 0≤b≤0.5, 0≤c≤0.05, and 0≤a≤2), LiₐNi_{1-b-c}CO_{b}M_{c}O₂₋ₐX₂ (wherein, 0.90≤a≤1, 0≤b≤0.5, 0≤c≤0.05, and 0≤a≤2), LiₐNi_{1-b-c}Mn_{b}M_{c}Dₐ (wherein, 0.90≤a≤1, 0≤b≤0.5, 0≤c≤0.05, and 0≤a≤2), LiₐNi_{1-b-c}Mn_{b}M_{c}O₂₋ₐXₐ (wherein, 0.90≤a≤1, 0≤b≤0.5, 0≤c≤0.05, and 0≤a≤2), LiₐNi_{1-b-c}Mn_{b}M_{c}O₂₋ₐX₂ (wherein, 0.90≤a≤1, 0≤b≤0.5, 0<c<0.05, and 0≤a≤2), LiₐNi_{b}E_{c}GₐO₂ (wherein, 0.90≤a≤1, 0≤b≤0.9, 0<<<0.5, and 0.001<<0.1), LiₐNi_{b}Co_{c}MnₐGeO₂ (wherein, 0.90≤a≤1, 0≤b≤0.9, 0≤c≤0.5, 0≤d<0.5, and 0.001≤e≤0.1), LiₐNiG_{b}O₂ (wherein, 0.90≤a≤1 and 0.001≤b≤0.1), LiₐCoG_{b}O₂ (wherein, 0.90≤a≤1 and 0.001≤b≤0.1), LiₐMnG_{b}O₂ (wherein, 0.90≤a≤1 and 0.001≤b≤0.1), LiₐMn₂GbO₄ (wherein, 0.90≤a≤1 and 0.001≤b≤0.1), QO₂, QS₂, LiQS₂, V₂O₅, LiV₂O₅, LiX′O₂, LiNiVO₄, Li_{(3-f)}J₂(PO₄)₃ (0≤f≤2); Li_{(3-f)}Fe₂(PO₄)₃ (0≤f≤2), LiFePO₄. (A is Ni, Co, Mn, or a combination thereof; M is Al, Ni, Co, Mn, Cr, Fe, Mg, Sr, V, a rare-earth element, or a combination thereof; D is O, F, S, P, or a combination thereof; E is Co, Mn, or a combination thereof; X is F, S, P, or a combination thereof; G is Al, Cr, Mn, Fe, Mg, La, Ce, Sr, V, or a combination thereof; Q is Ti, Mo, Mn, or a combination thereof; X′ is Cr, V, Fe, Sc, Y, or a combination thereof; and J is V, Cr, Mn, Co, Ni, Cu, or a combination thereof), LiCoO₂, LiMnₓO₂ₓ (x=1 or 2), LiNi₁₋ₓMnₓO₂ₓ (0≤x≤1), LiNi_{1-x-y}CoₓMn_{y}O₂ (0≤x≤0.5, 0≤y≤0.5), FePO₄, a lithium compound, lithium cobalt oxide, lithium nickel oxide, lithium nickel cobalt oxide, lithium nickel cobalt aluminum oxide, lithium nickel cobalt manganese oxide, lithium manganese oxide, lithium iron phosphate, nickel sulfide, copper sulfide, sulfur, iron oxide, vanadium oxide, a sodium containing material, an oxide of the formula NaM¹ₐO₂ (wherein M¹ is at least one transition metal element, and 0≤a≤1), NaFeO₂, NaMnO₂, NaNiO₂, NaCoO₂, an oxide represented by the formula NaMn₁₋ₐM¹ₐO₂ (wherein M¹ is at least one transition metal element, and 0≤a≤1), Na[Ni_{1/2}Mn_{1/2}]O₂, Na_{2/3} [Fe_{1/2}Mn_{1/2}]O₂, an oxide represented by Na_{0.44}Mn₁₋ₐM¹ₐO₂ (wherein M¹ is at least one transition metal element, and 0≤a≤1), an oxide represented by Na_{0.7}Mn₁₋ₐM¹ₐO_{2.05} an (wherein M¹ is at least one transition metal element, and 0≤a≤1) an oxide represented by Na_{b}M₂Si₁₂O₃₀ (wherein M² is at least one transition metal element, 2≤b≤6, and 2≤c≤5), NaFe₂Si₁₂O₃₀, Na₂Fe₅Si₁₂O (wherein M² is at least one transition metal element, 2≤b≤6, and 2≤c≤5), an oxide represented by Na_{d}M³ₑSi₆O₁₈ (wherein M³ is at least one transition metal element, 3≤d≤6, and 1≤e≤2), Na₂Fe₂Si₆O₁₈, Na₂MnFeSi₆O₁₈ (wherein M³ is at least one transition metal element, 3≤d≤6, and 1≤e≤2), an oxide represented by Na_{f}M⁴_{g}Si₂O₆ (wherein M⁴ is at least one element selected from transition metal elements, magnesium (Mg) and aluminum (Al), 1≤f≤2 and 1≤g≤2), a phosphate, Na₂FeSiO₆, NaFePO₄, Na₃Fe₂(PO₄)₃, Na₃V₂(PO₄)₃, Na₄Co₃(PO₄)₂P₂O₇, a borate, NaFeBO₄ or Na₃Fe₂(BO₄)₃, a fluoride, NaₕM₅F₆ (wherein M⁵ is at least one transition metal element, and 2≤h≤3), Na₃FeF₆, Na₂MnF₆, a fluorophosphate, Na₃V₂(PO₄)₂F₃, Na₃V₂(PO₄)₂FO₂, NaMnO₂, Na[Ni_{1/2}Mn_{1/2}]O₂, Na_{2/3}[Fe_{1/2}Mn_{1/2}]O₂, Na₃V₂(PO₄)₃, Na₄Co₃(PO₄)₂P₂O₇, Na₃V₂(PO₄)₂F₃ and/or Na₃V₂(PO₄)₂FO₂, as well as any complex oxides and/or other combinations of the foregoing.

Embodiment 226. The electrode assembly, sealed secondary battery cell, or method according to any preceding Embodiment, wherein the cathodically active material comprises at least one of a transition metal oxide, transition metal sulfide, transition metal nitride, transition metal phosphate, and transition metal nitride.

Embodiment 227. The electrode assembly, sealed secondary battery cell, or method according to any preceding Embodiment, wherein the cathodically active material comprises a transition metal oxide containing lithium and at least one of cobalt and nickel.

Embodiment 228. The electrode assembly, sealed secondary battery cell, or method according to any preceding Embodiment, wherein members of the population of electrode structures comprise anode current collectors comprising at least one of copper, nickel, aluminum, stainless steel, titanium, palladium, baked carbon, calcined carbon, indium, iron, magnesium, cobalt, germanium, lithium, a surface treated material of copper or stainless steel with carbon, nickel, titanium, silver, an aluminum-cadmium alloy, and/or alloys thereof.

Embodiment 229. The electrode assembly, sealed secondary battery cell, or method according to any preceding Embodiment, wherein members of the population of electrode structures comprise anode current collectors comprising at least one of copper, nickel, stainless steel and alloys thereof.

Embodiment 230. The electrode assembly, sealed secondary battery cell, or method according to any preceding Embodiment, wherein the counter-electrode structures comprise cathode current collectors comprising at least one of stainless steel, aluminum, nickel, titanium, baked carbon, sintered carbon, a surface treated material of aluminum or stainless steel with carbon, nickel, titanium, silver, or an alloy thereof.

Embodiment 231. The electrode assembly, sealed secondary battery cell, or method according to any preceding Embodiment, wherein the cathode current collectors comprising at least one of stainless steel, aluminum, nickel, titanium, baked carbon, sintered carbon, a surface treated material of aluminum or stainless steel with carbon, silver, or an alloy thereof.

Embodiment 232. The electrode assembly, sealed secondary battery cell, or method according to any preceding Embodiment, wherein the cathode current collectors comprising aluminum.

Embodiment 233. The electrode assembly, sealed secondary battery cell, or method according to any preceding Embodiment, wherein the first and second connecting members of the constraint system comprise any of stainless steel, titanium, or glass fiber composite.

Embodiment 234. The electrode assembly, sealed secondary battery cell, or method according to any preceding Embodiment, wherein the first and second connecting members of the constraint system comprises stainless steel.

Embodiment 235. The electrode assembly, sealed secondary battery cell, or method according to any preceding Embodiment, wherein the first and second connecting members of the constraint system comprise a coating of insulating material on inner and outer surfaces thereof.

Embodiment 236. The electrode assembly, sealed secondary battery cell, or method according to any preceding Embodiment, wherein the electrode assembly comprises at least 5 electrode structures and at least 5 counter-electrode structures.

Embodiment 237. The electrode assembly, sealed secondary battery cell, or method according to any preceding Embodiment, wherein the electrode assembly comprises at least 10 electrode structures and at least 10 counter-electrode structures.

Embodiment 238. The electrode assembly, sealed secondary battery cell, or method according to any preceding Embodiment, wherein the electrode assembly comprises at least 50 electrode structures and at least 50 counter-electrode structures.

Embodiment 239. The electrode assembly, sealed secondary battery cell, or method according to any preceding Embodiment, wherein the electrode assembly comprises at least 100 electrode structures and at least 100 counter-electrode structures.

Embodiment 240. The electrode assembly, sealed secondary battery cell, or method according to any preceding Embodiment, wherein the electrode assembly comprises at least 500 electrode structures and at least 500 counter-electrode structures.

### INCORPORATION BY REFERENCE

All publications and patents mentioned herein, including those items listed below, are hereby incorporated by reference in their entirety for all purposes as if each individual publication or patent was specifically and individually incorporated by reference. In case of conflict, the present application, including any definitions herein, will control.

### EQUIVALENTS

While specific embodiments have been discussed, the above specification is illustrative, and not restrictive. Many variations will become apparent to those skilled in the art upon review of this specification. The full scope of the embodiments should be determined by reference to the claims, along with their full scope of equivalents, and the specification, along with such variations.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained.

What is claimed is:

1. A device for energy storage and for energy release, the device comprising:
an electrode assembly comprising:
an electrode structure comprising an electrode current collector having (a) an electrode current collector body region and (b) an electrode current collector end region being bounded by, and extending from, a transverse end of the electrode current collector body region, the transverse end of the electrode current collector body region being along a transverse direction;
a counter-electrode structure stacked with the electrode structure along a longitudinal direction normal to the transverse direction, the counter-electrode structure being separated from the electrode structure along the longitudinal direction, the electrode current collector body region having a first height along a vertical direction normal to the transverse direction and normal to the longitudinal direction, the electrode current collector end region having a second height different from the first height;
an electrode busbar disposed along the longitudinal direction, the electrode busbar being operatively coupled with a surface of the electrode current collector, the surface having (a) a first surface portion of the electrode current collector body region, the first surface portion being disposed normal to the longitudinal direction, and (b) a second surface portion of the electrode current collector end region, the second surface portion being disposed along the longitudinal direction; and
a constraint system comprising apertures having a slot-shape with an elongated dimension, the electrode assembly being disposed in the constraint system.

2. The device of claim 1, wherein the constraint system being capable of restraining growth of the electrode assembly in the vertical direction.

3. The device of claim 2, wherein the constraint system comprises a first longitudinal constraint and a second longitudinal constraint separated from each other in the longitudinal direction.

4. The device of claim 2, wherein the constraint system comprises a first vertical growth constraint and a second vertical growth constraint separated from each other in the vertical direction.

5. The device of claim 2, wherein the constraint system is coupled with the electrode assembly at least in part using one or more of adhering, gluing, welding, joining, bonding, soldering, sintering, press contacting, brazing, thermal spraying joining, clamping, wire bonding, ribbon bonding, ultrasonic bonding, ultrasonic welding, resistance welding, laser beam welding, electron beam welding, induction welding, cold welding, plasma spraying, flame spraying, and arc spraying.

6. The device of claim 2, wherein the apertures are slots, the slots being spaced apart from one another in the transverse direction, each of the slots having a longitudinal axis oriented along the longitudinal direction.

7. The device of claim 1, wherein the counter-electrode structure comprises a counter-electrode current collector having (a) a counter-electrode current collector body region and (b) a counter-electrode current collector end region that is bounded by, and extends from, a transverse end of the counter-electrode current collector body region.

8. The device of claim 1, wherein the electrode current collector end region is spatially configured to increase energy density.

9. The device of claim 1, wherein at least a portion of the electrode current collector end region is bent in a direction towards the longitudinal direction.

10. The device of claim 1, wherein the electrode current collector body region and a portion of the electrode current collector end region are aligned about the transverse direction.

11. The device of claim 1, wherein a unit cell of the electrode assembly comprises the electrode structure and the counter-electrode structure, the electrode assembly comprising unit cells similar to, and including, the unit cell, the unit cells being stacked along the longitudinal direction.

12. The device of claim 11, wherein the electrode assembly comprises at least four unit cells.

13. The device of claim 11, wherein (a) a length L_{E} of the electrode structure of each of the unit cells and a length L_{CE} of the counter-electrode structure of each of the unit cells, are measured in the transverse direction, (b) a width W_{E} of the electrode structure of each of the unit cells and a width W_{CE} of the counter-electrode structure of each of the unit cells, are measured in the longitudinal direction, and (b) a height H_{E} of the electrode structure of each of the unit cells and a height H_{CE} of the counter-electrode structure of each of the unit cells, is measured in the vertical direction that is perpendicular to the longitudinal direction; wherein (i) a ratio of L_{E} to each of W_{E} and H_{E} of each of the electrode structure and of the counter-electrode structure being at least 2:1, respectively, (ii) a ratio of H_{E} to W_{E} for each of the electrode structure and of the counter-electrode structure being at least 0.4:1, (iii) a ratio of L_{CE} to each of W_{CE} and H_{CE} of each of the electrode structure and of the counter-electrode structure being at least 2:1, respectively, and/or (iv) a ratio of H_{CE} to W_{CE} for each of the electrode structure and of the counter-electrode structure being at least 0.4:1.

14. The device of claim 1, wherein (a) the electrode assembly is disposed in an enclosure, a thermal conductivity of the electrode assembly along a thermally conductive path between vertically opposing regions of external vertical surfaces of the enclosure in the vertical direction, is at least 7.5 Watts per meter per Kelvin (W/m·K), (b) a rated capacity of the device is of at least 100 milli Ampere Hours (mAmp*hr) (c) a core energy density of the device is at least 700 Watt hour per Liter (Whr/liter), or (d) any combination of (a), (b), and (c).

15. The device of claim 1, wherein the electrode assembly comprises an electrode active material that comprises silicon.

16. The device of claim 1, wherein the electrode assembly is disposed in an enclosure.

17. The device of claim 16, wherein the enclosure (a) is hermetically sealed, (b) comprises a metal material and/or (c) the device further comprising an electrode tab and a counter-electrode tab, the electrode structure being operatively coupled with the electrode tab and the counter-electrode structure being operatively coupled with the counter-electrode tab, the electrode tab and the counter-electrode tab being configured to extend from an interior of the enclosure to an exterior of the enclosure.

18. A method for energy storage and for energy release, the method comprising using one or more operations to form the device of claim 1.

19. A method of energy storage and for energy release, the method comprising (a) providing the device of claim 1; and (b) using the device for flow of carrier ions to the electrode assembly and/or cycling the electrode assembly between a charged state and a discharged state.

20. A control unit for facilitating energy storage and for energy release, the control unit being configured to electrically couple with the device in claim 1, the control unit being configured to direct execution of one or more operations, the control unit being configured to couple with an electrical connection.
